(19) United States
(12) Patent Application Publication
(10) Pub. No.: US 2017/0024724 A1
(43) Pub. Date: Jan. 26, 2017

(54) SYSTEM FOR RECOMMENDING OPTIMAL CARD, APPARATUS FOR RECOMMENDING OPTIMAL CARD AND METHOD FOR THE SAME

(71) Applicant: SK Planet Co., Ltd., Seongnam-si (KR)

(72) Inventor: Se-Byung KWAK, Seoul (KR)

(21) Appl. No.: 15/217,600

(22) Filed: Jul. 22, 2016

(30) Foreign Application Priority Data
Jul. 24, 2015 (KR) 10-2015-0104820
Aug. 6, 2015 (KR) 10-2015-0111001
Aug. 6, 2015 (KR) 10-2015-0111002
Aug. 6, 2015 (KR) 10-2015-0111005
Aug. 6, 2015 (KR) 10-2015-0111009

(51) Int. Cl. G06Q 20/34; G06Q 30/06

(52) U.S. Cl. CPC G06Q 20/34; G06Q 30/0601

(57) ABSTRACT

Disclosed herein are an optimal card recommendation system, a purchase prediction-based optimal card recommendation apparatus, and a method using the apparatus. One or more purchase commodities that are expected to be purchased by a user at a store are predicted, an amount of a payment that is expected to be made by the user at the store is predicted, and an optimal card is predicted, among multiple cards registered in an application for payment, in consideration of at least one of the expected payment amount and the one or more expected purchase commodities. The most suitable payment card may be recommended by predicting a commodity to be purchased by a user and a payment amount for the commodity so that the user may use an automatic payment service when paying for a commodity at a store through his or her mobile terminal.

### CROSS REFERENCE TO RELATED APPLICATIONS

This application claims the benefit of Korean Patent Application Nos. 10-2015-0104820, filed Jul. 24, 2015, 10-2015-0111009, filed Aug. 6, 2015, 10-2015-0111005, filed Aug. 6, 2015, 10-2015-0111002, filed Aug. 6, 2015, and 10-2015-0111001, filed Aug. 6, 2015, which are hereby incorporated by reference in their entirety into this application.

### BACKGROUND OF THE INVENTION

1. Technical Field

The present invention generally relates to technology for recommending a payment card to be used for online or offline payment and, more particularly, to a system, apparatus, and method for recommending an optimal card, which may recommend a card to be used for payment and a membership card by predicting a commodity to be purchased and a purchase amount before a user purchases a commodity, may change the payment card when a prediction is wrong, may recommend a card to be used for payment and a membership card depending on the time at which the user makes payment, may recommend a card to be used for payment and a membership card in consideration of discount weights depending on the time at which the user makes payment, and may adjust the closing time of a card usage period so as to achieve a target card usage record required to obtain benefits in the next month when recommending a card in order for the user to purchase a commodity.

2. Description of the Related Art

With the popularization of mobile terminals, various types of services that could not be imagined in the past have been realized and provided. As one of these services, there is technology in which a mobile terminal senses the visit of a user to a store or a shop when the user merely visits the store or shop, and provides a discount coupon or promotional information provided by the store or shop to the user.

Further, as an extension of this service, various schemes related to technology for recommending a payment card to be used for online or offline payment have also been proposed. For example, there may be various types of technologies, such as technology for setting target amounts for respective payment cards and primarily recommending a payment card, which has not come close to reaching a target amount, and technology for recommending a payment card having the maximum benefits, among multiple payment cards that have reached target card usage records in the previous month, but when multiple payment cards are selected, recommending a payment card having the minimum remaining amount required to achieve a card usage record in the current month.

However, such conventional card recommendation technologies can be applied only to the situation in which commodities and payment amounts are determined in advance, and thus it may be impossible to recommend a suitable card in the situation in which a commodity to be paid for by a user and a payment amount for the commodity are not fixed.

In this way, it may be difficult to recommend a suitable payment card in the situation in which a commodity to be purchased by the user or a purchase amount is not fixed. However, in a service in which a user checks in at a store and is provided with discount information such as a coupon, and in which advance payment is performed, after which automatic payment must be performed without requiring an additional payment operation through a Point of Sale (POS) system, there is a need to recommend a suitable payment card or a suitable membership card before the time of advance payment. In this case, in the situation in which a commodity or an amount is not fixed, there is the possibility that an unexpected case where the benefits of a recommended payment card and membership card are unsuitable or where the user purchases a commodity unrelated to the benefits of the card will occur.

### PRIOR ART DOCUMENTS

### Patent Documents

(Patent Document) Korean Patent Application Publication No. 10-2012-0134784 (Date of Publication: Dec. 12, 2012, entitled “Off-line Shopping System, Off-line Shopping Supporting Apparatus and Method, and Cloud Computing System and Off-ling Shopping Supporting Method thereof”)

### SUMMARY OF THE INVENTION

Accordingly, the present invention has been made keeping in mind the above problems occurring in the prior art, and an object of the present invention is to recommend the most suitable payment card by predicting a commodity to be purchased by a user and a payment amount for the commodity so that the user may use an automatic payment service when paying for a commodity at a store through his or her mobile terminal.

Another object of the present invention is to recommend a payment card and a membership card, which allow a user to obtain the maximum benefits, such as discounts or accumulation, depending on the commodity expected to be purchased by the user and a payment amount for the commodity.

A further object of the present invention is to maximize the convenience of a user by allowing the user to process payment while minimizing an operation of performing payment at a store using his or her mobile terminal.

Yet another object of the present invention is to recommend a card that provides optimal benefits even in the situation in which a commodity and a payment amount are not fixed, as in the case of a store check-in-based service.

Still another object of the present invention is to change the current card to another card having more benefits based on an actually purchased commodity and a payment amount for the commodity and to recommend the changed card when the prediction of a commodity or an amount is incorrect, thus improving the reliability of a card recommendation algorithm.

Still another object of the present invention is to provide a recommended card so that a user may purchase each commodity most effectively on each payment due date by applying a recommendation algorithm in consideration of benefits and usage records based on the date on which the commodity is paid for.

Still another object of the present invention is to recommend an optimal card by applying different weights to the discount rates and the accumulation rates of cards based on the date on which a commodity is paid for, thus allowing the user to obtain the most effective benefits depending on the payment date.

Still another object of the present invention is to provide a payment method, which allows a user to continuously obtain benefits based on usage records by postponing the closing date of the card usage period of the corresponding card in consideration of the usage records of respective cards when recommending a payment card.

In accordance with an aspect of the present invention to accomplish the above objects, there is provided an optimal card recommendation apparatus, including a purchase commodity prediction unit for predicting one or more purchase commodities that are expected to be purchased by a user at a store; an expected amount prediction unit for predicting an amount of a payment that is expected to be made by the user at the store; and a card recommendation unit for recommending an optimal card, among multiple cards registered in an application for payment, in consideration of at least one of the expected payment amount and the one or more expected purchase commodities.

Further, a purchase prediction-based optimal card recommendation method according to the present invention is an optimal card recommendation method performed by the purchase prediction-based optimal card recommendation apparatus, and includes predicting one or more purchase commodities that are expected to be purchased by a user at a store; predicting an amount of a payment that is expected to be made by the user at the store; and recommending an optimal card, among multiple cards registered in an application for payment, in consideration of at least one of the expected payment amount and the one or more expected purchase commodities.

Furthermore, a purchase prediction-based optimal card recommendation system according to the present invention includes an optimal card recommendation apparatus for predicting one or more purchase commodities that are expected to be purchased by a user at a store, predicting an amount of a payment that is expected to be made by the user at the store, and recommending an optimal card, among multiple cards registered in an application for payment, in consideration of at least one of the expected payment amount and the one or more expected purchase commodities, and a terminal for providing information about the optimal card to the user through the application.

In accordance with another aspect of the present invention to accomplish the above objects, there is provided an optimal card recommendation apparatus, including a purchase commodity prediction unit for predicting one or more purchase commodities that are expected to be purchased by a user at a store; an expected amount prediction unit for predicting an amount of a payment that is expected to be made by the user at the store; a card recommendation unit for recommending an optimal card, among multiple cards registered in an application for payment, in consideration of at least one of the expected payment amount and the one or more expected purchase commodities; and a card change unit for determining whether to change the optimal card in consideration of at least one card change condition, and changing the optimal card in consideration of at least one of an actual purchase commodity and an actual payment amount if it is determined to change the optimal card.

Further, an optimal card recommendation method based on the change of a recommended card according to the present invention is an optimal card recommendation method performed by the optimal card recommendation apparatus based on the change of a recommended card, and includes predicting one or more purchase commodities that are expected to be purchased by a user at a store; predicting an amount of a payment that is expected to be made by the user at the store; recommending an optimal card, among multiple cards registered in an application for payment, in consideration of at least one of the expected payment amount and the one or more expected purchase commodities; and determining whether to change the optimal card in consideration of at least one card change condition, and changing the optimal card in consideration of at least one of an actual purchase commodity and an actual payment amount if it is determined to change the optimal card.

Furthermore, an optimal card recommendation system based on the change of a recommended card according to the present invention includes an optimal card recommendation apparatus for predicting one or more purchase commodities that are expected to be purchased by a user at a store, predicting an amount of a payment that is expected to be made by the user at the store, recommending an optimal card, among multiple cards registered in an application for payment, in consideration of at least one of the expected payment amount and the one or more expected purchase commodities, determining whether to change the optimal card in consideration of at least one card change condition, and changing the optimal card in consideration of at least one of an actual purchase commodity and an actual payment amount if it is determined to change the optimal card; and a terminal for providing information about the optimal card to the user through the application.

In accordance with a further aspect of the present invention to accomplish the above objects, there is provided an optimal card recommendation apparatus, including a purchase commodity prediction unit for predicting one or more purchase commodities that are expected to be purchased by a user at a store; an expected amount prediction unit for predicting an amount of a payment that is expected to be made by the user at the store; a payment section determination unit for determining a payment section corresponding to a current date, among multiple sections corresponding to a usage record determination period; and a card recommendation unit for recommending an optimal card, among multiple cards registered in an application, in consideration of at least one of a recommendation algorithm corresponding to the payment section, the one or more expected purchase commodities, and the expected payment amount.

Further, a payment time-based optimal card recommendation method according to the present invention is an optimal card recommendation method performed by the payment time-based optimal card recommendation apparatus, and includes predicting one or more purchase commodities that are expected to be purchased by a user at a store; predicting an amount of a payment that is expected to be made by the user at the store; determining a payment section corresponding to a current date, among multiple sections corresponding to a usage record determination period; and recommending an optimal card, among multiple cards registered in an application, in consideration of at least one of a recommendation algorithm corresponding to the payment section, the one or more expected purchase commodities, and the expected payment amount.

Furthermore, a payment time-based optimal card recommendation system according to the present invention includes an optimal card recommendation apparatus for predicting one or more purchase commodities that are expected to be purchased by a user at a store, predicting an amount of a payment that is expected to be made by the user at the store, determining a payment section corresponding to a current date, among multiple sections corresponding to a usage record determination period, and recommending an optimal card, among multiple cards registered in an application, in consideration of at least one of a recommendation algorithm corresponding to the payment section, the one or more expected purchase commodities, and the expected payment amount; and a terminal for providing information about the optimal card to the user through the application.

In accordance with yet another aspect of the present invention to accomplish the above objects, there is provided an optimal card recommendation apparatus, including a purchase commodity prediction unit for predicting one or more purchase commodities that are expected to be purchased by a user at a store; an expected amount prediction unit for predicting an amount of a payment that is expected to be made by the user at the store; a payment section determination unit for determining a payment section corresponding to a current date, among multiple sections corresponding to a usage record determination period; and a card recommendation unit for recommending an optimal card, among multiple cards registered in an application, in consideration of at least one of a recommendation algorithm to which a weight corresponding to the payment section is applied, the one or more expected purchase commodities, and the expected payment amount.

Further, an optimal card recommendation method based on weights depending on payment times according to the present invention is an optimal card recommendation method performed by the optimal card recommendation apparatus based on weights depending on payment times, and includes predicting one or more purchase commodities that are expected to be purchased by a user at a store; predicting an amount of a payment that is expected to be made by the user at the store; determining a payment section corresponding to a current date, among multiple sections corresponding to a usage record determination period; and recommending an optimal card, among multiple cards registered in an application, in consideration of at least one of a recommendation algorithm to which a weight corresponding to the payment section is applied, the one or more expected purchase commodities, and the expected payment amount.

Furthermore, an optimal card recommendation system based on weights depending on payment times according to the present invention includes an optimal card recommendation apparatus for predicting one or more purchase commodities that are expected to be purchased by a user at a store, predicting an amount of a payment that is expected to be made by the user at the store, determining a payment section corresponding to a current date, among multiple sections corresponding to a usage record determination period, and recommending an optimal card, among multiple cards registered in an application, in consideration of at least one of a recommendation algorithm to which a weight corresponding to the payment section is applied, the one or more expected purchase commodities, and the expected payment amount.

In accordance with still another aspect of the present invention to accomplish the above objects, there is provided an optimal card recommendation apparatus, including a purchase commodity prediction unit for predicting one or more purchase commodities that are expected to be purchased by a user at a store; an expected amount prediction unit for predicting an amount of a payment that is expected to be made by the user at the store; a payment section determination unit for determining a payment section corresponding to a current date, among multiple sections corresponding to a usage record determination period; and a card recommendation unit for recommending an optimal card, among multiple cards registered in an application, in consideration of at least one of a recommendation algorithm corresponding to the payment section, the one or more expected purchase commodities, and the expected payment amount, and especially recommending the optimal card by additionally considering a possibility of a target usage record being achieved when closing of a card usage period is postponed depending on the payment section.

Further, an optimal card recommendation method using postponement of card usage period closing according to the present invention is an optimal card recommendation method performed by the optimal card recommendation apparatus using postponement of card usage period closing, and includes predicting one or more purchase commodities that are expected to be purchased by a user at a store; predicting an amount of a payment that is expected to be made by the user at the store; determining a payment section corresponding to a current date, among multiple sections corresponding to a usage record determination period; and recommending an optimal card, among multiple cards registered in an application, in consideration of at least one of a recommendation algorithm corresponding to the payment section, the one or more expected purchase commodities, and the expected payment amount, and especially recommending the optimal card by additionally considering a possibility of a target usage record being achieved when closing of a card usage period is postponed depending on the payment section.

Furthermore, an optimal card recommendation system using postponement of card usage period closing according to the present invention includes an optimal card recommendation apparatus for predicting one or more purchase commodities that are expected to be purchased by a user at a store, predicting an amount of a payment that is expected to be made by the user at the store, determining a payment section corresponding to a current date, among multiple sections corresponding to a usage record determination period, recommending an optimal card, among multiple cards registered in an application, in consideration of at least one of a recommendation algorithm corresponding to the payment section, the one or more expected purchase commodities, and the expected payment amount, and especially recommending the optimal card by additionally considering a possibility of a target usage record being achieved when closing of a card usage period is postponed depending on the payment section; and a terminal for providing information about the optimal card to the user through the application

In addition, as another means for accomplishing the objects of the present invention, there is provided a computer program stored in a storage medium to execute the above-described method.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a payment system using an application pay service according to an embodiment of the present invention;

FIG. 2 is an operation flowchart showing an example of a payment method using BLE Push in the payment system of FIG. 1;

FIG. 3 is an operation flowchart showing an example of a typical payment method performed using the payment system shown in FIG. 1;

FIGS. 4 and 5 are diagrams showing a payment process screen when a user is an application subscriber in the payment method using BLE Push, shown in FIG. 2;

FIGS. 6 and 7 are diagrams showing a member subscription screen when a user is not an application subscriber in the payment method using BLE Push, shown in FIG. 2;

FIG. 8 is a block diagram showing an optimal card recommendation apparatus according to an embodiment of the present invention;

FIG. 9 is a diagram showing a screen required to recommend an optimal card in an application according to an embodiment of the present invention;

FIG. 10 is an operation flowchart showing a purchase prediction-based optimal card recommendation method according to an embodiment of the present invention;

FIG. 11 is an operation flowchart showing in detail an expected purchase commodity prediction procedure corresponding to step S1010 in the optimal card recommendation method shown in FIG. 10;

FIG. 12 is an operation flowchart showing in detail an expected payment amount prediction procedure corresponding to step S1020 in the optimal card recommendation method shown in FIG. 10;

FIG. 13 is a diagram showing in detail a procedure for matching an expected purchase commodity with an expected payment amount in the purchase prediction-based optimal card recommendation method according to an embodiment of the present invention;

FIG. 14 is a flow diagram showing a purchase prediction-based optimal card recommendation process according to an embodiment of the present invention;

FIG. 15 is a block diagram showing an optimal card recommendation apparatus according to another embodiment of the present invention;

FIG. 16 is a diagram showing a screen required to recommend an optimal card in an application according to an embodiment of the present invention;

FIG. 17 is a diagram showing a recommended card change screen according to an embodiment of the present invention;

FIG. 18 is an operation flowchart showing an optimal card recommendation method based on the change of a recommended card according to an embodiment of the present invention;

FIG. 19 is a diagram showing in detail a procedure for changing an optimal card in the optimal card recommendation method based on the change of a recommended card according to an embodiment of the present invention;

FIG. 20 is a flow diagram showing an optimal card recommendation process based on the change of a recommended card according to an embodiment of the present invention;

FIG. 21 is a block diagram showing an optimal card recommendation apparatus according to a further embodiment of the present invention;

FIG. 22 is a block diagram showing in detail the section division unit, shown in FIG. 21;

FIG. 23 is a diagram showing sections obtained by dividing a usage record determination period according to an embodiment of the present invention;

FIG. 24 is an operation flowchart showing a payment time-based optimal card recommendation method according to an embodiment of the present invention;

FIG. 25 is a diagram showing in detail a procedure for determining recommendation algorithms depending on payment sections in the payment time-based optimal card recommendation method according to an embodiment of the present invention;

FIG. 26 is a flow diagram showing a payment time-based optimal card recommendation process according to an embodiment of the present invention;

FIG. 27 is a block diagram showing an optimal card recommendation apparatus according to yet another embodiment of the present invention;

FIG. 28 is a block diagram showing in detail the section division unit shown in FIG. 27;

FIG. 29 is a diagram showing sections obtained by dividing a usage record determination period according to an embodiment of the present invention;

FIG. 30 is an operation flowchart showing an optimal card recommendation method based on weights depending on payment times according to an embodiment of the present invention;

FIG. 31 is a diagram showing in detail a procedure for determining recommendation algorithms depending on payment sections in the optimal card recommendation method based on weights depending on payment times according to an embodiment of the present invention;

FIG. 32 is a flow diagram showing an optimal card recommendation process based on weights depending on payment times according to an embodiment of the present invention;

FIG. 33 is a block diagram showing an optimal card recommendation apparatus according to still another embodiment of the present invention;

FIG. 34 is a block diagram showing in detail the card recommendation unit shown in FIG. 33;

FIG. 35 is a diagram showing sections obtained by dividing a usage record determination period according to an embodiment of the present invention;

FIG. 36 is a diagram showing a scheme for postponing the closing date of a card usage period according to an embodiment of the present invention;

FIG. 37 is an operation flowchart showing an optimal card recommendation method using the postponement of card usage period closing according to an embodiment of the present invention;

FIG. 38 is a diagram showing in detail a procedure for determining recommendation algorithms depending on payment sections in the optimal card recommendation method using the postponement of card usage period closing according to an embodiment of the present invention; and

FIG. 39 is a diagram showing in detail a procedure for postponing the closing date of the card usage period of the optimal card in the optimal card recommendation method using the postponement of card usage period closing according to an embodiment of the present invention.

### DESCRIPTION OF THE PREFERRED EMBODIMENTS

Hereinafter, preferred embodiments of the present invention will be described in detail with reference to the attached drawings. In the following description of the present invention and attached drawings, detailed descriptions of known functions and configurations which are deemed to make the gist of the present invention obscure will be omitted. It should be noted that the same reference numerals are used to designate the same or similar elements throughout the drawings.

The terms and words used in the present specification and claims should not be interpreted as being limited to their typical meaning based on the dictionary definitions thereof, but should be interpreted as having the meaning and concept relevant to the technical spirit of the present invention on the basis of the principle by which the inventor can suitably define the terms in the way which best describes the invention. Meanwhile, the configurations described in the present specification and the configurations illustrated in the drawings are merely preferred embodiments of the present invention and do not exhaustively present the technical spirit of the present invention. Accordingly, it should be appreciated that there may be various equivalents and modifications that can replace the embodiments and the configurations at the time at which the present application is filed. The terms such as “first” and “second” may be used to describe various components and are intended to merely distinguish one component from other components and are not intended to limit the components.

Here, a optimal card recommendation apparatus disclosed in “DESCRIPTION OF THE PREFERRED EMBODIMENTS” correspond to a payment card recommendation apparatus in this application claims.

Further, a optimal card disclosed in “DESCRIPTION OF THE PREFERRED EMBODIMENTS” correspond to a payment card in this application claims.

Further, a optimal card recommendation unit disclosed in “DESCRIPTION OF THE PREFERRED EMBODIMENTS” correspond to a payment card recommendation unit in this application claims.

Further, a optimal membership card disclosed in “DESCRIPTION OF THE PREFERRED EMBODIMENTS” correspond to a payment membership card in this application claims.

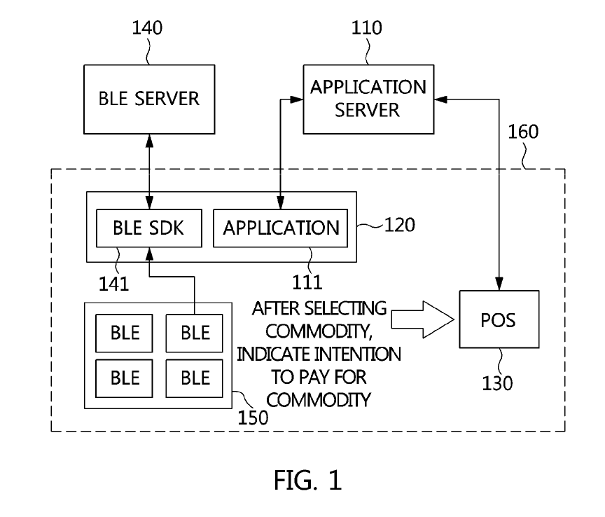

FIG. 1 is a block diagram showing a payment system using an application pay service according to an embodiment of the present invention.

Referring to FIG. 1, the payment system using an application pay service according to the embodiment of the present invention includes an application server 110, a terminal 120, a Point of Sale (POS) device 130, a Bluetooth Low Energy (BLE) server 140, and a BLE device 150.

The payment system according to the embodiment of the present invention may correspond to a system for performing payment using an application pay service based on an application installed on the mobile terminal of a user when the user purchases a commodity at an offline store.

The application server 110 may be a server for processing a procedure related to payment by providing an application 111 for performing payment, together with information related to payment, to the terminal 120 of the user. The application server 110 may transmit and receive data over a network.

Here, the network is configured to provide a path through which data is transferred between the application server 110 and the terminal 120, and is a concept including all existing networks that are conventionally used and networks that can be developed in the future. For example, the network may be a wired/wireless Local Area Network (LAN) for providing communication between various types of information devices in a limited area, a mobile communication network for providing communication between individual moving objects and between a moving object and an external system outside the moving object, or a satellite communication network for providing communication between individual earth stations using satellites, or may be any one of wired/wireless communication networks or a combination of two or more thereof. Transfer mode standards for the network may include all transfer mode standards that will be developed in the future, without being limited to existing transfer mode standards. Further, in FIG. 1, the network used between the application server 110 and the terminal 120 may be different from or identical to the network between the application server 110 and the POS device 130 and the network between the BLE server 140 and the terminal 120.

The terminal 120 receives information corresponding to commodity payment from the application server 110 using the application and provides the received information to the user.

Here, the terminal 120 may be a device that is connected to a communication network and that is capable of executing the application. Such a terminal may be any of mobile terminals having various mobile communication specifications, such as a mobile phone, a Portable Multimedia Player (PMP), a Mobile Internet Device (MID), a smart phone, a tablet computer (PC), a notebook computer, a netbook computer, a Personal Digital Assistant (PDA), and an information communication device.

Further, the terminal 120 may receive various types of information such as number and character information, and may transfer signals that are input in relation to the settings of various functions and the control of functions of the terminal 120 to a control unit through an input unit. Furthermore, the input unit of the terminal 120 may be configured to include at least one of a keypad and a touchpad for generating input signals depending on the user's touch or manipulation. Here, the input unit of the terminal 120 may be implemented in the form of a single touch panel (or a touch screen) together with the display unit of the terminal 120, and may therefore simultaneously perform an input function and a display function. Furthermore, the input unit of the terminal 120 may be any of all types of input means that can be developed in the future, as well as an input device such as a keyboard, a keypad, a mouse, or a joystick. In particular, the input unit of the terminal 120 according to the present invention may deliver an input signal, required to select a card or perform payment based on the optimal card recommendation system, to the control unit of the terminal 120.

Meanwhile, the display unit of the terminal 120 may display information about a series of operation states and operation results during the performance of functions of the terminal 120. In addition, the display unit of the terminal 120 may display the menu of the terminal 120, user data entered by the user, etc. Here, the display unit of the terminal 120 may be implemented as a Liquid Crystal Display (LCD), a Thin Film Transistor LCD (TFT-LCD), a Light-Emitting Diode (LED), an Organic LED (OLED), an Active Matrix OLED (AMOLED), a retina display, a flexible display, or a three-dimensional (3D) display. In this case, when the display unit of the terminal 120 is implemented as a touch screen, the display unit of the terminal 120 may perform all or some of the functions of the input unit of the terminal 120. In particular, the display unit of the terminal 120 according to the present invention may display information about an optimally recommended card and information related to payment, which are provided based on the optimal card recommendation system, on a screen.

Meanwhile, the storage unit of the terminal 120 is a device for storing data, and includes main memory and auxiliary memory, and may store application programs required for the functional operations of the terminal 120. The storage unit of the terminal 120 may chiefly include a program area and a data area. Here, when each function is activated in response to the request of the user, the terminal 120 provides individual functions by executing the corresponding application programs under the control of the control unit. In particular, the storage unit of the terminal 120 according to the present invention may store an operating system for booting the terminal 120, a program for recommending a card or performing payment based on the optimal card recommendation system, etc. Further, the storage unit of the terminal 120 may store a content database (DB) for storing multiple pieces of content and information about the terminal 120. Here, the content DB may include execution data required to execute content and the attribute information of the content, and may store content usage information based on the execution of the content and the like. Further, the information about the terminal 120 may include terminal specification information.

Furthermore, the communication unit of the terminal 120 may perform a function of transmitting and receiving data to and from the application server 110 over the network. Here, the communication unit of the terminal 120 may include a Radio Frequency (RF) transmission means for up-converting and amplifying the frequency of a signal to be transmitted, and an RF reception means for low-noise amplifying a received signal and down-converting the amplified signal. The communication unit of the terminal 120 may include at least one of a wireless communication module and a wired communication module. Further, the wireless communication module is a component for transmitting and receiving data according to a wireless communication method, and may transmit and receive data to and from the application server 110 using any one of a wireless network communication module, a wireless Local Area Network (LAN) communication module, and a wireless Personal Area Network (PAN) communication module when the terminal 120 uses wireless communication. Furthermore, the wired communication module is configured to transmit and receive data in a wired manner. The wired communication module accesses the network in a wired manner and is then capable of transmitting and receiving data to and from the application server 110 over the network. That is, the terminal 120 accesses the network using the wireless communication module or the wired communication module and is capable of transmitting and receiving data to and from the application server 110 over the network. In particular, the network according to the present invention may transmit and receive data required to recommend an optimal card based on the optimal card recommendation system while the terminal 120 communicates with the application server 110 and the BLE server 140.

Further, the control unit of the terminal 120 may be a process device for running the operating system (OS) and individual components. For example, the control unit may control the overall process for accessing the application server 110. When accessing the application server 110 through a separate service application, the control unit may control the overall process for executing a service application in response to the user's request, may control the service so that a service usage request is transmitted to the application server 110 at the same time that the service application is executed, and may also perform control such that information about the terminal 120, required for the authentication of the user, is transmitted together with the request.

Further, the control unit of the terminal 120 may execute specific content stored in the storage unit of the terminal 120 in response to the user's request. At this time, the control unit may store content usage history depending on the execution of the content as content usage information.

Furthermore, the terminal 120 of the user has an application for an application pay service installed thereon, and may correspond to the terminal 120 of the user who has subscribed to the application pay service.

The POS device 130, which is a device for performing payment for a commodity at a store 160, may correspond to a device capable of performing the application pay service based on communication with the application server 110.

The BLE sever 140 may be a server for detecting the location of the terminal 120 and providing information using Bluetooth Low Energy (BLE) technology.

Here, the BLE technology denotes short-range wireless communication technology for periodically transmitting information about an object based on Bluetooth 4.0 within the range of a certain radius near a terminal. That is, even if the user of the terminal 120 does not take a separate action, the location of the user is automatically detected, and then a signal for a payment service may be provided.

Here, a beacon denotes short-range data communication technology using BLE, and enables various types of application services, such as object and context awareness, content push, indoor positioning, automatic check-in, and geo-fencing, based on proximity positioning. Compared to previous similar technology, the beacon may be provided more conveniently at lower expense, thus functioning as an accelerator for forming new service markets. Here, the beacon may also mean all types of devices for periodically transmitting certain signals so as to indicate the certain signals. For example, the BLE device 150 shown in FIG. 1 may correspond to a beacon.

Beacons may be classified into a sound-based low frequency beacon, an LED beacon, a WiFi beacon, a Bluetooth beacon, etc. depending on the method for transmitting signals. Further, such a beacon is capable of transmitting periodic signals using a small packet corresponding to about 21 bytes, does not require separate pairing with a target for receiving signals, and is capable of transmitting the ID value of a beacon transmitter and signals corresponding to received signal strength at a maximum distance of 50 meters even if the beacon is operated at low power. Furthermore, the beacon may be freely used at any offline store because it is inexpensive and may be easily attached to any place owing to its small size.

For example, the beacon is installed at a specific place in the store 160, and is configured to, when the user or customer having the terminal 120 enters the area of the BLE beacon, detect the corresponding terminal 120 and transmit a signal including information.

The store 160 may be an offline shop in which payment is performed and may correspond to an application pay service affiliated store in which both an application pay agent and the BLE device 150 are installed.

Below, the payment system according to the embodiment of the present invention will be described in view of the flow of service.

First, the user may enter the store 160 with his or her terminal 120.

Here, the entry of the user into the store 160 may be detected using a beacon, which is BLE-based short-range data communication technology.

That is, in accordance with the present invention, the terminal 120 on which Bluetooth is activated may receive a BLE signal, transmitted from the BLE device 150, which is the beacon located in the store 160, using a BLE Software Development Kit (SDK) 141. Here, the BLE signal may also be received through the application 111 installed based on the BLE SDK 141. Thereafter, when the terminal 120 transmits information included in the BLE signal to the BLE server 140, the BLE server 140 may provide information related to BLE benefits corresponding to the BLE signal to the terminal 120.

Thereafter, the terminal 120 may access the application server 110 based on information about the BLE benefits received from the BLE server 140 through the application.

Here, the application server 110 may include at least one module for performing payment.

For example, the application server 110 may include a membership provision module capable of providing membership information based on both the user information of the terminal 120 and store information corresponding to the store 160. Here, the membership provision module may include a separate database (DB) capable of storing membership information for respective users and store information for respective stores.

As another example, the application server 110 may further include an application pay service-based payment module for performing payment using an application pay service. Here, the application pay service-based payment module may include credit card information or bank information required to perform payment using the application pay service. For example, when the user performs payment using the application pay service with a credit card so as to purchase a commodity at the store 160, the application pay service-based payment module and a credit card application may transmit and receive data required for real-time payment to and from each other.

Here, the application pay service-based payment module may include an optimal card recommendation apparatus for recommending an optimal card, among credit cards possessed by the user, in consideration of discount benefits, shop benefits, and accumulation benefits based on the credit card information. For example, for respective types of credit cards, information about benefits obtained when a target usage record in the previous month have been achieved and benefits provided through membership cards may be aggregated, and thus an optimal card based on a discount rate or an accumulation rate may be recommended. Further, the optimal card recommendation apparatus may be implemented independently of the application pay service-based payment module.

As a further example, the application server 110 may include a store information provision module capable of providing benefit information about coupons or Gifticons that can be used by the user at the store 160 or information about events currently underway at the store 160 and the marketing of the store 160, together with the membership information provided through the membership provision module. For example, the store information provision module may inquire about Gifticons or coupons that can be used by the user at the store 160 through the application and provide the Gifticons or coupons to the application server 110, thus allowing the user to use the Gifticons or coupons through the application installed on the terminal 120. Further, the store information provision module provides event information and marketing information corresponding to a plurality of stores for providing services based on the payment system according to the embodiment of the present invention to the application server 110, and is then capable of providing information about events and marketing that are currently underway at the store 160 visited by the user to the terminal 120 of the user.

Thereafter, the user who accesses the application server 110 through the terminal 120 may perform advanced authentication using the application pay service in order to purchase a commodity at the store 160. For example, the user may enter a stage for advanced authentication using the action of receiving a purchase-related push message through the BLE device 150 and clicking a purchase button included in the push message. Here, as a means for advanced authentication for purchase, that is, primary authentication, any of various schemes, such as the entry of a personal identification number (PIN), the use of a picture image gesture, and the use of a touch gesture, may be used.

Thereafter, the user may move to the POS device 130 while holding a commodity to be purchased at the store 160, may indicate his or her intention to pay for the commodity using the application pay service to the clerk of the store 160, and may then perform secondary authentication for commodity purchase and payment. For example, a secondary authentication method may include various schemes, such as a scheme for allowing the user to be located in a payment zone near the POS device 130 while carrying his or her terminal 120, a scheme for inputting a motion gesture pattern using the terminal 120 in the payment zone, a scheme for inputting a touch pattern to a signature pad included in the POS device 130, a scheme for generating an intersection on a signature pad, and a question-and-answer scheme.

Further, secondary authentication may be performed such that the clerk of the store 160 scans the commodity to be purchased and identifies the user who uses the application pay service through the POS device 130, after which payment may be performed.

Thereafter, when even secondary authentication is completed, the application server 110 may send a message indicating whether payment based on the application pay service has been successfully performed to at least one of the user's terminal 120 and the POS device 130.

When the payment system using the application pay service is used, it is possible for the user to pay for a commodity using an optimal card merely by performing primary authentication and performing simple secondary authentication at the store 160.

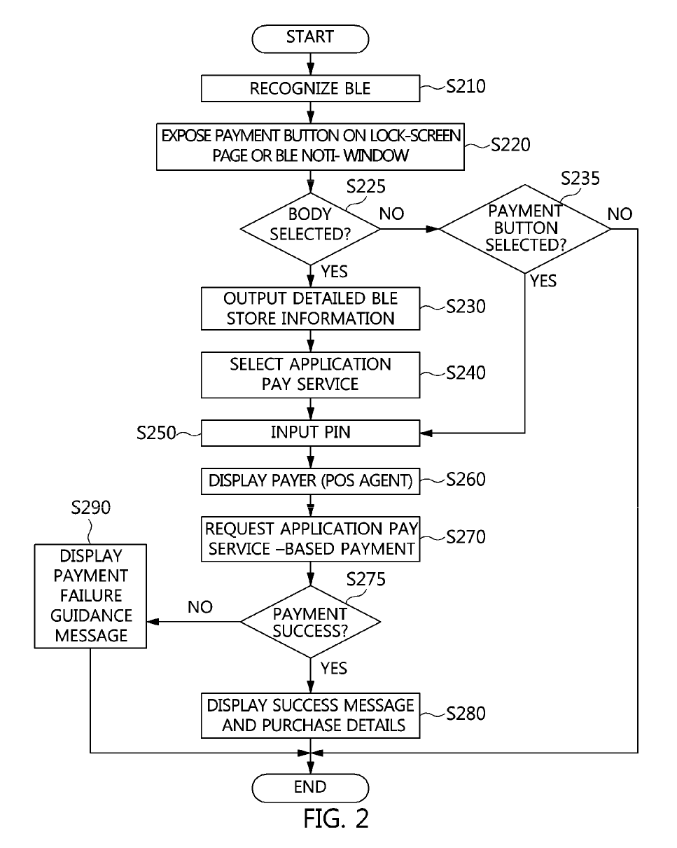

FIG. 2 is an operation flowchart showing an embodiment of a payment method using BLE Push in the payment system shown in FIG. 1.

Referring to FIG. 2, a method for performing payment based on BLE Push, that is, a push message, in the payment system shown in FIG. 1 is configured such that, when a user who has subscribed to an application pay service enters an offline store, an application installed on the terminal of the user recognizes a BLE signal transmitted from a BLE device at step S210.

Thereafter, a payment button is exposed, together with coupon information and discount information which are included in the BLE signal, to at least one of a lock-screen page and a BLE notification (BLE Noti) window on the terminal of the user, and is then provided to the user at step S220.

Thereafter, it is determined whether the user selects a body area corresponding to the coupon information and discount information exposed to the terminal at step S225.

If it is determined at step S225 that the user selects the body area, a screen showing detailed information about the store that transmitted the BLE signal is output via the terminal of the user at step S230.

Thereafter, as the user selects the application pay service included in the detailed store information screen, that is, the payment button, at step S240, a PIN input window is output via the user terminal so as to perform primary authentication for the application pay service at step S250.

Here, primary authentication may be performed using a picture image gesture authentication technique or a touch gesture authentication technique.

When the user has not yet subscribed to the application pay service, a member subscription button for prompting the user to subscribe to the application pay service, instead of the application pay service and the payment button, may be displayed on the detailed store information screen.

Meanwhile, if it is determined at step S225 that the user does not select the body area, it is determined whether the user selects the payment button at step S235.

If it is determined at step S235 that the user selects the payment button, a PIN input window is output via the user terminal so as to perform primary authentication for the application pay service at step S250.

If it is determined at step S235 that the user does not select the payment button, it may be determined that the user does not use the application pay service, and the process may be terminated.

Thereafter, when primary authentication is performed in such a way that the user enters a PIN through the terminal, payer information corresponding to the user is displayed on the POS device at the store at step S260. For example, the picture of the user is displayed, thus allowing the clerk of the store to easily identify the payer.

Next, the user chooses the commodity to be purchased at the store, and request the clerk of the store to process payment using the application pay service through the POS device at step S270.

Here, the POS device may perform secondary authentication for the application pay service. For example, such secondary authentication may correspond to a scheme for allowing the user to be located in a payment zone near the POS device while carrying his or her terminal, a scheme for inputting a motion gesture pattern using the terminal in the payment zone, a scheme for inputting a touch pattern to a signature pad included in the POS device, a scheme for generating an intersection on a signature pad, or a question-and-answer scheme.

Thereafter, whether payment based on the application pay service has succeeded is determined at step S275. If it is determined at step S275 that payment has succeeded, purchase details or payment details, together with a payment success message, are displayed on the terminal of the user at step S280.

In contrast, if it is determined at step S275 that payment has failed, a payment failure guidance message is displayed on the terminal of the user at step S290.

Here, the cause of the payment failure may be briefly displayed in the form of text.

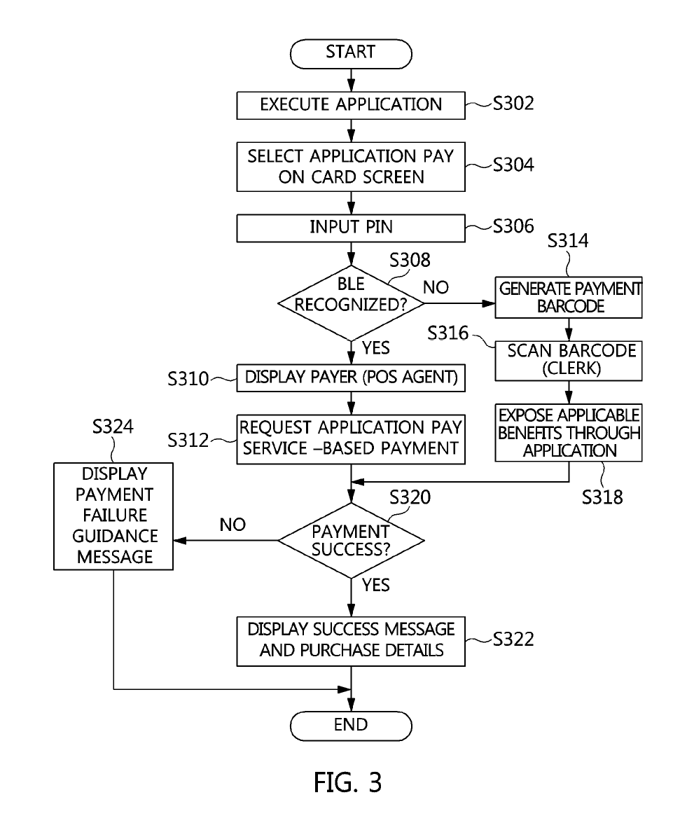

FIG. 3 is an operation flowchart showing an embodiment of a typical payment method performed by the payment system shown in FIG. 1.

Referring to FIG. 3, in the typical payment method performed by the payment system shown in FIG. 1, a user who has subscribed to an application pay service enters an offline store (or a bricks-and-mortar store) and executes an application installed on his or her terminal at step S302.

Here, the application may correspond to an application for the application pay service.

Thereafter, the user selects “application pay” on a card select screen on which payment cards registered in the application are displayed at step S304.

At this time, the application pay service may be registered in the application using any one of payment cards in the same manner as a typical credit card.

Thereafter, a PIN input window is output via the user terminal so as to perform primary authentication for the application pay service at step S306.

In this case, primary authentication may also be performed using a picture image gesture authentication technique or a touch gesture authentication technique.

Thereafter, it is determined whether the terminal that performed primary authentication may be recognized via a BLE signal (BLE recognition) at step S308

If it is determined at step S308 that BLE recognition is possible, the terminal of the user is recognized based on BLE technology, and thus payer information corresponding to the user is displayed on the POS device at step S310.

Thereafter, the user chooses the commodity to be purchased at the store and requests the clerk of the store to process payment based on the application pay service via the POS device at step S312.

Here, the POS device may perform secondary authentication for the application pay service. For example, secondary authentication may correspond to a scheme for allowing the user to be located in a payment zone near the POS device while carrying his or her terminal, a scheme for inputting a motion gesture pattern using the terminal in the payment zone, a scheme for inputting a touch pattern to a signature pad included in the POS device, a scheme for generating an intersection on a signature pad, or a question-and-answer scheme.

Further, if it is determined at step S308 that BLE recognition is impossible, a barcode required to perform payment is generated and displayed on the terminal of the user at step S314.

Here, the barcode may be a barcode that enables payment to be performed based on the application pay service.

Thereafter, when the user chooses a commodity to be purchased at the store and shows the barcode generated by the terminal via the POS device, the clerk scans the barcode at step S316, and available benefits are output to the terminal through the application and are shown to the user at step S318.

At this time, information about benefits may be provided through a popup push message.

Thereafter, whether payment based on the application pay service has succeeded is determined at step S320. If it is determined at step S320 that payment has succeeded, purchase details or payment details together with a payment success message are displayed on the terminal of the user at step S322.

In contrast, if it is determined at step S320 that payment has failed, a payment failure guidance message is displayed on the terminal of the user at step S324.

Here, the cause of the payment failure may also be briefly displayed in the form of text.

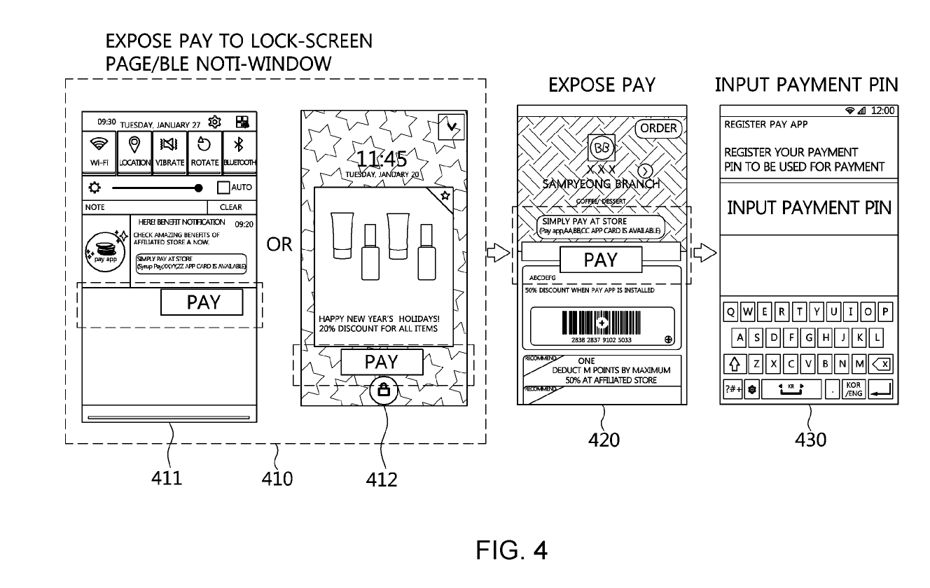

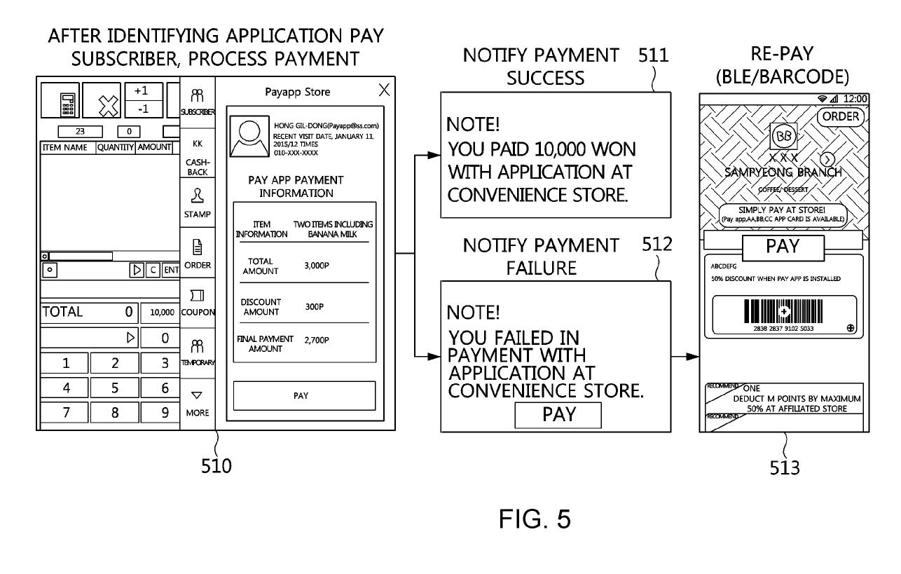

FIGS. 4 and 5 are diagrams showing a payment process screen when a user is an application subscriber in the payment method using BLE Push, shown in FIG. 2.

Referring to FIGS. 4 and 5, in the payment method based on BLE Push, shown in FIG. 2, when a user who has subscribed to an application pay service enters an offline store, a commodity benefit screen 410 is displayed to the user through an application installed on the terminal of the user.

Here, a BLE signal transmitted from a beacon installed at the store is recognized through the application installed on the terminal, and the commodity benefit screen 410, including the discount information and the coupon information of the store, which are included in the BLE signal, may be exposed to the terminal.

Here, the commodity benefit screen 410 is configured such that when the terminal is locked, discount information and coupon information, together with a payment button, may be displayed in the lock-screen page 412 of the terminal.

Further, the commodity benefit screen 410 is configured such that discount information and coupon information, together with a payment button, may be displayed in the BLE notification window (BLE Noti) 411 of the terminal.

In this case, when the user selects a body area indicating discount information and coupon information on the commodity benefit screen 410, a detailed store screen 420 of the store corresponding to the commodity benefit screen 410 may be displayed on the terminal.

On the detailed store screen 420, detailed discount and coupon information may be displayed together with store information. Further, the payment button is displayed together with the detailed store screen, thus allowing the user to perform a procedure for payment at any time.

At this time, when the user selects the payment button displayed on the detailed store screen 420 or the commodity benefit screen 410, a payment PIN input window 430 may be displayed in order to perform primary authentication for the application pay service.

Here, primary authentication may be performed using a picture image gesture authentication scheme or a touch gesture authentication scheme, as well as such a PIN input authentication scheme.

Thereafter, when primary authentication based on the PIN input by the user is completed, information about the user who has completed primary authentication, that is, a purchaser who has completed primary authentication, is displayed on the payment screen 510 of the POS device installed at the store.

Thereafter, when the user who has completed the primary authentication moves to the POS device while carrying the commodity to be purchased, and requests the clerk of the store to process payment based on the application pay service, the clerk may check the identity of the user through the payment screen 510. For example, the user may be checked using the picture of the user.

In this case, after secondary authentication for the application pay service is performed, payment may proceed.

Thereafter, when payment based on the application pay service succeeds, a payment success message 511 may be sent to the terminal of the user.

Here, the name of the store at which payment is performed, the payment means, and the payment amount may be displayed in the payment success message 511.

Further, when payment fails, a payment failure message 512 is sent to the terminal of the user, and a re-payment screen 513 may be displayed on the terminal so as to perform payment again.

Here, on the re-payment screen 513, a payment button may be displayed, or a barcode for the application pay service may also be displayed.

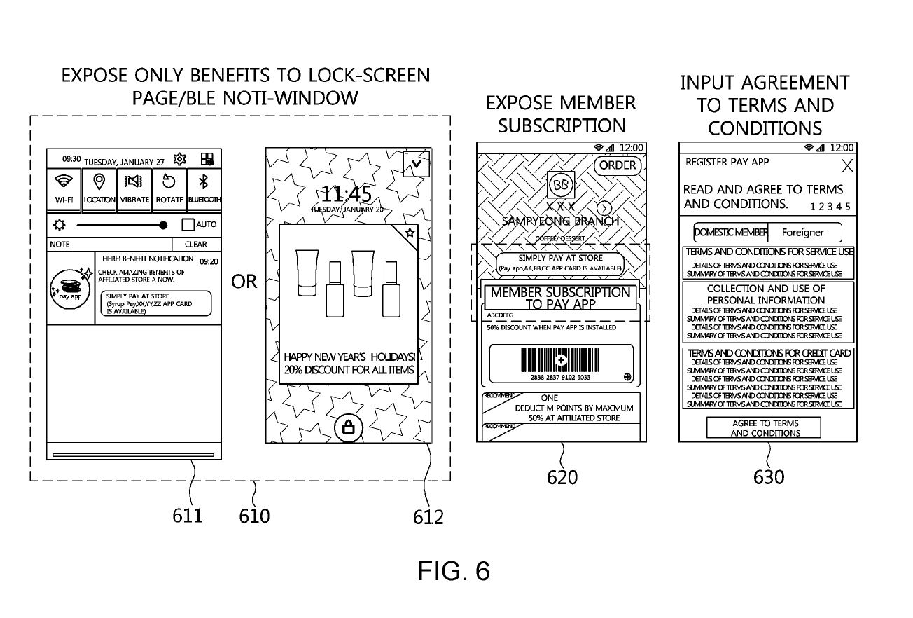

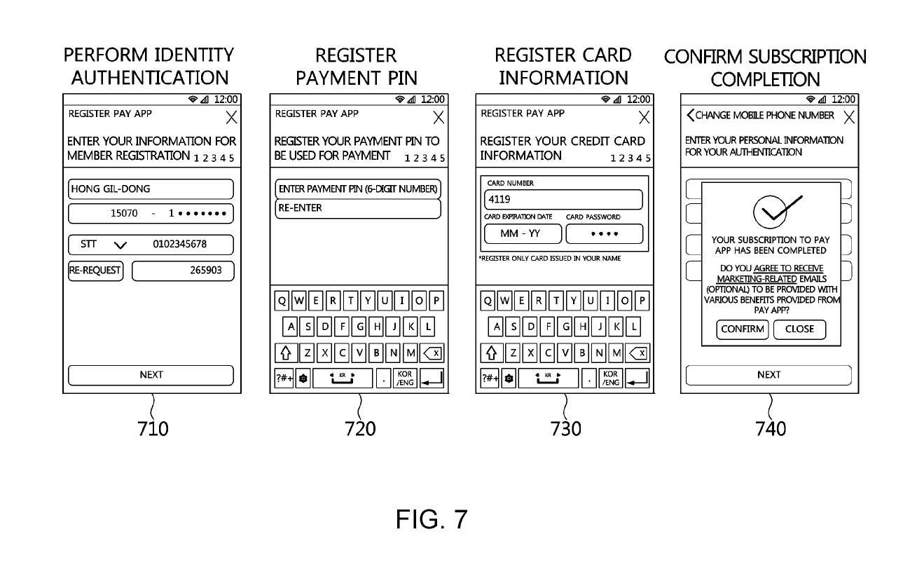

FIGS. 6 and 7 are diagrams showing a member subscription screen when a user is a not an application subscriber in the payment method using BLE Push, shown in FIG. 2.

Referring to FIGS. 6 and 7, in the payment method using BLE Push, shown in FIG. 2, when a user who is not a member of the application pay service enters an offline store, a commodity benefit screen 610 is displayed to the user through an application installed on the terminal of the user.

Here, a BLE signal transmitted from a beacon installed at the store is recognized through the application installed on the terminal, and the commodity benefit screen 610, including the discount information and coupon information of the store, which are included in the BLE signal, may be exposed to the terminal.

Here, the commodity benefit screen 610 is configured such that, when the terminal is locked, discount information and coupon information are displayed on the lock-screen page 612 of the terminal, but, because the user is not a member of the application pay service, a payment button may not be displayed.

Further, the commodity benefit screen 610 is configured such that discount information and coupon information may be displayed in the BLE notification window (BLE Noti) 611 of the terminal.

When the user selects a body area indicating discount information and coupon information on the commodity benefit screen 610, a detailed store screen for the store corresponding to the commodity benefit screen 610 may be displayed on the terminal.

Here, on the detailed store screen 620, detailed discount and coupon information may be displayed together with store information. Further, a pay App subscription button for prompting the user to subscribe to the application pay service is displayed together with the store information, thus allowing the user to subscribe to the service for payment anytime.

In this case, when the user selects the pay App subscription button, a terms agreement screen 630, required for subscription to the application pay service, may be displayed on the terminal of the user.

Thereafter, when the user agrees to the terms and conditions, an identity authentication screen 710 is displayed on the terminal, thus allowing the user himself or herself to be authenticated.

Here, identity authentication may be performed in such a way that the user enters his or her name, resident registration number, telecommunication company, mobile phone number, etc., and then enters an authentication number.

Thereafter, when the identity authentication of the user has been completed, a payment PIN registration screen 720 may be displayed on the terminal so as to register a PIN to be used in the application pay service.

Next, a card information registration screen 730 may be displayed on the terminal to register a card to be used in the application pay service.

Then, after all information has been entered, a subscription confirmation screen 740 is finally displayed, and subscription has been completed when the user selects “confirm”.

Thereafter, a payment button is displayed on the terminal of the user, and primary authentication based on a PIN is performed, and then the application pay service may be provided.

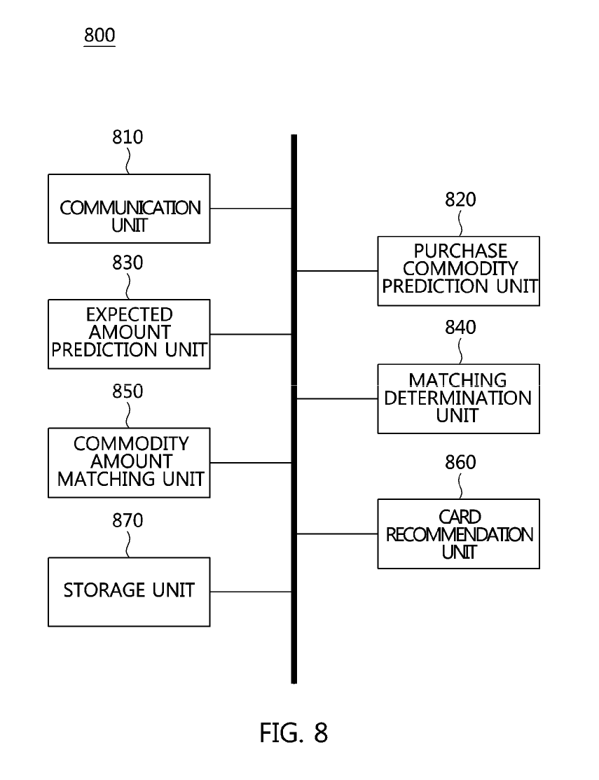

FIG. 8 is a block diagram showing an optimal card recommendation apparatus according to an embodiment of the present invention.

Referring to FIG. 8, an optimal card recommendation apparatus 800 according to an embodiment of the present invention may include a communication unit 810, a purchase commodity prediction unit 820, an expected amount prediction unit 830, a matching determination unit 840, a commodity amount matching unit 850, a card recommendation unit 860, and a storage unit 870.

The communication unit 810 functions to transmit and receive information required to recommend an optimal card to and from the terminal of the user over a communication network, such as a typical network. In particular, the communication unit 810 according to an embodiment may receive pieces of information required to predict one or more expected purchase commodities and an expected payment amount from the terminal, and may provide information corresponding to the optimal card to the terminal.

Here, information required to predict the one or more expected purchase commodities and the expected payment amount may be received from a separate application server. For example, user information, such as the purchase information, personal information, possessed payment card information, and possessed membership card information of the user, and various types of information, pertaining for example to events, discounts, and marketing information provided by the corresponding store, may be received.

The purchase commodity prediction unit 820 predicts one or more commodities that are expected to be purchased by the user (hereinafter referred to as “one or more expected purchase commodities”) at the store. That is, conventional card recommendation technology is configured to recommend an optimal payment card and an optimal membership card in consideration of information about the type and price of the corresponding commodity to be purchased by the user in the state in which the commodity to be purchased by the user has been fixed. Thus, the conventional card recommendation technology merely enables a card to be recommended only when the user enters information about the commodity to be purchased through the application, or only when commodity information is provided through the POS device at the store. However, such card recommendation technology cannot provide a particular advantage except for convenience in that information about the card to be used for payment is provided when the user purchases a commodity through the POS device.

In contrast, the present invention predicts in advance commodities expected to be purchased by the user and recommends a card in the state in which the commodity to be purchased by the user at the store is not yet fixed, thus providing assistance in further simplifying and facilitating the procedure in which the user actually performs payment through the POS device.

Here, one or more commodities expected to be purchased may be predicted in consideration of at least one of the purchasing pattern of the user in an affiliated store group corresponding to the store, the purchasing pattern of a user group identical to the user in the affiliated store group, benefit information provided by each store, and the utilization of benefits by the user.

In an embodiment, the purchasing patterns of the user for respective affiliated store groups may be generated using information, such as the types of commodities purchased by the user in each affiliated store group, which sells household items, the time of the purchase, or the price range of purchased commodities.

In another embodiment, based on the age, gender, occupation, and preference information of the user, a user group may be generated based on other users corresponding to information similar to the above information, and the purchasing pattern of the corresponding user group may be generated and may be used to predict commodities that are expected to be purchased.

In a further embodiment, information about the store visited by the user may be obtained, and benefit information currently provided by the store, that is, information about discounted commodities, commodities corresponding to a Buy-One-Get-One-Free (BOGOF) offer, or commodities available for a limited time, may be obtained and used to predict the commodities that are expected to be purchased.

In yet another embodiment, commodities expected to be purchased may be predicted in consideration of how the user has utilized benefits obtained from the purchase of commodities. That is, benefit information preferred by the user between discounts and accumulation may be considered, or a usage pattern for accumulated points may be considered when the commodities expected to be purchased are predicted.

Here, unnecessary commodity items may be detected in consideration of at least one of information about the commodity most recently purchased by the user in the affiliated store group and the time of the purchase, and may be excluded when one or more commodities expected to be purchased are predicted.

For example, when there is a commodity purchased by the user in an affiliated store group identical to a specific store before the user visits the specific store, there is a low probability that the user will purchase the corresponding commodity at the current store. Therefore, when the commodity expected to be purchased at the current store is predicted, the commodity previously purchased in the same affiliated store group may be recognized as an unnecessary commodity item, and may be excluded from the commodities expected to be purchased.

In still another embodiment, when there is a commodity purchased by the user in an affiliated store group identical to a specific store before the user visits the specific store, the commodity may instead be predicted to be the commodity expected to be purchased in consideration of the time at which the corresponding commodity was purchased and whether the commodity is discounted or not. That is, assuming that hair gel is on sale at a discount price at a hair product shop visited by the user, and the user purchased the hair gel one month ago, there may be a high probability that the user will purchase the hair gel owing to the benefits of the discount price at this visit.

The expected amount prediction unit 830 predicts the amount of the payment that is expected to be made by the user (hereinafter referred to as an “expected payment amount”) at the corresponding store.

Here, the reason for additionally predicting an expected payment amount as well as an expected purchase commodity so as to recommend an optimal card is that there may be benefits that are provided when a predetermined amount or more is paid at each store. Therefore, the amount required to purchase a commodity, that is, the payment amount, may be a very important factor in recommending a card. For example, assuming that a discount benefit is provided when commodities corresponding to more than 100,000 Won are purchased with a specific payment card at a store visited by the user, a payment amount for purchase commodities, which are expected to be purchased by the user at the corresponding store, is predicted to reach an amount of 100,000 Won, thus allowing the user to obtain more benefits.

Here, the expected payment amount may be predicted in consideration of at least one of the purchasing pattern of the user, information about the amount of the purchase by a single user at the store, and information about the amount of each purchase by a user group identical to the user in an affiliated store group.

In an embodiment, when the purchasing pattern of the user, which was considered when the expected purchase commodity was predicted, is used, information about the prices of commodities to be purchased by the user may be acquired, and thus the expected payment amount may be predicted in consideration of the purchasing pattern of the user.

In another embodiment, an expected payment amount may be predicted using information about the average purchase amount by a single user at the store visited by the user.

In a further embodiment, whether the store visited by the user is a jewelry shop which sells relatively expensive goods, or a grocery shop which sells relatively cheap goods, is determined, and information about the amount of each purchase in the corresponding affiliated store group may be considered. Further, whether a user is a student, a housewife, or an office worker is determined, and thus information about the amount of each purchase by a user group identical to the user may be considered. That is, in the cases where the user is a student and where the user is an office worker, there may be a great difference in consumption tendencies, and thus an expected payment amount may be predicted in consideration of the purchase amount information based on the user group.

The matching determination unit 840 compares the total amount of one or more expected purchase commodities with the expected payment amount, and then determines whether to match the one or more expected purchase commodities and the expected payment amount with each other. For example, assuming that the expected payment amount is predicted to be excessively high compared to the number of the one or more expected purchase commodities, there is the possibility that the reliability of the recommended card may be deteriorated because the tendencies of two conditions that are considered when recommending an optimal card are different from each other. Therefore, it is possible to compare the total amount obtained by summing the prices of one or more expected purchase commodities with the expected payment amount, and to determine to match the expected purchase commodities with the expected payment amount if it is determined that a difference is present between the total amount and the expected payment amount. Then, an algorithm for performing matching may be executed.

Further, if it is determined that the total amount is relatively similar to the expected payment amount when comparing the total amount with the expected payment amount, matching is not performed, and the expected payment amount may be used as a reference value that is considered when recommending an optimal card.

At this time, when the difference between the total amount and the expected payment amount is equal to or greater than a preset reference difference, it may be determined that matching is to be performed. For example, when the preset reference difference is 30,000 Won, matching may be performed when the difference between the total amount and the expected payment amount is 30,000 Won or more.

Here, the preset reference difference may be set to different values depending on affiliated store groups. For example, the reference difference in an affiliated store group that sells expensive commodities is set to a value larger than that of the reference difference in an affiliated store group that sells relatively inexpensive commodities, thus preventing unnecessary matching from being performed. Further, the reference difference in an affiliated store group that sells inexpensive commodities is set to a smaller value, thus improving the accuracy of the algorithm for recommending an optimal card.

The commodity amount matching unit 850 is configured to, when performing matching between the one or more expected purchase commodities and the expected payment amount, adjust any one of the expected payment amount and the one or more expected purchase commodities, and then match the one or more expected purchase commodities with the expected payment amount. That is, in order to reduce the difference between the total amount of the one or more expected purchase commodities and the expected payment amount, any one of the total amount and the expected payment amount may be adjusted.

Here, when the total amount is greater than the expected payment amount, a commodity having a low probability of being purchased is first excluded from the one or more expected purchase commodities, and thus the total amount may be adjusted to match the expected payment amount. For example, it may be assumed that there are 10 expected purchase commodities, that the total amount is greater than the expected payment amount, and that the difference between the total amount and the expected payment amount is greater than a preset reference difference by 50,000 Won. In this case, it is determined that an unnecessary commodity is further included in the expected purchase commodities, the probabilities of being purchased are determined for 10 respective expected purchase commodities, and the commodity having the lowest probability of being purchased may be excluded first.

Further, when the total amount is less than the expected payment amount, the expected payment amount is adjusted to match the total amount, and thus the one or more expected purchase commodities may match the expected payment amount. For example, it may be assumed that there are five expected purchase commodities, that the total amount is less than the expected payment amount, and that the difference between the total amount and the expected payment amount is greater than a preset reference difference by 50,000 Won. In this case, it is preferable to recommend a card using a method for adjusting the expected payment amount to match the total amount, rather than using a method for adding a commodity having a low probability of being purchased to the expected purchase commodities for the additional purchase of the commodity. That is, since the probability that the user will purchase an unnecessary commodity is low, the accuracy of the algorithm for recommending a card may be improved by decreasing the expected payment amount.

The card recommendation unit 860 recommends an optimal card, among multiple cards registered in the application for payment, in consideration of at least one of the expected payment amount and the one or more expected purchase commodities.

Here, the multiple cards may include payment cards such as a cash card, a debit card, and a credit card for payment. Further, the multiple cards may include a membership card, a cash-back card, and a discount card, which enable points to be accumulated or discounts to be provided when commodities are purchased.

Here, the application may include a mobile payment application, a mobile electronic wallet application, etc., which register the card information of the user and allow the terminal to perform payment using the card information.

In this case, among the one or more payment cards included in the multiple cards, the optimal payment card for providing the maximum benefits may be recommended. For example, depending on whether the payment card is a credit card, a cash card or a debit card, the discount rate or accumulation rate may differ, and thus the discount rates and accumulation rates of respective payment cards may be checked so as to recommend a card enabling the maximum benefits to be obtained.

In another embodiment, the discount or accumulation rates of respective card companies and banks corresponding to credit cards or debit cards may differ, and thus the discount rate and accumulation rates of respective card companies and banks may be checked so as to recommend an optimal card.

In a further embodiment, the benefits of respective credit cards or debit cards may be provided differently depending on the card usage record in the previous month. Thus, an optimal card may be recommended by additionally considering whether the card usage record in the previous month has been achieved.

In yet another embodiment, when multiple optimal cards having similar discount rates and accumulation rates are selected, an optimal card may be recommended such that the card usage record in the current month is checked and a card, the usage record of which can be achieved, is considered so as to be provided with benefits in the next month.

In still another embodiment, in the case of a payment card having a designated payment due date, such as a credit card, an optimal card may be recommended by applying an algorithm in which payment timing is considered based on the payment due date. In other words, when the card usage record of card A, the payment due date of which is approaching, is not yet achieved, the recommendation priority of card A is designated to be high, and card A may then be recommended until the payment due date of card A is reached.

Further, among one or more membership cards included in multiple cards, an optimal membership card may be recommended in consideration of at least one of an accumulation rate and a discount rate. For example, when an optimal payment card is recommended, a membership card, which can be used together with the recommended payment card and can be used at the corresponding store, is recommended together with the payment card, thus allowing the user to be sufficiently provided with the benefits of discounts and accumulation without missing the benefits.

Furthermore, when it is possible to purchase a commodity using points accumulated in a membership card, the corresponding membership card may be included in a card recommendation list for payment and may also be recommended. In addition, when payment using points is possible according to the setting of the user, the recommendation priority of the corresponding membership card is designated to be higher than that of a credit card or a debit card, and then the membership card may be primarily recommended.

Here, information about an optimal payment card and an optimal membership card may be provided together through the application. For example, information about the optimal membership card that matches information about the optimal payment card may be displayed together on a single screen of the application. Alternatively, when the optimal payment card is clicked, optimal membership cards that can be used together with the clicked optimal payment card may be provided in the form of a list in descending order of benefit amount.

As described above, the storage unit 870 stores various types of information generated during a procedure for providing the optimal card recommendation service according to an embodiment of the present invention.

In an embodiment, the storage unit 870 may be implemented independently of the optimal card recommendation apparatus 800 and may then support a function for the optimal card recommendation service. Here, the storage unit 870 may function as separate large-capacity storage and may include a control function for performing operations.

Meanwhile, the optimal card recommendation apparatus 800 is equipped with memory and may store information in the apparatus. In an exemplary embodiment, the memory is a computer-readable medium. In an exemplary embodiment, the memory may be a volatile memory unit, and in another exemplary embodiment, the memory may be a nonvolatile memory unit. In an embodiment, the storage may be a computer-readable medium. In various different embodiments, the storage may include, for example, a hard disk device, an optical disk device or other types of large-capacity storage device.

Such an optimal card recommendation apparatus 800 is used, and thus the user may use an automatic payment service with a previously recommended payment card when paying for a commodity at a store using his or her mobile terminal.

Further, a payment card and a membership card which allow the user to obtain the maximum benefits, such as discounts or accumulation, are recommended depending on the commodity expected to be purchased by the user and the expected payment amount, thus inducing the user to consume appropriately and helping the user make a reasonable purchase.

Furthermore, an operation required by the user to pay at a store using a mobile terminal may be minimized, and thus there is an advantage in that the user's convenience may be maximized when commodities are purchased.

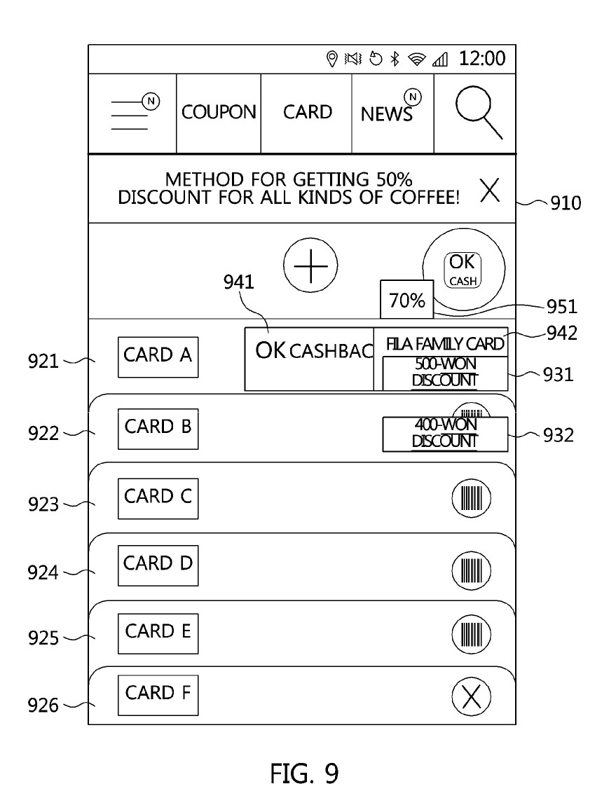

FIG. 9 is a diagram showing a screen required to recommend an optimal card in an application according to an embodiment of the present invention.

Referring to FIG. 9, on a card recommendation screen 910 required to recommend an optimal card in an application according to an embodiment of the present invention, at least one of pieces of discount amount information 931 and 932, membership cards 941 and 942, and usage record achievement rates 951 for respective cards, together with respective recommended cards 921 to 926, may be displayed.

Here, the card recommendation screen 910 may display the recommended cards 921 to 926, which are recommended through an optimal card recommendation algorithm, in descending order of benefit amount. For example, as shown in FIG. 9, the recommended card 921 determined to have the maximum benefits is displayed at the uppermost portion, and recommended cards 922 to 926 determined to have the next largest benefits may be sequentially displayed below the recommended card 921.

Further, if commodity prices are discounted when commodities are purchased with the recommended cards 922 to 926, the card recommendation screen 910 may display the pieces of discount amount information 931 and 932 such that they overlap the respective recommended cards 922 to 926. For example, when the recommended card 921 is used for payment, a 500-Won discount may be provided depending on the discount amount information 931.

Furthermore, the card recommendation screen 910 may display information about membership cards 941 and 942 that can be used together with the recommended cards 922 to 926.

Furthermore, the card recommendation screen 910 displays a usage record achievement rate 951 in the current month for each of the recommended cards 922 to 926, thus enabling usage record achievement information, which is required in order to obtain benefits through the corresponding card in the next month, to be easily checked. For example, in the case of credit cards, the range of application of benefits in the current month may differ greatly depending on whether the usage record in a previous month has been achieved. Therefore, the usage record achievement rate 951 may also be managed to obtain benefits in the next month while the recommended cards 922 to 926 are recommended.

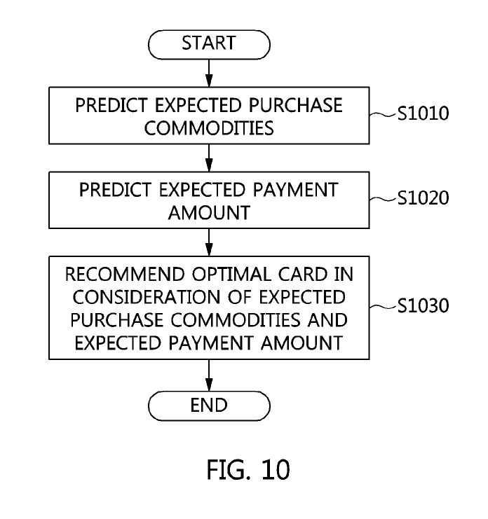

FIG. 10 is an operation flowchart showing a purchase prediction-based optimal card recommendation method according to an embodiment of the present invention.

Referring to FIG. 10, the purchase prediction-based optimal card recommendation method according to the embodiment of the present invention is an optimal card recommendation method using the purchase prediction-based optimal card recommendation apparatus. First, the optimal card recommendation method predicts one or more purchase commodities that are expected to be purchased by the user at a store at step S1010. That is, conventional card recommendation technology is configured to recommend an optimal payment card and an optimal membership card in consideration of information about the type and price of the corresponding commodity to be purchased by the user in the state in which the commodity to be purchased by the user has been fixed. Thus, the conventional card recommendation technology merely enables a card to be recommended only when the user enters information about the commodity to be purchased through the application, or only when commodity information is provided through the POS device at the store. However, such card recommendation technology cannot provide a particular advantage except for convenience in that information about the card to be used for payment is provided when the user purchases a commodity through the POS device.

In contrast, the present invention predicts in advance commodities expected to be purchased by the user and recommends a card in the state in which the commodity to be purchased by the user at the store is not yet fixed, thus providing assistance in further simplifying and facilitating the procedure in which the user actually performs payment through the POS device.

Here, one or more commodities expected to be purchased may be predicted in consideration of at least one of the purchasing pattern of the user in an affiliated store group corresponding to the store, the purchasing pattern of a user group identical to the user in the affiliated store group, benefit information provided by each store, and the utilization of benefits by the user.

In an embodiment, the purchasing patterns of the user for respective affiliated store groups may be generated using information, such as the types of commodities purchased by the user in each affiliated store group, which sells household items, the time of the purchase, or the price range of purchased commodities.

In another embodiment, based on the age, gender, occupation, and preference information of the user, a user group may be generated based on other users corresponding to information similar to the above information, and the purchasing pattern of the corresponding user group may be generated and may be used to predict commodities that are expected to be purchased.

In a further embodiment, information about the store visited by the user may be obtained, and benefit information currently provided by the store, that is, information about discounted commodities, commodities corresponding to a Buy-One-Get-One-Free (BOGOF) offer, or commodities available for a limited time, may be obtained and used to predict the commodities that are expected to be purchased.

In yet another embodiment, commodities expected to be purchased may be predicted in consideration of how the user has utilized benefits obtained from the purchase of commodities. That is, benefit information preferred by the user between discounts and accumulation may be considered, or a usage pattern for accumulated points may be considered when the commodities expected to be purchased are predicted.

Here, unnecessary commodity items may be detected in consideration of at least one of information about the commodity most recently purchased by the user in the affiliated store group and the time of the purchase, and may be excluded when one or more commodities expected to be purchased are predicted.

For example, when there is a commodity purchased by the user in an affiliated store group identical to a specific store before the user visits the specific store, there is a low probability that the user will purchase the corresponding commodity at the current store. Therefore, when the commodity expected to be purchased at the current store is predicted, the commodity previously purchased in the same affiliated store group may be recognized as an unnecessary commodity item, and may be excluded from the commodities expected to be purchased.

In still another embodiment, when there is a commodity purchased by the user in an affiliated store group identical to a specific store before the user visits the specific store, the commodity may instead be predicted to be the commodity expected to be purchased in consideration of the time at which the corresponding commodity was purchased and whether the commodity is discounted or not. That is, assuming that hair gel is on sale at a discount price at a hair product shop visited by the user, and the user purchased the hair gel one month ago, there may be a high probability that the user will purchase the hair gel owing to the benefits of the discount price at this visit.

Further, the purchase prediction-based optimal card recommendation method according to the embodiment of the present invention predicts the amount of the payment that is expected to be made by the user at the store at step S1020.

Here, the reason for additionally predicting an expected payment amount as well as an expected purchase commodity so as to recommend an optimal card is that there may be benefits that are provided when a predetermined amount or more is paid at each store. Therefore, the amount required to purchase a commodity, that is, the payment amount, may be a very important factor in recommending a card. For example, assuming that a discount benefit is provided when commodities corresponding to more than 100,000 Won are purchased with a specific payment card at a store visited by the user, a payment amount for purchase commodities, which are expected to be purchased by the user at the corresponding store, is predicted to reach an amount of 100,000 Won, thus allowing the user to obtain more benefits.

Here, the expected payment amount may be predicted in consideration of at least one of the purchasing pattern of the user, information about the amount of the purchase by a single user at the store, and information about the amount of each purchase by a user group identical to the user in an affiliated store group.

In an embodiment, when the purchasing pattern of the user, which was considered when the expected purchase commodity was predicted, is used, information about the prices of commodities to be purchased by the user may be acquired, and thus the expected payment amount may be predicted in consideration of the purchasing pattern of the user.

In another embodiment, an expected payment amount may be predicted using information about the average purchase amount by a single user at the store visited by the user.

In a further embodiment, whether the store visited by the user is a jewelry shop which sells relatively expensive goods, or a grocery shop which sells relatively cheap goods, is determined, and information about the amount of each purchase in the corresponding affiliated store group may be considered. Further, whether a user is a student, a housewife, or an office worker is determined, and thus information about the amount of each purchase by a user group identical to the user may be considered. That is, in the cases where the user is a student and where the user is an office worker, there may be a great difference in consumption tendencies, and thus an expected payment amount may be predicted in consideration of the purchase amount information based on the user group.

Further, although not shown in FIG. 10, the purchase prediction-based optimal card recommendation method according to the embodiment of the present invention compares the total amount of one or more expected purchase commodities with the expected payment amount, and then determines whether to match the one or more expected purchase commodities and the expected payment amount with each other. For example, assuming that the expected payment amount is predicted to be excessively high compared to the number of the one or more expected purchase commodities, there is the possibility that the reliability of the recommended card may be deteriorated because the tendencies of two conditions that are considered when recommending an optimal card are different from each other. Therefore, it is possible to compare the total amount obtained by summing the prices of one or more expected purchase commodities with the expected payment amount, and to determine to match the expected purchase commodities with the expected payment amount if it is determined that a difference is present between the total amount and the expected payment amount. Then, an algorithm for performing matching may be executed.

Further, if it is determined that the total amount is relatively similar to the expected payment amount when comparing the total amount with the expected payment amount, matching is not performed, and the expected payment amount may be used as a reference value that is considered when recommending an optimal card.

At this time, when the difference between the total amount and the expected payment amount is equal to or greater than a preset reference difference, it may be determined that matching is to be performed. For example, when the preset reference difference is 30,000 Won, matching may be performed when the difference between the total amount and the expected payment amount is 30,000 Won or more.

Here, the preset reference difference may be set to different values depending on affiliated store groups. For example, the reference difference in an affiliated store group that sells expensive commodities is set to a value larger than that of the reference difference in an affiliated store group that sells relatively inexpensive commodities, thus preventing unnecessary matching from being performed. Further, the reference difference in an affiliated store group that sells inexpensive commodities is set to a smaller value, thus improving the accuracy of the algorithm for recommending an optimal card.

Furthermore, although not shown in FIG. 10, the purchase prediction-based optimal card recommendation method according to the embodiment of the present invention adjusts any one of the one or more expected purchase commodities and the expected payment amount and then matches the one or more expected purchase commodities with the expected payment amount. That is, in order to reduce the difference between the total amount of the one or more expected purchase commodities and the expected payment amount, any one of the total amount and the expected payment amount may be adjusted.

Here, when the total amount is greater than the expected payment amount, a commodity having a low probability of being purchased is first excluded from the one or more expected purchase commodities, and thus the total amount may be adjusted to match the expected payment amount. For example, it may be assumed that there are 10 expected purchase commodities, that the total amount is greater than the expected payment amount, and that the difference between the total amount and the expected payment amount is greater than a preset reference difference by 50,000 Won. In this case, it is determined that an unnecessary commodity is further included in the expected purchase commodities, the probabilities of being purchased are determined for 10 respective expected purchase commodities, and the commodity having the lowest probability of being purchased may be excluded first.

Further, when the total amount is less than the expected payment amount, the expected payment amount is adjusted to match the total amount, and thus the one or more expected purchase commodities may match the expected payment amount. For example, it may be assumed that there are five expected purchase commodities, that the total amount is less than the expected payment amount, and that the difference between the total amount and the expected payment amount is greater than a preset reference difference by 50,000 Won. In this case, it is preferable to recommend a card using a method for adjusting the expected payment amount to match the total amount, rather than using a method for adding a commodity having a low probability of being purchased to the expected purchase commodities for the additional purchase of the commodity. That is, since the probability that the user will purchase an unnecessary commodity is low, the accuracy of the algorithm for recommending a card may be improved by decreasing the expected payment amount.

Furthermore, the purchase prediction-based optimal card recommendation method according to the embodiment of the present invention recommends an optimal card, among multiple payment cards registered in the application for payment, in consideration of at least one of the expected payment amount and the one or more expected purchase commodities at step S1030.

Here, the multiple cards may include payment cards such as a cash card, a debit card, and a credit card for payment. Further, the multiple cards may include a membership card, a cash-back card, and a discount card, which enable points to be accumulated or discounts to be provided when commodities are purchased.

Here, the application may include a mobile payment application, a mobile electronic wallet application, etc., which register the card information of the user and allow the terminal to perform payment using the card information.

In this case, among the one or more payment cards included in the multiple cards, the optimal payment card for providing the maximum benefits may be recommended. In an embodiment, depending on whether the payment card is a credit card, a cash card or a debit card, the discount rate or accumulation rate may differ, and thus the discount rates and accumulation rates of respective payment cards may be checked so as to recommend a card enabling the maximum benefits to be obtained.

In another embodiment, the discount or accumulation rates of respective card companies and banks corresponding to credit cards or debit cards may differ, and thus the discount rate and accumulation rates of respective card companies and banks may be checked so as to recommend an optimal card.

In a further embodiment, the benefits of respective credit cards or debit cards may be provided differently depending on the card usage record in the previous month. Thus, an optimal card may be recommended by additionally considering whether the card usage record in the previous month has been achieved.

In yet another embodiment, when multiple optimal cards having similar discount rates and accumulation rates are selected, an optimal card may be recommended such that the card usage record in the current month is checked and a card, the usage record of which can be achieved, is considered so as to be provided with benefits in the next month.

In still another embodiment, in the case of a payment card having a designated payment due date, such as a credit card, an optimal card may be recommended by applying an algorithm in which payment timing is considered based on the payment due date. In other words, when the card usage record of card A, the payment due date of which is approaching, is not yet achieved, the recommendation priority of card A is designated to be high, and card A may then be recommended until the payment due date of card A is reached.

Further, among one or more membership cards included in multiple cards, an optimal membership card may be recommended in consideration of at least one of an accumulation rate and a discount rate. For example, when an optimal payment card is recommended, a membership card, which can be used together with the recommended payment card and can be used at the corresponding store, is recommended together with the payment card, thus allowing the user to be sufficiently provided with the benefits of discounts and accumulation without missing the benefits.

Furthermore, when it is possible to purchase a commodity using points accumulated in a membership card, the corresponding membership card may be included in a card recommendation list for payment and may also be recommended. In addition, when payment using points is possible according to the setting of the user, the recommendation priority of the corresponding membership card is designated to be higher than that of a credit card or a debit card, and then the membership card may be primarily recommended.

Here, information about an optimal payment card and an optimal membership card may be provided together through the application. For example, information about the optimal membership card that matches information about the optimal payment card may be displayed together on a single screen of the application.

Alternatively, when the optimal payment card is clicked, optimal membership cards that can be used together with the clicked optimal payment card may be provided in the form of a list in descending order of benefit amount.

Further, although not shown in FIG. 10, in the purchase prediction-based optimal card recommendation method according to the embodiment of the present invention, the optimal card recommendation apparatus transmits and receives information, required to recommend an optimal card, to and from the terminal of the user over a communication network, such as a typical network, using a separate communication module. In particular, the communication module according to an embodiment of the present invention may receive information required to predict the one or more expected purchase commodities and the expected payment amount from the terminal, and may provide information corresponding to the optimal card to the terminal.

Here, the information required to predict the one or more expected purchase commodities and the expected payment amount may also be received from a separate application server.

Further, although not shown in FIG. 10, the purchase prediction-based optimal card recommendation method according to the embodiment of the present invention stores various types of information, generated during a procedure for providing the optimal card recommendation service according to an embodiment of the present invention, as described above, in a storage module.

Here, the storage module may be implemented independently of the optimal card recommendation apparatus to support a function for the optimal card recommendation service. Here, the storage module may function as separate large-capacity storage, and may include a control function for performing operations.

By means of such an optimal card recommendation method, when the user pays for a commodity at a store using his or her mobile terminal, an automatic payment service may be used using a payment card that is recommended in advance.

Further, a payment card and a membership card that allow the user to obtain the maximum benefits, such as discounts or accumulation, are recommended depending on the commodities expected to be purchased by the user and the amount of the payment expected to be made by the user, thus inducing the user to consume appropriately and helping the user make reasonable purchases.

Furthermore, the number of operations required by the user to pay at the store using the mobile terminal may be minimized, and thus there is an advantage in that the convenience of the user may be maximized when commodities are purchased.

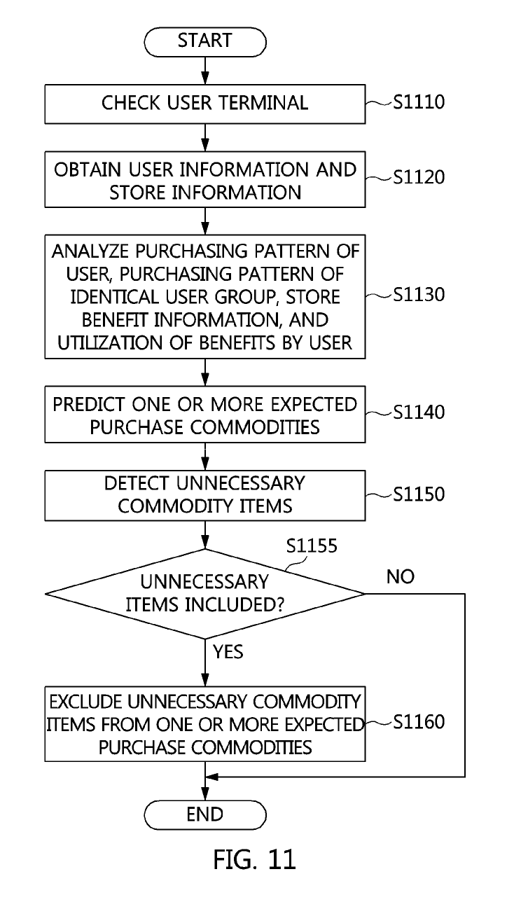

FIG. 11 is an operation flowchart showing in detail an expected purchase commodity prediction procedure corresponding to step S1010 in the optimal card recommendation method shown in FIG. 10.

Referring to FIG. 11, in the expected purchase commodity prediction procedure in the optimal card recommendation method shown in FIG. 10, when the user enters an offline store while holding his or her terminal, the terminal of the user is checked using BLE communication technology at step S1110. For example, a beacon, corresponding to a BLE device, may be installed at the entrance to the offline store. Thereafter, when the user enters the area of the beacon, the terminal of the user may be checked such that the application installed on the terminal recognizes a BLE signal transmitted from the beacon and transmits the BLE signal to the application server, and such that the application server transfers information to a POS device at the offline store.

Thereafter, user information and store information are obtained based on the application installed on the terminal at step S1120. For example, the user information may be private user information related to the personal information, purchase history information, and commodity-of-interest information of the user who has subscribed to the application, and the store information may correspond to information such as events, discounts and benefits corresponding to an offline store visited by the user.

Next, information about at least one of the purchasing pattern of the user in an affiliated store group corresponding to the store, the purchasing pattern of a user group identical to the user in the affiliated store group, the benefit information provided by each store, and the utilization of the benefits by the user is obtained based on the user information and the store information, and is then analyzed at step S1130.

Thereafter, one or more expected purchase commodities are predicted based on the results of analysis of the information at step S1140.

Then, unnecessary commodity items are detected at step S1150, and it is determined whether the unnecessary commodity items are included in the one or more expected purchase commodities at step S1155.

Here, the unnecessary commodity items may be detected in consideration of at least one of information about the commodity most recently purchased by the user in the affiliated store group and information about the time at which the commodity was purchased.

If it is determined at step S1155 that unnecessary commodity items are included, one or more expected purchase commodities are finally fixed after the unnecessary commodity items are excluded from the one or more expected purchase commodities, predicted at step S1140, at step S1160.

For example, if there is a history that, on the day before visiting a certain shop that sells toner cartridges for printers, the user purchased a toner cartridge for a printer of the same model as that of the toner cartridge at another specialty shop, there may be a low probability that the user will purchase again the corresponding toner cartridge model for the printer. Therefore, the corresponding toner cartridge model for the printer may be excluded from the expected purchase commodities.

Further, if it is determined at step S1155 that unnecessary commodity items are not included in the one or more expected purchase commodities, the one or more expected purchase commodities, predicted at step S1140, are finally fixed without change at step S1160.

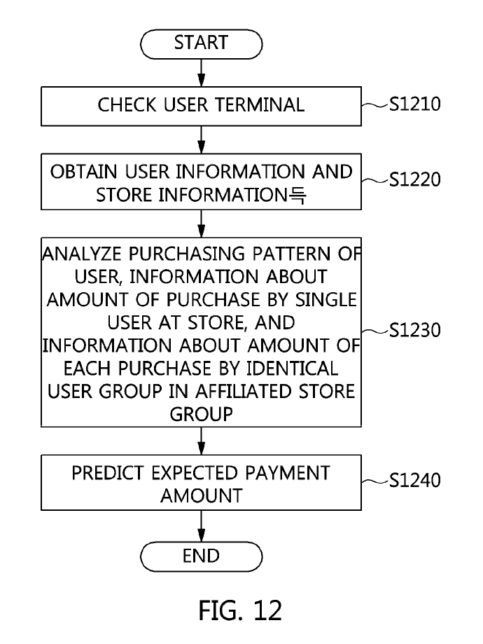

FIG. 12 is an operation flowchart showing in detail the expected payment amount prediction procedure corresponding to step S1020 in the optimal card recommendation method shown in FIG. 10.

Referring to FIG. 12, in the expected payment amount prediction procedure in the optimal card recommendation method shown in FIG. 10, when the user enters an offline store while holding his or her terminal, the terminal of the user is checked based on BLE communication technology at step S1210. For example, a beacon, corresponding to a BLE device, may be installed at the entrance to the offline store. Thereafter, when the user enters the area of the beacon, the terminal of the user may be checked such that the application installed on the terminal recognizes a BLE signal transmitted from the beacon and transmits the BLE signal to the application server, and such that the application server transfers information to a POS device at the offline store.

Next, user information and store information are obtained based on the application installed on the terminal at step S1220. For example, the user information may be private user information related to the personal information, purchase history information, and commodity-of-interest information of the user who has subscribed to the application, and the store information may correspond to information, such as events, discounts, and benefits corresponding to an offline store visited by the user.

Thereafter, an expected payment amount is obtained and analyzed in consideration of at least one of the purchasing pattern of the user, information about the amount of the purchase by a single user at the store, and information about the amount of each purchase by a user group identical to the user in an affiliated store group, based on the user information and the store information at step S1230, and the expected payment amount is predicted based on the results of the analysis at step S1240.

In an embodiment, when the purchasing pattern of the user, which was considered when the expected purchase commodity was predicted, is used, information about the prices of commodities to be purchased by the user may be acquired, and thus the expected payment amount may be predicted in consideration of the purchasing pattern of the user.

In another embodiment, an expected payment amount may be predicted using information about the average purchase amount by a single user at the store visited by the user.

In a further embodiment, whether the store visited by the user is a jewelry shop which sells relatively expensive goods, or a grocery shop which sells relatively cheap goods, is determined, and information about the amount of each purchase in the corresponding affiliated store group may be considered. Further, whether a user is a student, a housewife, or an office worker is determined, and thus information about the amount of each purchase by a user group identical to the user may be considered. That is, in the cases where the user is a student and where the user is an office worker, there may be a great difference in consumption tendencies, and thus an expected payment amount may be predicted in consideration of the purchase amount information based on the user group.

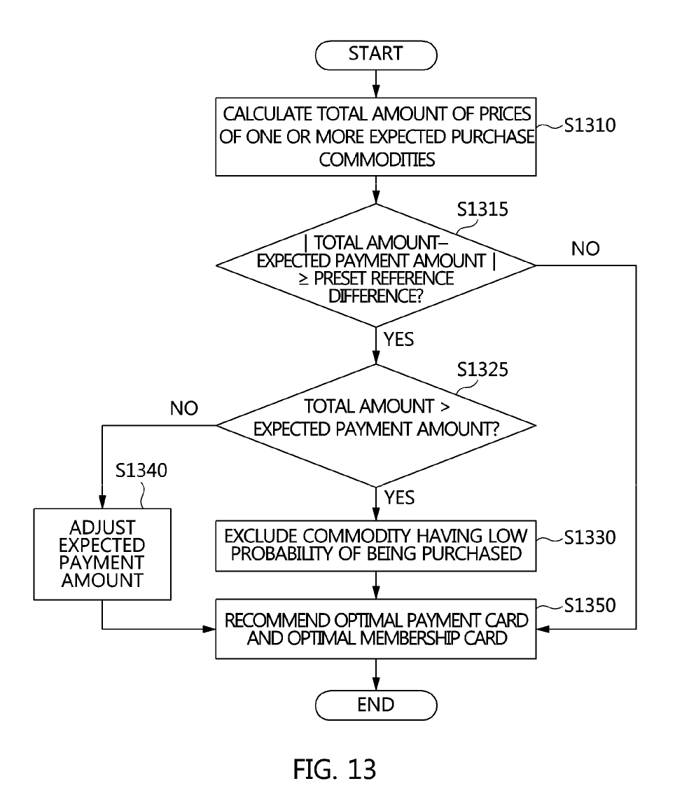

FIG. 13 is diagram showing in detail a procedure for matching expected purchase commodities with an expected payment amount in the purchase prediction-based optimal card recommendation method according to an embodiment of the present invention.

Referring to FIG. 13, in the procedure for matching expected purchase commodities with an expected payment amount in the purchase prediction-based optimal card recommendation method according to an embodiment of the present invention, the prices of one or more expected purchase commodities are summed, and thus the total amount is calculated at step S1310.

Thereafter, whether the difference between the total amount and the expected payment amount is equal to or greater than a preset reference difference is determined at step S1315.

If it is determined at step S1315 that the difference is less than the preset reference difference, an optimal payment card and an optimal membership card are recommended, among multiple cards registered in the application for payment, in consideration of at least one of the expected payment amount and the one or more expected purchase commodities at step S1350.

In contrast, if it is determined at step S1315 that the difference is equal to or greater than the preset reference difference, it is determined whether the total amount is greater than the expected payment amount at step S1325.

If it is determined at step S1325 that the total amount is greater than the expected payment amount, a commodity having a low probability of being purchased is first excluded from the one or more expected purchase commodities, and thus the total amount is adjusted so that the total amount matches the expected payment amount at step S1330.

Thereafter, an optimal payment card and an optimal membership card are recommended, among the multiple cards registered in the application for payment, in consideration of at least one of the expected payment amount and the one or more expected purchase commodities, which have been adjusted such that a commodity having a low probability of being purchased is excluded, at step S1350.

Further, if it is determined at step S1325 that when the total amount is not greater than the expected payment amount, the expected payment amount is adjusted so that it matches the total amount at step S1340.

Thereafter, an optimal payment card and an optimal membership card are recommended, among the multiple cards registered in the application for payment, in consideration of at least one of the expected payment amount, which has been adjusted to match the total amount, and the one or more expected purchase commodities at step S1350.

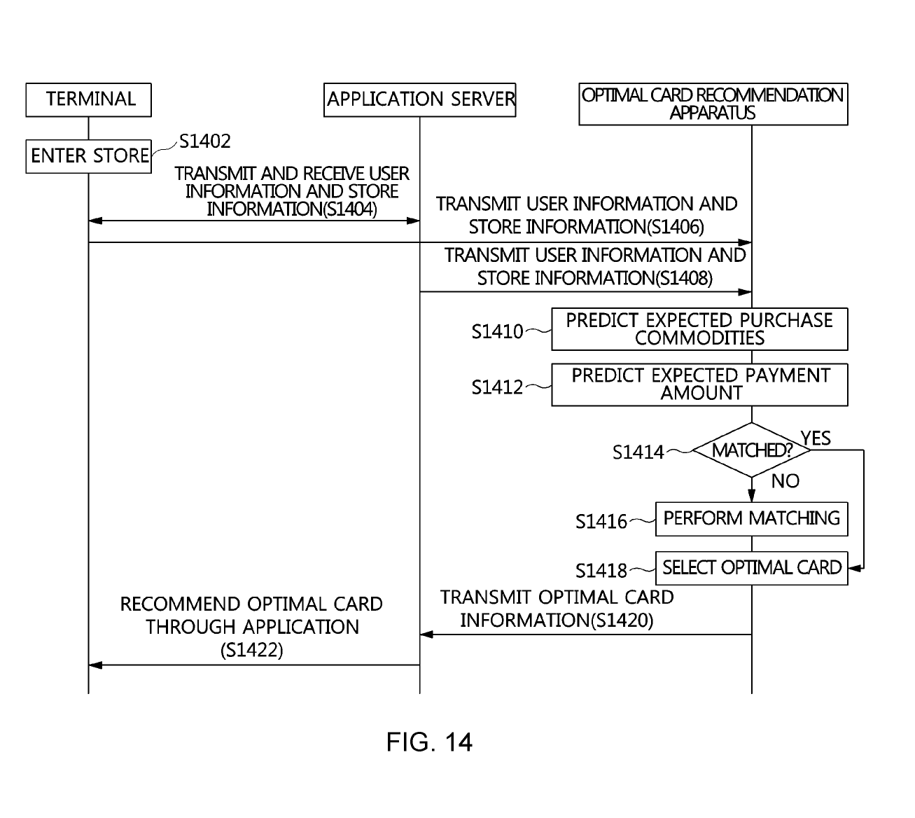

FIG. 14 is a diagram showing a purchase prediction-based optimal card recommendation process according to an embodiment of the present invention.

Referring to FIG. 14, in the purchase prediction-based optimal card recommendation process according to the embodiment of the present invention, the user enters an offline store while holding his or her terminal at step S1402.

Next, an application server checks the terminal of the user based on information received through at least one BLE device, that is, at least one beacon, installed at the store, and transmits and receives user information and store information to and from the terminal of the user at step S1404.

Thereafter, the user information and the store information are transmitted to the optimal card recommendation apparatus through the terminal or the application server at steps S1406 and S1408.

Here, the user information may be private user information related to the personal information, purchase history information, and commodity-of-interest information of the user who has subscribed to the application, and the store information may correspond to information, such as events, discounts and benefits corresponding to an offline store visited by the user.

Thereafter, the optimal card recommendation apparatus obtains at least one of the purchasing pattern of the user in an affiliated store group corresponding to the store, the purchasing pattern of a user group identical to the user in the affiliated store group, benefit information provided by each store, and the utilization of benefits by the user, based on the user information and the store information, and then predicts one or more expected purchase commodities at step S1410.

Next, the optimal card recommendation apparatus obtains information about an expected payment amount in consideration of at least one of the purchasing pattern of the user, information about the amount of the purchase by a single user at the store, and information about the amount of each purchase by the identical user group in the affiliated store group, based on the user information and the store information, and then predicts the expected payment amount at step S1412.

Thereafter, it is determined whether to match the one or more expected purchase commodities with the expected payment amount at step S1414.

Here, the prices of the one or more expected purchase commodities are summed, and thus the total amount is calculated. Whether the difference between the total amount and the expected payment amount is equal to or greater than a preset reference difference is determined. If it is determined that the difference is equal to or greater than the preset reference difference, matching may be performed.

If it is determined to perform matching at step S1414, when the total amount is greater than the expected payment amount, matching is performed by excluding a commodity having a low probability of being purchased from the one or more expected purchase commodities, whereas when the total amount is less than the expected payment amount, matching is performed by adjusting the expected payment amount at step S1416.

Thereafter, the optimal card to be used for payment is selected from among the cards of the user registered in the application, based on the one or more expected purchase commodities and the expected payment amount which have been matched, at step S1418.

Further, if it is determined at step S1414 that matching is not to be performed, an optimal card is selected based on the one or more expected purchase commodities and the expected payment amount at step S1418.

Thereafter, information about the selected optimal card is delivered to the application server at step S1420, and the application server displays the optimal card information to the user through the application, thus enabling the optimal card to be recommended at step S1422.

FIG. 15 is a block diagram showing an optimal card recommendation apparatus according to another embodiment of the present invention.

Referring to FIG. 15, an optimal card recommendation apparatus 1500 according to the other embodiment of the present invention includes a communication unit 1510, a purchase commodity prediction unit 1520, an expected amount prediction unit 1530, a matching determination unit 1540, a commodity amount matching unit 1550, a card recommendation unit 1560, a card change unit 1570, and a storage unit 1580.

The communication unit 1510 functions to transmit and receive information required to recommend an optimal card to and from the terminal of the user over a communication network, such as a typical network. In particular, the communication unit 1510 according to an embodiment may receive pieces of information required to predict one or more expected purchase commodities and an expected payment amount from the terminal, and may provide information corresponding to the optimal card to the terminal.

Here, information required to predict the one or more expected purchase commodities and the expected payment amount may be received from a separate application server. For example, user information, such as the purchase information, personal information, possessed payment card information, and possessed membership card information of the user, and various types of information, pertaining for example to events, discounts, and marketing information provided by the corresponding store, may be received.

The purchase commodity prediction unit 1520 predicts one or more commodities that are expected to be purchased by the user at the store. That is, conventional card recommendation technology is configured to recommend an optimal payment card and an optimal membership card in consideration of information about the type and price of the corresponding commodity to be purchased by the user in the state in which the commodity to be purchased by the user has been fixed. Thus, the conventional card recommendation technology merely enables a card to be recommended only when the user enters information about the commodity to be purchased through the application, or only when commodity information is provided through the POS device at the store. However, such card recommendation technology cannot provide a particular advantage except for convenience in that information about the card to be used for payment is provided when the user purchases a commodity through the POS device.

In contrast, the present invention predicts in advance commodities expected to be purchased by the user and recommends a card in the state in which the commodity to be purchased by the user at the store is not yet fixed, thus providing assistance in further simplifying and facilitating the procedure in which the user actually performs payment through the POS device.

Here, one or more commodities expected to be purchased may be predicted in consideration of at least one of the purchasing pattern of the user in an affiliated store group corresponding to the store, the purchasing pattern of a user group identical to the user in the affiliated store group, benefit information provided by each store, and the utilization of benefits by the user.

In an embodiment, the purchasing patterns of the user for respective affiliated store groups may be generated using information, such as the types of commodities purchased by the user in each affiliated store group, which sells household items, the time of the purchase, or the price range of purchased commodities.

In another embodiment, based on the age, gender, occupation, and preference information of the user, a user group may be generated based on other users corresponding to information similar to the above information, and the purchasing pattern of the corresponding user group may be generated and may be used to predict commodities that are expected to be purchased.

In a further embodiment, information about the store visited by the user may be obtained, and benefit information currently provided by the store, that is, information about discounted commodities, commodities corresponding to a Buy-One-Get-One-Free (BOGOF) offer, or commodities available for a limited time, may be obtained and used to predict the commodities that are expected to be purchased.

In yet another embodiment, commodities expected to be purchased may be predicted in consideration of how the user has utilized benefits obtained from the purchase of commodities. That is, benefit information preferred by the user between discounts and accumulation may be considered, or a usage pattern for accumulated points may be considered when the commodities expected to be purchased are predicted.

Here, unnecessary commodity items may be detected in consideration of at least one of information about the commodity most recently purchased by the user in the affiliated store group and the time of the purchase, and may be excluded when one or more commodities expected to be purchased are predicted.

For example, when there is a commodity purchased by the user in an affiliated store group identical to a specific store before the user visits the specific store, there is a low probability that the user will purchase the corresponding commodity at the current store. Therefore, when the commodity expected to be purchased at the current store is predicted, the commodity previously purchased in the same affiliated store group may be recognized as an unnecessary commodity item, and may be excluded from the commodities expected to be purchased.

In still another embodiment, when there is a commodity purchased by the user in an affiliated store group identical to a specific store before the user visits the specific store, the commodity may instead be predicted to be the commodity expected to be purchased in consideration of the time at which the corresponding commodity was purchased and whether the commodity is discounted or not. That is, assuming that hair gel is on sale at a discount price at a hair product shop visited by the user, and the user purchased the hair gel one month ago, there may be a high probability that the user will purchase the hair gel owing to the benefits of the discount price at this visit.

The expected amount prediction unit 1530 predicts the amount of the payment that is expected to be made by the user at the store.

Here, the reason for additionally predicting an expected payment amount as well as an expected purchase commodity so as to recommend an optimal card is that there may be benefits that are provided when a predetermined amount or more is paid at each store. Therefore, the amount required to purchase a commodity, that is, the payment amount, may be a very important factor in recommending a card. For example, assuming that a discount benefit is provided when commodities corresponding to more than 100,000 Won are purchased with a specific payment card at a store visited by the user, a payment amount for purchase commodities, which are expected to be purchased by the user at the corresponding store, is predicted to reach an amount of 100,000 Won, thus allowing the user to obtain more benefits.

Here, the expected payment amount may be predicted in consideration of at least one of the purchasing pattern of the user, information about the amount of the purchase by a single user at the store, and information about the amount of each purchase by a user group identical to the user in an affiliated store group.

In an embodiment, when the purchasing pattern of the user, which was considered when the expected purchase commodity was predicted, is used, information about the prices of commodities to be purchased by the user may be acquired, and thus the expected payment amount may be predicted in consideration of the purchasing pattern of the user.

In another embodiment, an expected payment amount may be predicted using information about the average purchase amount by a single user at the store visited by the user.

In a further embodiment, whether the store visited by the user is a jewelry shop which sells relatively expensive goods, or a grocery shop which sells relatively cheap goods, is determined, and information about the amount of each purchase in the corresponding affiliated store group may be considered. Further, whether a user is a student, a housewife, or an office worker is determined, and thus information about the amount of each purchase by a user group identical to the user may be considered. That is, in the cases where the user is a student and where the user is an office worker, there may be a great difference in consumption tendencies, and thus an expected payment amount may be predicted in consideration of the purchase amount information based on the user group.

The matching determination unit 1540 compares the total amount of one or more expected purchase commodities with the expected payment amount, and then determines whether to match the one or more expected purchase commodities and the expected payment amount with each other. For example, assuming that the expected payment amount is predicted to be excessively high compared to the number of the one or more expected purchase commodities, there is the possibility that the reliability of the recommended card may be deteriorated because the tendencies of two conditions that are considered when recommending an optimal card are different from each other. Therefore, it is possible to compare the total amount obtained by summing the prices of one or more expected purchase commodities with the expected payment amount, and to determine to match the expected purchase commodities with the expected payment amount if it is determined that a difference is present between the total amount and the expected payment amount. Then, an algorithm for performing matching may be executed.

Further, if it is determined that the total amount is relatively similar to the expected payment amount when comparing the total amount with the expected payment amount, matching is not performed, and the expected payment amount may be used as a reference value that is considered when recommending an optimal card.

At this time, when the difference between the total amount and the expected payment amount is equal to or greater than a preset reference difference, it may be determined that matching is to be performed. For example, when the preset reference difference is 30,000 Won, matching may be performed when the difference between the total amount and the expected payment amount is 30,000 Won or more.

Here, the preset reference difference may be set to different values depending on affiliated store groups. For example, the reference difference in an affiliated store group that sells expensive commodities is set to a value larger than that of the reference difference in an affiliated store group that sells relatively inexpensive commodities, thus preventing unnecessary matching from being performed. Further, the reference difference in an affiliated store group that sells inexpensive commodities is set to a smaller value, thus improving the accuracy of the algorithm for recommending an optimal card.

The commodity amount matching unit 1550 is configured to, when performing matching between the one or more expected purchase commodities and the expected payment amount, adjust any one of the expected payment amount and the one or more expected purchase commodities, and then match the one or more expected purchase commodities with the expected payment amount. That is, in order to reduce the difference between the total amount of the one or more expected purchase commodities and the expected payment amount, any one of the total amount and the expected payment amount may be adjusted.

Here, when the total amount is greater than the expected payment amount, a commodity having a low probability of being purchased is first excluded from the one or more expected purchase commodities, and thus the total amount may be adjusted to match the expected payment amount. For example, it may be assumed that there are 10 expected purchase commodities, that the total amount is greater than the expected payment amount, and that the difference between the total amount and the expected payment amount is greater than a preset reference difference by 50,000 Won. In this case, it is determined that an unnecessary commodity is further included in the expected purchase commodities, the probabilities of being purchased are determined for 10 respective expected purchase commodities, and the commodity having the lowest probability of being purchased may be excluded first.

Further, when the total amount is less than the expected payment amount, the expected payment amount is adjusted to match the total amount, and thus the one or more expected purchase commodities may match the expected payment amount. For example, it may be assumed that there are five expected purchase commodities, that the total amount is less than the expected payment amount, and that the difference between the total amount and the expected payment amount is greater than a preset reference difference by 50,000 Won. In this case, it is preferable to recommend a card using a method for adjusting the expected payment amount to match the total amount, rather than using a method for adding a commodity having a low probability of being purchased to the expected purchase commodities for the additional purchase of the commodity. That is, since the probability that the user will purchase an unnecessary commodity is low, the accuracy of the algorithm for recommending a card may be improved by decreasing the expected payment amount.

The card recommendation unit 1560 recommends an optimal card, among multiple cards registered in the application for payment, in consideration of at least one of the expected payment amount and the one or more expected purchase commodities.

Here, the multiple cards may include payment cards such as a cash card, a debit card, and a credit card for payment. Further, the multiple cards may include a membership card, a cash-back card, and a discount card, which enable points to be accumulated or discounts to be provided when commodities are purchased.

Here, the application may include a mobile payment application, a mobile electronic wallet application, etc., which register the card information of the user and allow the terminal to perform payment using the card information.

In this case, among the one or more payment cards included in the multiple cards, the optimal payment card for providing the maximum benefits may be recommended. In an embodiment, depending on whether the payment card is a credit card, a cash card or a debit card, the discount rate or accumulation rate may differ, and thus the discount rates and accumulation rates of respective payment cards may be checked so as to recommend a card enabling the maximum benefits to be obtained.

In another embodiment, discount rates or accumulation rates for respective card companies and banks corresponding to credit cards or debit cards may differ. Thus, the discount rates and accumulation rates for respective card companies and banks may be checked so as to recommend an optimal card.

In a further embodiment, since the benefits of respective credit cards or debit cards may be provided differently depending on the card usage record in the previous month, an optimal card may be recommended by additionally considering whether the card usage record in a previous month has been achieved.

In yet another embodiment, when multiple optimal cards having similar discount rates and accumulation rates are selected, an optimal card may be recommended such that the card usage record in the current month is checked and a card, the usage record of which can be achieved, is considered so as to be provided with benefits in the next month.

In still another embodiment, in the case of a payment card having a designated payment due date, such as a credit card, an optimal card may be recommended by applying an algorithm in which payment timing is considered based on the payment due date. In other words, when the card usage record of card A, the payment due date of which is approaching, is not yet achieved, the recommendation priority of card A is designated to be high, and card A may then be recommended until the payment due date of card A is reached.

Further, among one or more membership cards included in multiple cards, an optimal membership card may be recommended in consideration of at least one of an accumulation rate and a discount rate. For example, when an optimal payment card is recommended, a membership card, which can be used together with the recommended payment card and can be used at the corresponding store, is recommended together with the payment card, thus allowing the user to be sufficiently provided with the benefits of discounts and accumulation without missing the benefits.

Furthermore, when it is possible to purchase a commodity using points accumulated in a membership card, the corresponding membership card may be included in a card recommendation list for payment and may also be recommended. In addition, when payment using points is possible according to the setting of the user, the recommendation priority of the corresponding membership card is designated to be higher than that of a credit card or a debit card, and then the membership card may be primarily recommended.

Here, information about an optimal payment card and an optimal membership card may be provided together through the application. For example, information about the optimal membership card that matches information about the optimal payment card may be displayed together on a single screen of the application. Alternatively, when the optimal payment card is clicked, optimal membership cards that can be used together with the clicked optimal payment card may be provided in the form of a list in descending order of benefit amount.

The card change unit 1570 determines whether to change the optimal card in consideration of at least one card change condition, and then changes the optimal card in consideration of at least one of an actual purchase commodity and an actual payment amount when it is determined to change the optimal card. For example, it may be assumed that, when user A enters store B, one or more expected purchase commodities and an expected payment amount are predicted, and then credit card C is recommended as an optimal card. At this time, an actual purchase commodity chosen to be actually purchased by user A, and an actual payment amount based on the actual purchase commodity are checked. If the difference between the sum of the prices of the expected purchase commodities and the expected payment amount is large, the optimal card is determined to be changed in consideration of the actual purchase commodity and the actual payment amount, and then the recommended optimal card may be changed.

In this case, the card to be recommended may be selected from among the remaining cards registered in the application, rather than the optimal card recommended before being changed, and then the previously recommended card may be replaced with the selected card. Further, as the optimal payment card is changed, the optimal membership card may also be changed and recommended.

At this time, when the difference, obtained by comparing an expected discount amount based on at least one of the actual purchase commodity and the actual payment amount with an actual discount amount corresponding to the optimal card, is equal to or greater than a preset change reference amount, the optimal card satisfies the at least one card change condition, and may then be changed.

For example, it may be assumed that an expected discount amount, which is predicted when the card chosen in consideration of the actual purchase commodity and the actual payment amount is used, rather than the recommended card, is 1,000 Won, and that the actual discount amount obtained when the optimal card is used is 300 Won. In this case, if the preset change reference amount is 500 Won, the card chosen in consideration of the actual purchase commodity and the actual payment amount may be changed to the optimal card so that the user gets a 1,000-Won discount, corresponding to the expected discount amount.

In this case, when the determination as to whether to apply a conditional discount based on a total payment amount is changed, it is determined that at least one card change condition is satisfied, and thus the optimal card may be changed.

For example, it may be assumed that the expected payment amount of the user is predicted to be 110,000 Won, and that card A, which provides a 30% discount when a purchase amount is 100,000 Won or more, is recommended as an optimal card. In this case, when the actual payment amount is 90,000 Won, whereby the payment conditions are changed such that the application of the conditional discount based on the total payment amount corresponding to card A, that is, a 30% discount, is impossible, it may be determined that the optimal card is to be changed from card A to another card. In contrast, even in the case where an expected payment amount is predicted to be 90,000 Won, and then card A is not recommended as an optimal card, but the actual payment amount is 110,000 Won, the determination as to whether to apply a conditional discount based on the total payment amount has changed in a similar way, and thus it may be determined that the optimal card is to be changed.

As described above, the storage unit 1580 stores various types of information generated during a procedure for providing the optimal card recommendation service according to an embodiment of the present invention.

In an embodiment, the storage unit 1580 may be implemented independently of the optimal card recommendation apparatus 1500 and may then support a function for the optimal card recommendation service. Here, the storage unit 1580 may function as separate large-capacity storage and may include a control function for performing operations.

Meanwhile, the optimal card recommendation apparatus 1500 is equipped with memory and may store information in the apparatus. In an exemplary embodiment, the memory is a computer-readable medium. In an exemplary embodiment, the memory may be a volatile memory unit, and in another exemplary embodiment, the memory may be a nonvolatile memory unit. In an embodiment, the storage may be a computer-readable medium. In various different embodiments, the storage may include, for example, a hard disk device, an optical disk device or other types of large-capacity storage device.

Such an optimal card recommendation apparatus 1500 is used, and thus the user may use an automatic payment service with a previously recommended payment card when paying for a commodity at a store using his or her mobile terminal.

Further, a payment card and a membership card which allow the user to obtain the maximum benefits, such as discounts or accumulation, are recommended depending on the commodity expected to be purchased by the user and the expected payment amount, thus inducing the user to consume appropriately and helping the user make a reasonable purchase.

Furthermore, an operation required by the user to pay at a store using a mobile terminal may be minimized, and thus there is an advantage in that the user's convenience may be maximized when commodities are purchased.

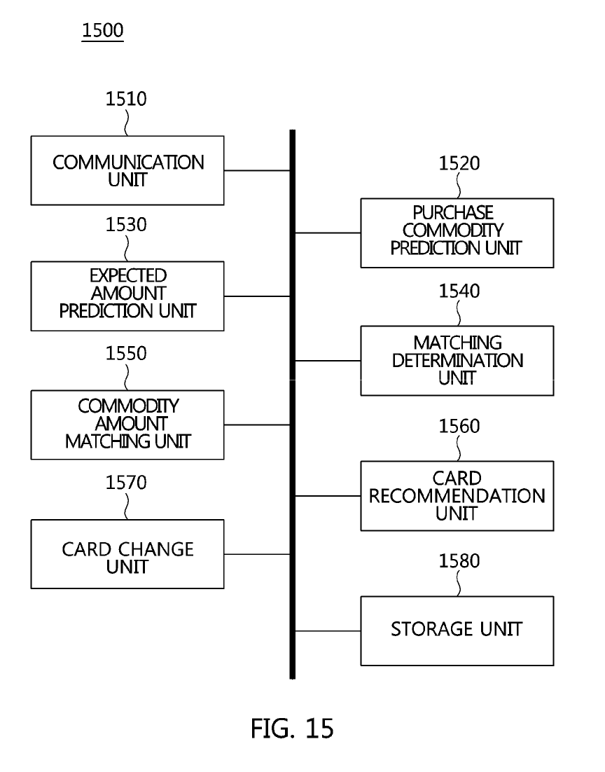

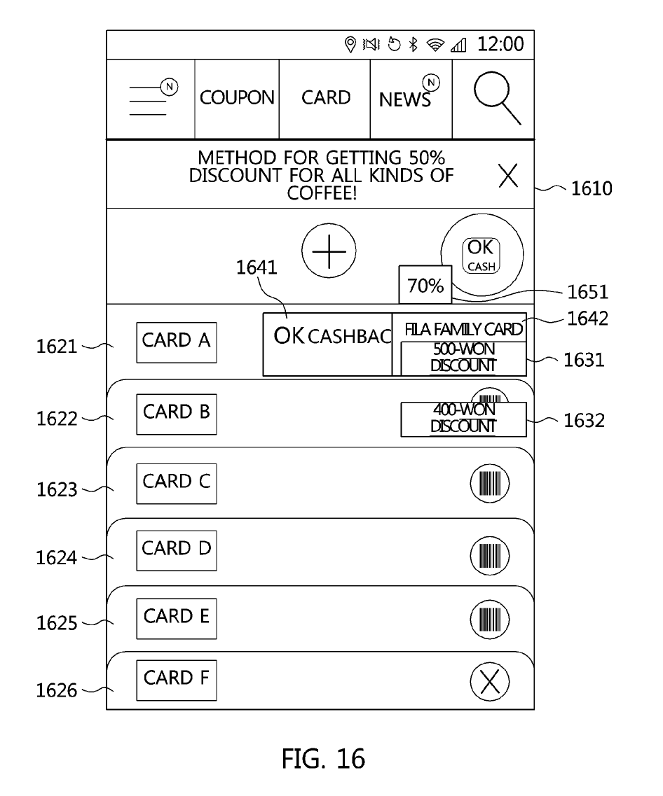

FIG. 16 is a diagram showing a screen required to recommend an optimal card in an application according to an embodiment of the present invention.

Referring to FIG. 16, on a card recommendation screen 1610, which is required to recommend an optimal card in an application according to an embodiment of the present invention, at least one of pieces of discount amount information 1631 and 1632, membership cards 1641 and 1642, and usage record achievement rates 1651 for respective cards, together with respective recommended cards 1621 to 1626, may be displayed.

Here, the card recommendation screen 1610 may display the recommended cards 1621 to 1626, which are recommended through an optimal card recommendation algorithm, in descending order of benefit amount. For example, as shown in FIG. 16, the recommended card 1621 determined to have the maximum benefits is displayed at an uppermost portion, and recommended cards 1622 to 1626, determined to sequentially have the next largest benefits, may be sequentially displayed below the recommended card 1621.

Further, if commodity prices are discounted when commodities are purchased with the recommended cards 1622 to 1626, the card recommendation screen 1610 may display the pieces of discount amount information 1631 and 1632 such that they overlap the respective recommended cards 1622 to 1626. For example, when the recommended card 1621 is used for payment, a 500-Won discount may be provided depending on the discount amount information 1631.

Furthermore, the card recommendation screen 1610 may display information about membership cards 1641 and 1642, which can be used together with the recommended cards 1622 to 1626.

Furthermore, the card recommendation screen 1610 displays a usage record achievement rate 1651 in the current month for each of the recommended cards 1622 to 1626, thus enabling usage record achievement information, which is required in order to obtain benefits through the corresponding card in the next month, to be easily checked. For example, in the case of credit cards, the range of application of benefits in the current month may differ greatly depending on whether the usage record in the previous month has been achieved. Therefore, the usage record achievement rate 1651 may also be managed to obtain benefits in the next month while the recommended cards 1622 to 1626 are recommended.

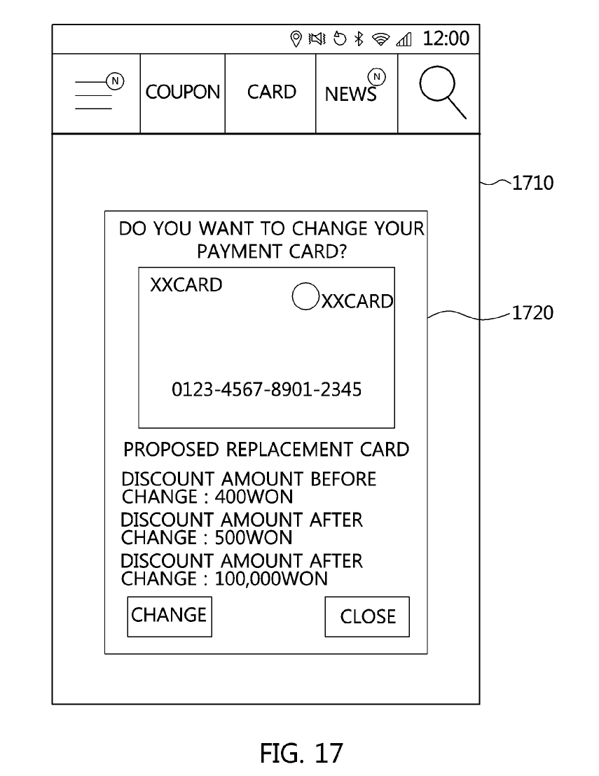

FIG. 17 is a diagram showing a screen required to change a recommended card according to an embodiment of the present invention.

Referring to FIG. 17, on a recommended card change screen 1710 according to an embodiment of the present invention, a card change popup window 1720 may be displayed through an application installed on the terminal of the user.

Here, in the card change popup window 1720, the card that is capable of providing the most benefits when both an actual purchase commodity and an actual purchase amount are considered may be shown as a proposed replacement card.

Further, in the card change popup window 1720, a discount amount, obtained when an actual purchase commodity is paid for using an optimal card before being replaced with the proposed replacement card, that is, using the recommended card, and a discount amount, obtained when the actual purchase commodity is paid for using the proposed replacement card, may be indicated. Here, in the card change popup window 1720, benefit information, such as a discount rate or accumulation rate, in addition to the discount amount, may also be indicated.

Furthermore, in the change popup window 1720, the usage record of the proposed replacement card is indicated, thus allowing the user to consider usage record information when determining to change the optimal card. For example, if it is determined that the recommended card has a high usage record achievement rate, whereby the target usage record in the current month can be achieved if only the corresponding payment is made, and that the proposed replacement card has a low usage record achievement rate, making it difficult to achieve the target usage record in the current month, the user may use the previously recommended optimal card without changing the optimal card even if the discount amount or discount rate for the proposed replacement card is high.

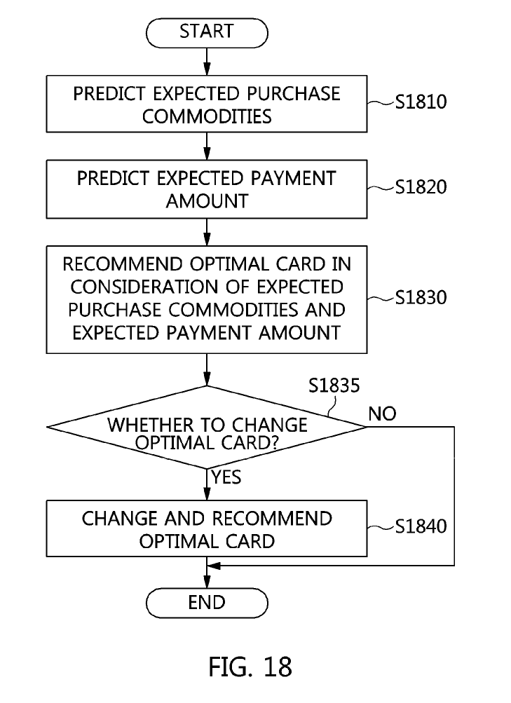

FIG. 18 is an operation flowchart showing an optimal card recommendation method based on the change of a recommended card according to an embodiment of the present invention.

Referring to FIG. 18, the optimal card recommendation method based on the change of a recommended card according to the embodiment of the present invention is an optimal card recommendation method performed by the optimal card recommendation apparatus based on the change of a recommended card. First, the optimal card recommendation method predicts one or more purchase commodities that are expected to be purchased by the user at a store at step S1810. That is, conventional card recommendation technology is configured to recommend an optimal payment card and an optimal membership card in consideration of information about the type and price of the corresponding commodity to be purchased by the user in the state in which the commodity to be purchased by the user has been fixed. Thus, the conventional card recommendation technology merely enables a card to be recommended only when the user enters information about the commodity to be purchased through the application, or only when commodity information is provided through the POS device at the store. However, such card recommendation technology cannot provide a particular advantage except for convenience in that information about the card to be used for payment is provided when the user purchases a commodity through the POS device.

In contrast, the present invention predicts in advance commodities expected to be purchased by the user and recommends a card in the state in which the commodity to be purchased by the user at the store is not yet fixed, thus providing assistance in further simplifying and facilitating the procedure in which the user actually performs payment through the POS device.

Here, one or more commodities expected to be purchased may be predicted in consideration of at least one of the purchasing pattern of the user in an affiliated store group corresponding to the store, the purchasing pattern of a user group identical to the user in the affiliated store group, benefit information provided by each store, and the utilization of benefits by the user.

In an embodiment, the purchasing patterns of the user for respective affiliated store groups may be generated using information, such as the types of commodities purchased by the user in each affiliated store group, which sells household items, the time of the purchase, or the price range of purchased commodities.

In another embodiment, based on the age, gender, occupation, and preference information of the user, a user group may be generated based on other users corresponding to information similar to the above information, and the purchasing pattern of the corresponding user group may be generated and may be used to predict commodities that are expected to be purchased.

In a further embodiment, information about the store visited by the user may be obtained, and benefit information currently provided by the store, that is, information about discounted commodities, commodities corresponding to a Buy-One-Get-One-Free (BOGOF) offer, or commodities available for a limited time, may be obtained and used to predict the commodities that are expected to be purchased.

In yet another embodiment, commodities expected to be purchased may be predicted in consideration of how the user has utilized benefits obtained from the purchase of commodities. That is, benefit information preferred by the user between discounts and accumulation may be considered, or a usage pattern for accumulated points may be considered when the commodities expected to be purchased are predicted.

Here, unnecessary commodity items may be detected in consideration of at least one of information about the commodity most recently purchased by the user in the affiliated store group and the time of the purchase, and may be excluded when one or more commodities expected to be purchased are predicted.

For example, when there is a commodity purchased by the user in an affiliated store group identical to a specific store before the user visits the specific store, there is a low probability that the user will purchase the corresponding commodity at the current store. Therefore, when the commodity expected to be purchased at the current store is predicted, the commodity previously purchased in the same affiliated store group may be recognized as an unnecessary commodity item, and may be excluded from the commodities expected to be purchased.

In still another embodiment, when there is a commodity purchased by the user in an affiliated store group identical to a specific store before the user visits the specific store, the commodity may instead be predicted to be the commodity expected to be purchased in consideration of the time at which the corresponding commodity was purchased and whether the commodity is discounted or not. That is, assuming that hair gel is on sale at a discount price at a hair product shop visited by the user, and the user purchased the hair gel one month ago, there may be a high probability that the user will purchase the hair gel owing to the benefits of the discount price at this visit.

Further, the optimal card recommendation method based on the change of a recommended card according to the embodiment of the present invention predicts the amount of the payment that is expected to be made by the user at the store at step S1820.

Here, the reason for additionally predicting an expected payment amount as well as an expected purchase commodity so as to recommend an optimal card is that there may be benefits that are provided when a predetermined amount or more is paid at each store. Therefore, the amount required to purchase a commodity, that is, the payment amount, may be a very important factor in recommending a card. For example, assuming that a discount benefit is provided when commodities corresponding to more than 100,000 Won are purchased with a specific payment card at a store visited by the user, a payment amount for purchase commodities, which are expected to be purchased by the user at the corresponding store, is predicted to reach an amount of 100,000 Won, thus allowing the user to obtain more benefits.

Here, the expected payment amount may be predicted in consideration of at least one of the purchasing pattern of the user, information about the amount of the purchase by a single user at the store, and information about the amount of each purchase by a user group identical to the user in an affiliated store group.

In an embodiment, when the purchasing pattern of the user, which was considered when the expected purchase commodity was predicted, is used, information about the prices of commodities to be purchased by the user may be acquired, and thus the expected payment amount may be predicted in consideration of the purchasing pattern of the user.

In another embodiment, an expected payment amount may be predicted using information about the average purchase amount by a single user at the store visited by the user.

In a further embodiment, whether the store visited by the user is a jewelry shop which sells relatively expensive goods, or a grocery shop which sells relatively cheap goods, is determined, and information about the amount of each purchase in the corresponding affiliated store group may be considered. Further, whether a user is a student, a housewife, or an office worker is determined, and thus information about the amount of each purchase by a user group identical to the user may be considered. That is, in the cases where the user is a student and where the user is an office worker, there may be a great difference in consumption tendencies, and thus an expected payment amount may be predicted in consideration of the purchase amount information based on the user group.

Although not shown in FIG. 18, the optimal card recommendation method based on the change of a recommended card according to the embodiment of the present invention determines whether to match the one or more expected purchase commodities with the expected payment amount by comparing the total amount of one or more expected purchase commodities with the expected payment amount. For example, assuming that the expected payment amount is predicted to be excessively high compared to the number of the one or more expected purchase commodities, there is the possibility that the reliability of the recommended card may be deteriorated because the tendencies of two conditions that are considered when recommending an optimal card are different from each other. Therefore, it is possible to compare the total amount obtained by summing the prices of one or more expected purchase commodities with the expected payment amount, and to determine to match the expected purchase commodities with the expected payment amount if it is determined that a difference is present between the total amount and the expected payment amount. Then, an algorithm for performing matching may be executed

Further, if it is determined that the total amount is relatively similar to the expected payment amount when comparing the total amount with the expected payment amount, matching is not performed, and the expected payment amount may be used as a reference value that is considered when recommending an optimal card.

At this time, when the difference between the total amount and the expected payment amount is equal to or greater than a preset reference difference, it may be determined that matching is to be performed. For example, when the preset reference difference is 30,000 Won, matching may be performed when the difference between the total amount and the expected payment amount is 30,000 Won or more.

Here, the preset reference difference may be set to different values depending on affiliated store groups. For example, the reference difference in an affiliated store group that sells expensive commodities is set to a value larger than that of the reference difference in an affiliated store group that sells relatively inexpensive commodities, thus preventing unnecessary matching from being performed. Further, the reference difference in an affiliated store group that sells inexpensive commodities is set to a smaller value, thus improving the accuracy of the algorithm for recommending an optimal card.

Although not shown in FIG. 18, the optimal card recommendation method based on the change of a recommended card according to the embodiment of the present invention matches the one or more expected purchase commodities with the expected payment amount by adjusting any one of the expected payment amount and the one or more expected purchase commodities if it is determined to match the one or more expected purchase commodities with the expected payment amount. That is, any one of the total amount of the one or more expected purchase commodities and the expected payment amount may be adjusted so as to reduce the difference between the total amount and the expected payment amount.

Here, when the total amount is greater than the expected payment amount, a commodity having a low probability of being purchased is first excluded from the one or more expected purchase commodities, and thus the total amount may be adjusted to match the expected payment amount. For example, it may be assumed that there are 10 expected purchase commodities, that the total amount is greater than the expected payment amount, and that the difference between the total amount and the expected payment amount is greater than a preset reference difference by 50,000 Won. In this case, it is determined that an unnecessary commodity is further included in the expected purchase commodities, the probabilities of being purchased are determined for 10 respective expected purchase commodities, and the commodity having the lowest probability of being purchased may be excluded first.

Further, when the total amount is less than the expected payment amount, the expected payment amount is adjusted to match the total amount, and thus the one or more expected purchase commodities may match the expected payment amount. For example, it may be assumed that there are five expected purchase commodities, that the total amount is less than the expected payment amount, and that the difference between the total amount and the expected payment amount is greater than a preset reference difference by 50,000 Won. In this case, it is preferable to recommend a card using a method for adjusting the expected payment amount to match the total amount, rather than using a method for adding a commodity having a low probability of being purchased to the expected purchase commodities for the additional purchase of the commodity. That is, since the probability that the user will purchase an unnecessary commodity is low, the accuracy of the algorithm for recommending a card may be improved by decreasing the expected payment amount.

Further, the optimal card recommendation method based on the change of a recommended card according to the embodiment of the present invention recommends an optimal card, among multiple cards registered in the application for payment, in consideration of at least one of the expected payment amount and the one or more expected purchase commodities at step S1830.

Here, the multiple cards may include payment cards such as a cash card, a debit card, and a credit card for payment. Further, the multiple cards may include a membership card, a cash-back card, and a discount card, which enable points to be accumulated or discounts to be provided when commodities are purchased.

Here, the application may include a mobile payment application, a mobile electronic wallet application, etc., which register the card information of the user and allow the terminal to perform payment using the card information.

In this case, among the one or more payment cards included in the multiple cards, the optimal payment card for providing the maximum benefits may be recommended. For example, depending on whether the payment card is a credit card, a cash card or a debit card, the discount rate or accumulation rate may differ, and thus the discount rates and accumulation rates of respective payment cards may be checked so as to recommend a card enabling the maximum benefits to be obtained.

In another embodiment, the discount or accumulation rates of respective card companies and banks corresponding to credit cards or debit cards may differ, and thus the discount rate and accumulation rates of respective card companies and banks may be checked so as to recommend an optimal card.

In a further embodiment, the benefits of respective credit cards or debit cards may be provided differently depending on the card usage record in the previous month. Thus, an optimal card may be recommended by additionally considering whether the card usage record in the previous month has been achieved.

In yet another embodiment, when multiple optimal cards having similar discount rates and accumulation rates are selected, an optimal card may be recommended such that the card usage record in the current month is checked and a card, the usage record of which can be achieved, is considered so as to be provided with benefits in the next month.

In still another embodiment, in the case of a payment card having a designated payment due date, such as a credit card, an optimal card may be recommended by applying an algorithm in which payment timing is considered based on the payment due date. In other words, when the card usage record of card A, the payment due date of which is approaching, is not yet achieved, the recommendation priority of card A is designated to be high, and card A may then be recommended until the payment due date of card A is reached.

Further, among one or more membership cards included in multiple cards, an optimal membership card may be recommended in consideration of at least one of an accumulation rate and a discount rate. For example, when an optimal payment card is recommended, a membership card, which can be used together with the recommended payment card and can be used at the corresponding store, is recommended together with the payment card, thus allowing the user to be sufficiently provided with the benefits of discounts and accumulation without missing the benefits.

Furthermore, when it is possible to purchase a commodity using points accumulated in a membership card, the corresponding membership card may be included in a card recommendation list for payment and may also be recommended. In addition, when payment using points is possible according to the setting of the user, the recommendation priority of the corresponding membership card is designated to be higher than that of a credit card or a debit card, and then the membership card may be primarily recommended.

Here, information about the optimal payment card and the optimal membership card may be provided together through the application. For example, information about the optimal membership card that matches information about the optimal payment card may be displayed and shown together on a single screen of the application. Alternatively, when the optimal payment card is clicked, optimal membership cards that can be used together with the clicked optimal payment card may be provided in the form of a list in descending order of benefit amount.

Further, the optimal card recommendation method based on the change of a recommended card according to the embodiment of the present invention determines whether to change an optimal card in consideration of at least one card change condition at step S1835. For example, it may be assumed that, when user A enters store B, one or more expected purchase commodities and an expected payment amount are predicted, and then credit card C is recommended as an optimal card. At this time, an actual purchase commodity chosen to be actually purchased by user A, and an actual payment amount based on the actual purchase commodity are checked. If the difference between the sum of the prices of the expected purchase commodities and the expected payment amount is large, the optimal card is determined to be changed in consideration of the actual purchase commodity and the actual payment amount, and then the recommended optimal card may be changed.

If it is determined at step S1835 that the optimal card is to be changed, the optimal card is changed in consideration of at least one of the actual purchase commodity and the actual payment amount at step S1840.

In this case, the card to be recommended may be selected from among the remaining cards registered in the application, rather than the optimal card recommended before being changed, and then the previously recommended card may be replaced with the selected card. Further, as the optimal payment card is changed, the optimal membership card may also be changed and recommended.

At this time, when the difference, obtained by comparing an expected discount amount based on at least one of the actual purchase commodity and the actual payment amount with an actual discount amount corresponding to the optimal card, is equal to or greater than a preset change reference amount, the optimal card satisfies the at least one card change condition, and may then be changed.

For example, it may be assumed that an expected discount amount, which is predicted when the card chosen in consideration of the actual purchase commodity and the actual payment amount is used, rather than the recommended card, is 1,000 Won, and that the actual discount amount obtained when the optimal card is used is 300 Won. In this case, if the preset change reference amount is 500 Won, the card chosen in consideration of the actual purchase commodity and the actual payment amount may be changed to the optimal card so that the user gets a 1,000-Won discount, corresponding to the expected discount amount.

In this case, when the determination as to whether to apply a conditional discount based on a total payment amount is changed, it is determined that at least one card change condition is satisfied, and thus the optimal card may be changed.

For example, it may be assumed that the expected payment amount of the user is predicted to be 110,000 Won, and that card A, which provides a 30% discount when a purchase amount is 100,000 Won or more, is recommended as an optimal card. In this case, when the actual payment amount is 90,000 Won, whereby the payment conditions are changed such that the application of the conditional discount based on the total payment amount corresponding to card A, that is, a 30% discount, is impossible, it may be determined that the optimal card is to be changed from card A to another card. In contrast, even in the case where an expected payment amount is predicted to be 90,000 Won, and then card A is not recommended as an optimal card, but the actual payment amount is 110,000 Won, the determination as to whether to apply a conditional discount based on the total payment amount has changed in a similar way, and thus it may be determined that the optimal card is to be changed.

Further, if it is determined at step S1835 that the optimal card is not to be changed, the recommended optimal card may be recommended through the application without being changed.

Although not shown in FIG. 18, in the optimal card recommendation method based on the change of a recommended card according to the embodiment of the present invention, the optimal card recommendation apparatus transmits and receives information, required to recommend an optimal card, to and from the terminal of the user over a communication network, such as a typical network, using a separate communication module. In particular, the communication module according to the embodiment of the present invention may receive information required to predict the one or more expected purchase commodities and the expected payment amount from the terminal, and provide information corresponding to the optimal card to the terminal.

Here, the information required to predict the one or more expected purchase commodities and the expected payment amount may be received from a separate application server.

Further, although not shown in FIG. 18, the optimal card recommendation method based on the change of a recommended card according to the embodiment of the present invention stores various types of information, generated during a procedure for providing an optimal card recommendation service according to the embodiment of the present invention, in the storage module, as described above.

Here, the storage module may be implemented independently of the optimal card recommendation apparatus to support a function for the optimal card recommendation service. Here, the storage module may function as separate large-capacity storage, and may include a control function for performing operations.

By means of such an optimal card recommendation method, when the user pays for a commodity at a store using his or her mobile terminal, an automatic payment service may be used using a payment card that is recommended in advance.

Further, a payment card and a membership card that allow the user to obtain the maximum benefits, such as discounts or accumulation, are recommended depending on the commodities expected to be purchased by the user and the amount of the payment expected to be made by the user, thus inducing the user to consume appropriately and helping the user make reasonable purchases.

Furthermore, the number of operations required by the user to pay at the store using the mobile terminal may be minimized, and thus there is an advantage in that the convenience of the user may be maximized when commodities are purchased.

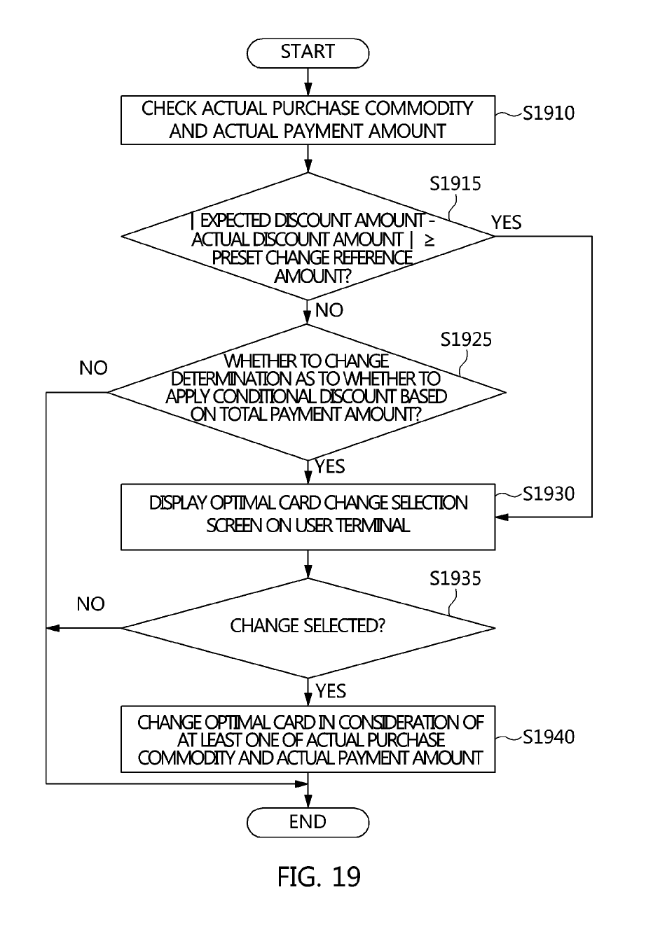

FIG. 19 is a flowchart showing in detail a procedure for changing an optimal card in the optimal card recommendation method based on the change of a recommended card according to an embodiment of the present invention.

Referring to FIG. 19, the procedure for changing an optimal card in the optimal card recommendation method based on the change of a recommended card according to the embodiment of the present invention first checks an actual purchase commodity, which is submitted by the user for actual purchase to a POS device, and an actual payment amount at step S1910.

Here, the clerk of the corresponding store may check the actual purchase commodity and the actual payment amount by scanning a barcode on the commodity chosen by the user using the POS device. Here, information input to the POS device may be provided both to the application server and to the optimal card recommendation apparatus over the network.

Thereafter, it is determined whether the difference obtained by comparing an expected discount amount based on at least one of the actual purchase commodity and the actual payment amount with an actual discount amount corresponding to the optimal card is equal to or greater than a preset change reference amount at step S1915. For example, the expected discount amount may be an amount expected when a card for providing the most benefits, among multiple cards registered in the application, is used in consideration of the actual purchase commodity and the actual payment amount.

If it is determined at step S1915 that the difference between the expected discount amount and the actual discount amount is less than the preset change reference amount, it is determined whether the determination as to whether to apply a conditional discount based on the total payment amount has changed at step S1925. For example, the conditional discount based on the total payment amount may be a discount provided when the total payment amount is equal to or greater than a predetermined level, as in the case where a 30% discount is provided when a purchase amount for commodities purchased with a specific card is 100,000 Won or more. Therefore, in the case where the expected payment amount is an amount to which the conditional discount can be applied, but the actual payment amount is an amount to which the conditional discount cannot be applied, it may be determined that the determination as to whether to apply the conditional discount based on the total payment amount has changed.

Here, if it is determined at step S1925 that that the determination as to whether to apply the conditional discount based on the total payment amount has not changed, the optimal card may not be changed. That is, since the above condition does not satisfy at least one card change condition required to change the optimal card, the optimal card may not be changed.

In contrast, if it is determined at step S1925 that the determination as to whether to apply the conditional discount based on the total payment amount has changed, an optimal card change selection screen is displayed on the terminal of the user at step S1930. That is, since the above condition satisfies at least one card change condition required to change the optimal card, a guidance screen may be displayed to the user so as to change the optimal card.

Meanwhile, if it is determined at step S1915 that the difference between the expected discount amount and the actual discount amount is equal to or greater than the preset change reference amount, the optimal card change selection screen is displayed on the terminal of the user at step S1930. Even in this case, since the above condition satisfies the at least one card change condition required to change an optimal card, similar to the case where the determination as to whether to apply the conditional discount based on the total payment amount has changed at step S1925, the guidance screen may be displayed to the user so as to change an optimal card.

Thereafter, it is determined whether the user has selected the change of a card on the optimal card change selection screen at step S1935. If it is determined that the change of the card has been selected, the optimal card is changed in consideration of at least one of the actual purchase commodity and the actual payment amount at step S1940.

Here, the screen for selecting the change of an optimal card may include a button for opting to change an optimal card and a button for opting not to change an optimal card.

Further, the screen for selecting the change of an optimal card may include information about the new optimal card when the optimal card is changed, that is, a new recommended card in consideration of the actual purchase commodity and the actual payment amount.

Furthermore, the screen for selecting the change of an optimal card may include information about a discount amount, a discount rate, and an accumulation rate depending on the change of the optimal card.

If it is determined at step S1935 that selection has been made so as not to change an optimal card, the optimal card is not changed.

Here, it may be possible to display the optimal card change selection screen in consideration of only one of card change conditions corresponding to steps S1915 and S1925.

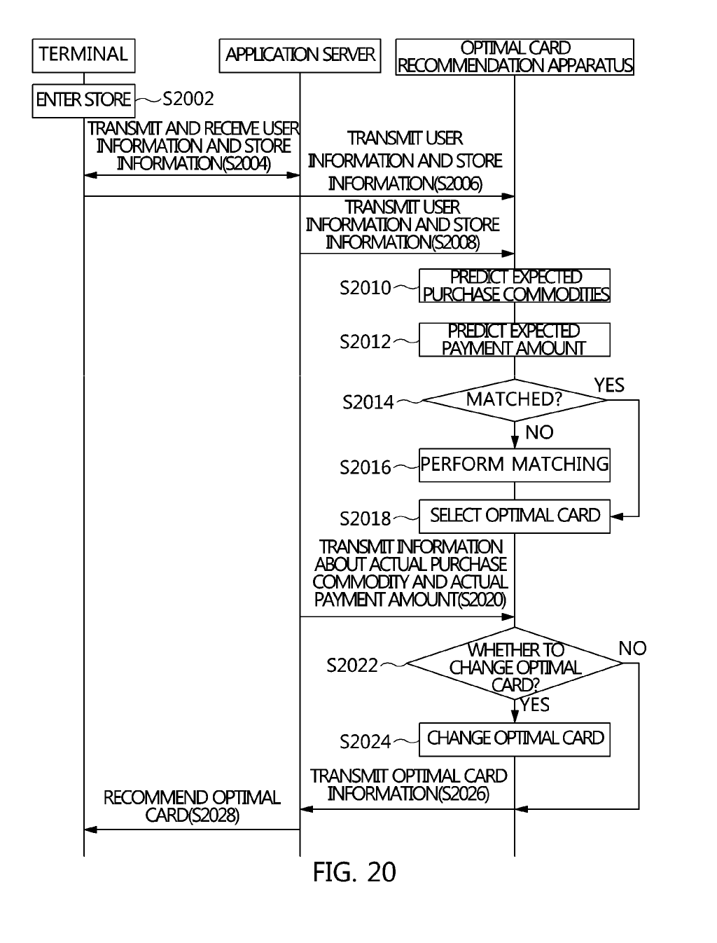

FIG. 20 is a flow diagram showing an optimal card recommendation process based on the change of a recommended card according to an embodiment of the present invention.

Referring to FIG. 20, in the optimal card recommendation process based on the change of a recommended card according to the embodiment of the present invention, the user enters an offline store while holding his or her terminal at step S2002.

Thereafter, an application server checks the terminal of the user based on information received through at least one BLE device, that is, at least one beacon, installed at the store, and transmits and receives user information and store information to and from the terminal of the user at step S2004.

Thereafter, the user information and the store information are transmitted to the optimal card recommendation apparatus through the terminal or the application server at steps S2006 and S2008.

Here, the user information may be private user information related to the personal information, purchase history information, and commodity-of-interest information of the user who has subscribed to the application, and the store information may correspond to information such as events, discounts and benefits corresponding to an offline store visited by the user.

Thereafter, the optimal card recommendation apparatus obtains at least one of the purchasing pattern of the user in an affiliated store group corresponding to the store, the purchasing pattern of a user group identical to the user in the affiliated store group, benefit information provided by each store, and the utilization of benefits by the user, based on the user information and the store information, and then predicts one or more expected purchase commodities at step S2010.

Next, the optimal card recommendation apparatus obtains information about an expected payment amount in consideration of at least one of the purchasing pattern of the user, information about the amount of the purchase by a single user at the store, and information about the amount of each purchase by the identical user group in the affiliated store group, based on the user information and the store information, and then predicts the expected payment amount at step S2012.

Thereafter, it is determined whether the one or more expected purchase commodities match the expected payment amount at step S2014.

Here, the prices of the one or more expected purchase commodities are summed, and thus the total amount is calculated. Whether the difference between the total amount and the expected payment amount is equal to or greater than a preset reference difference is determined. If it is determined that the difference is equal to or greater than the preset reference difference, matching may be performed.

If it is determined that matching is not performed at step S2014, when the total amount is greater than the expected payment amount, matching is performed by excluding a commodity having a low probability of being purchased from the one or more expected purchase commodities, whereas when the total amount is less than the expected payment amount, matching is performed by adjusting the expected payment amount at step S2016.

Thereafter, the optimal card to be used for payment is selected from among the cards of the user registered in the application, based on the one or more expected purchase commodities and the expected payment amount which have been matched, at step S2018.

Further, if it is determined at step S2014 that matching is performed, an optimal card is selected based on the one or more expected purchase commodities and the expected payment amount at step S2018.

Next, the application server transmits information about an actual purchase commodity and an actual payment amount to the optimal card recommendation apparatus at step S2020.

In this case, when the user chooses a commodity to be purchased and submits the commodity to the clerk of the store through the POS device, the clerk may input information about the actual purchase commodity into the POS device by scanning the barcode on the commodity.

Further, the POS device may deliver information about the actual purchase commodity, together with the actual payment amount, that is, the sum of the prices of the actual purchase commodity, to the application server.

Thereafter, the optimal card recommendation apparatus determines whether to change the optimal card in consideration of at least one of the actual purchase commodity and the actual payment amount at step S2022.

Here, the optimal card may be changed when satisfying at least one card change condition, which includes at least one of the case where the difference between an expected discount amount based on at least one of the actual purchase commodity and the actual payment amount and an actual discount amount corresponding to the optimal card is equal to or greater than a preset change reference amount, and the case where the determination as to whether to apply a conditional discount based on a total payment amount is changed.

If it is determined at step S2022 that the optimal card is to be changed, the optimal card is changed in consideration of at least one of the actual purchase commodity and the actual payment amount at step S2024.

Thereafter, information about the changed optimal card is delivered to the application server at step S2026, and the application server recommends an optimal card by displaying the optimal card information to the user through the application at step S2028.

Further, if it is determined at step S2022 that the optimal card is not to be changed, information about the selected optimal card is delivered to the application server at step S2026, and the application server recommends an optimal card by displaying the optimal card information to the user through the application at step S2028.

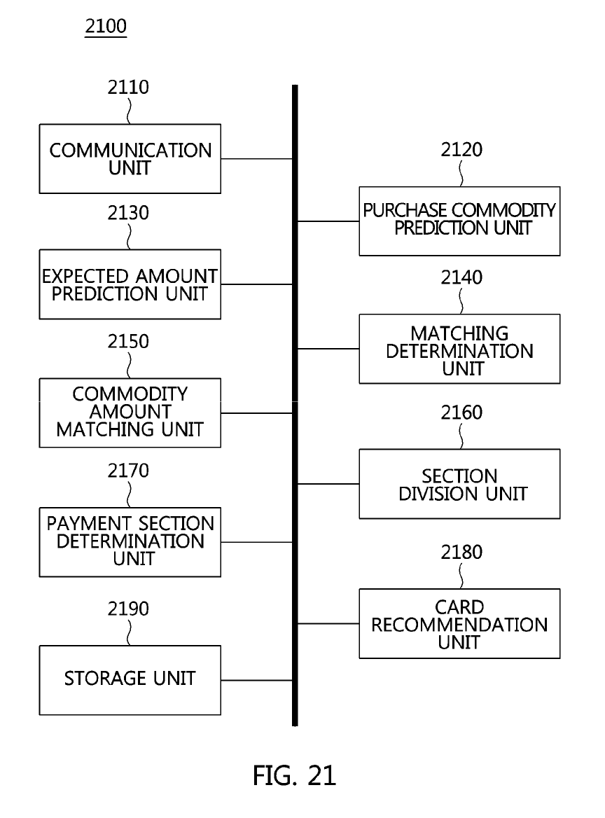

FIG. 21 is a block diagram showing an optimal card recommendation apparatus according to a further embodiment of the present invention.

Referring to FIG. 21, an optimal card recommendation apparatus 2100 according to the further embodiment of the present invention includes a communication unit 2110, a purchase commodity prediction unit 2120, an expected amount prediction unit 2130, a matching determination unit 2140, a commodity amount matching unit 2150, a section division unit 2160, a payment section determination unit 2170, a card recommendation unit 2180, and a storage unit 2190.

The communication unit 2110 functions to transmit and receive information required to recommend an optimal card to and from the terminal of the user over a communication network, such as a typical network. In particular, the communication unit 2110 according to an embodiment may receive pieces of information required to predict one or more expected purchase commodities and an expected payment amount from the terminal, and may provide information corresponding to the optimal card to the terminal. Further, information about the opening dates of card usage periods for respective cards registered in the application may be received through the homepages of respective card companies connected to the application server.

Here, information required to predict the one or more expected purchase commodities and the expected payment amount may be received from a separate application server. For example, user information, such as the purchase information, personal information, possessed payment card information, and possessed membership card information of the user, and various types of information, pertaining for example to events, discounts, and marketing information provided by the corresponding store, may be received.

The purchase commodity prediction unit 2120 predicts one or more purchase commodities that are expected to be purchased by the user at the store. That is, conventional card recommendation technology is configured to recommend an optimal payment card and an optimal membership card in consideration of information about the type and price of the corresponding commodity to be purchased by the user in the state in which the commodity to be purchased by the user has been fixed. Thus, the conventional card recommendation technology merely enables a card to be recommended only when the user enters information about the commodity to be purchased through the application, or only when commodity information is provided through the POS device at the store. However, such card recommendation technology cannot provide a particular advantage except for convenience in that information about the card to be used for payment is provided when the user purchases a commodity through the POS device.

In contrast, the present invention predicts in advance commodities expected to be purchased by the user and recommends a card in the state in which the commodity to be purchased by the user at the store is not yet fixed, thus providing assistance in further simplifying and facilitating the procedure in which the user actually performs payment through the POS device.

Here, one or more commodities expected to be purchased may be predicted in consideration of at least one of the purchasing pattern of the user in an affiliated store group corresponding to the store, the purchasing pattern of a user group identical to the user in the affiliated store group, benefit information provided by each store, and the utilization of benefits by the user.

In an embodiment, the purchasing patterns of the user for respective affiliated store groups may be generated using information, such as the types of commodities purchased by the user in each affiliated store group, which sells household items, the time of the purchase, or the price range of purchased commodities.

In another embodiment, based on the age, gender, occupation, and preference information of the user, a user group may be generated based on other users corresponding to information similar to the above information, and the purchasing pattern of the corresponding user group may be generated and may be used to predict commodities that are expected to be purchased.

In a further embodiment, information about the store visited by the user may be obtained, and benefit information currently provided by the store, that is, information about discounted commodities, commodities corresponding to a Buy-One-Get-One-Free (BOGOF) offer, or commodities available for a limited time, may be obtained and used to predict the commodities that are expected to be purchased.

In yet another embodiment, commodities expected to be purchased may be predicted in consideration of how the user has utilized benefits obtained from the purchase of commodities. That is, benefit information preferred by the user between discounts and accumulation may be considered, or a usage pattern for accumulated points may be considered when the commodities expected to be purchased are predicted.

Here, unnecessary commodity items may be detected in consideration of at least one of information about the commodity most recently purchased by the user in the affiliated store group and the time of the purchase, and may be excluded when one or more commodities expected to be purchased are predicted.

For example, when there is a commodity purchased by the user in an affiliated store group identical to a specific store before the user visits the specific store, there is a low probability that the user will purchase the corresponding commodity at the current store. Therefore, when the commodity expected to be purchased at the current store is predicted, the commodity previously purchased in the same affiliated store group may be recognized as an unnecessary commodity item, and may be excluded from the commodities expected to be purchased.

In still another embodiment, when there is a commodity purchased by the user in an affiliated store group identical to a specific store before the user visits the specific store, the commodity may instead be predicted to be the commodity expected to be purchased in consideration of the time at which the corresponding commodity was purchased and whether the commodity is discounted or not. That is, assuming that hair gel is on sale at a discount price at a hair product shop visited by the user, and the user purchased the hair gel one month ago, there may be a high probability that the user will purchase the hair gel owing to the benefits of the discount price at this visit.

The expected amount prediction unit 2130 predicts the amount of the payment that is expected to be made by the user at the store.

Here, the reason for additionally predicting an expected payment amount as well as an expected purchase commodity so as to recommend an optimal card is that there may be benefits that are provided when a predetermined amount or more is paid at each store. Therefore, the amount required to purchase a commodity, that is, the payment amount, may be a very important factor in recommending a card. For example, assuming that a discount benefit is provided when commodities corresponding to more than 100,000 Won are purchased with a specific payment card at a store visited by the user, a payment amount for purchase commodities, which are expected to be purchased by the user at the corresponding store, is predicted to reach an amount of 100,000 Won, thus allowing the user to obtain more benefits.

Here, the expected payment amount may be predicted in consideration of at least one of the purchasing pattern of the user, information about the amount of the purchase by a single user at the store, and information about the amount of each purchase by a user group identical to the user in an affiliated store group.

In an embodiment, when the purchasing pattern of the user, which was considered when the expected purchase commodity was predicted, is used, information about the prices of commodities to be purchased by the user may be acquired, and thus the expected payment amount may be predicted in consideration of the purchasing pattern of the user.

In another embodiment, an expected payment amount may be predicted using information about the average purchase amount by a single user at the store visited by the user.

In a further embodiment, whether the store visited by the user is a jewelry shop which sells relatively expensive goods, or a grocery shop which sells relatively cheap goods, is determined, and information about the amount of each purchase in the corresponding affiliated store group may be considered. Further, whether a user is a student, a housewife, or an office worker is determined, and thus information about the amount of each purchase by a user group identical to the user may be considered. That is, in the cases where the user is a student and where the user is an office worker, there may be a great difference in consumption tendencies, and thus an expected payment amount may be predicted in consideration of the purchase amount information based on the user group.

The matching determination unit 2140 determines whether to match the one or more expected purchase commodities with the expected payment amount by comparing the total amount of the one or more expected purchase commodities with the expected payment amount. For example, assuming that the expected payment amount is predicted to be excessively high compared to the number of the one or more expected purchase commodities, there is the possibility that the reliability of the recommended card may be deteriorated because the tendencies of two conditions that are considered when recommending an optimal card are different from each other. Therefore, it is possible to compare the total amount obtained by summing the prices of one or more expected purchase commodities with the expected payment amount, and to determine to match the expected purchase commodities with the expected payment amount if it is determined that a difference is present between the total amount and the expected payment amount. Then, an algorithm for performing matching may be executed.

Further, if it is determined that the total amount is relatively similar to the expected payment amount when comparing the total amount with the expected payment amount, matching is not performed, and the expected payment amount may be used as a reference value that is considered when recommending an optimal card.

At this time, when the difference between the total amount and the expected payment amount is equal to or greater than a preset reference difference, it may be determined that matching is to be performed. For example, when the preset reference difference is 30,000 Won, matching may be performed when the difference between the total amount and the expected payment amount is 30,000 Won or more.

Here, the preset reference difference may be set to different values depending on affiliated store groups. For example, the reference difference in an affiliated store group that sells expensive commodities is set to a value larger than that of the reference difference in an affiliated store group that sells relatively inexpensive commodities, thus preventing unnecessary matching from being performed. Further, the reference difference in an affiliated store group that sells inexpensive commodities is set to a smaller value, thus improving the accuracy of the algorithm for recommending an optimal card.

The commodity amount matching unit 2150 is configured to, when performing matching between the one or more expected purchase commodities and the expected payment amount, adjust any one of the expected payment amount and the one or more expected purchase commodities, and then match the one or more expected purchase commodities with the expected payment amount. That is, in order to reduce the difference between the total amount of the one or more expected purchase commodities and the expected payment amount, any one of the total amount and the expected payment amount may be adjusted.

Here, when the total amount is greater than the expected payment amount, a commodity having a low probability of being purchased is first excluded from the one or more expected purchase commodities, and thus the total amount may be adjusted to match the expected payment amount. For example, it may be assumed that there are 10 expected purchase commodities, that the total amount is greater than the expected payment amount, and that the difference between the total amount and the expected payment amount is greater than a preset reference difference by 50,000 Won. In this case, it is determined that an unnecessary commodity is further included in the expected purchase commodities, the probabilities of being purchased are determined for 10 respective expected purchase commodities, and the commodity having the lowest probability of being purchased may be excluded first.

Further, when the total amount is less than the expected payment amount, the expected payment amount is adjusted to match the total amount, and thus the one or more expected purchase commodities may match the expected payment amount. For example, it may be assumed that there are five expected purchase commodities, that the total amount is less than the expected payment amount, and that the difference between the total amount and the expected payment amount is greater than a preset reference difference by 50,000 Won. In this case, it is preferable to recommend a card using a method for adjusting the expected payment amount to match the total amount, rather than using a method for adding a commodity having a low probability of being purchased to the expected purchase commodities for the additional purchase of the commodity. That is, since the probability that the user will purchase an unnecessary commodity is low, the accuracy of the algorithm for recommending a card may be improved by decreasing the expected payment amount.

The section division unit 2160 checks the opening dates of card usage periods (billing cycles or statement periods) of multiple cards registered in the application, and divides each of the usage record determination periods corresponding to one month from the card usage period opening dates into a plurality of sections. For example, assuming that the opening date of the card usage period is the first day of each month, the usage record determination period may be divided into sections such that an interval ranging from the opening date to ⅓ of the usage record determination period is a first section, an interval ranging from the end of the first section to ⅔ of the usage record determination period is a second section, and an interval corresponding to the remaining ⅓ of the usage record determination period is a third section.

Here, since the opening dates of card usage periods of respective cards may be different from each other, the usage record determination periods may be divided into multiple sections in different ways for multiple respective cards.

In this case, separate recommendation algorithms may be applied to respective sections. For example, an algorithm for recommending an optimal card in consideration of benefits may be applied to the first section, an algorithm for recommending an optimal card in consideration of both benefits and the card usage record in the current month may be applied to the second section, and an algorithm for recommending an optimal card in consideration of only the card usage record in the current month may be applied to the third section. Further, when the card usage record is considered, as in the case of the second section or the third section, a card may also be recommended in consideration of the usage record in the future by operating in conjunction with other applications, such as the calendar or housekeeping book of the user terminal.

Further, recommendation factors, such as discounts or accumulation, the achievement rate of the usage record in the current month, or the non-achievement rate of the usage record in the current month, are designated for respective sections to which recommendation algorithms are applied, and weights may be differently set for respective recommendation factors. Furthermore, weights for respective recommendation factors may be set differently for respective cards. For example, the weights of discounts and accumulation for card A may be set to values greater than those of card B.

In this case, the multiple sections may be variously set and divided depending on the optimal card recommendation system.

Here, cards having the same card usage period opening date, among the multiple cards, may be grouped, and then one or more card groups may be generated. For example, it may be assumed that five credit cards corresponding to A to E are registered in the application and that the opening dates of card usage periods of cards A to C are the first day of each month, but the opening dates of card usage periods of cards D and E are the 11th of each month. Here, cards A, B, and C may be grouped to generate a first card group, and cards D and E may be grouped to generate a second card group.

In this case, the usage record determination period corresponding to each of the one or more card groups may be divided into multiple group-based sections. That is, in the above example, since the opening date of the card usage period for the first card group is the first day of each month, the usage record determination period may be divided into multiple sections such that an interval ranging from the first to the 10th of the month is a first section, an interval ranging from the 11th to the 20th is a second section, and an interval ranging from the 21st to the last day is a third section. Further, since the opening date of the card usage period for the second card group is the 11th of each month, the usage record determination period may be divided into multiple sections such that an interval ranging from the 11th to the 20th of the month is a first section, an interval ranging from the 21st to the last day is a second section, and an interval ranging from the first to the 10th is a third section.

The payment section determination unit 2170 determines a payment section corresponding to the current date, among the multiple sections corresponding to the usage record determination period. That is, among the multiple sections, the section in which the current date, on which the user enters the store, falls may be determined.

The card recommendation unit 2180 recommends an optimal card, among multiple cards registered in the application, in consideration of at least one of the recommendation algorithm corresponding to the payment section, the one or more expected purchase commodities, and the expected payment amount.

Here, weights for recommendation are respectively assigned to the recommendation algorithm corresponding to the payment section, the one or more expected purchase commodities, and the expected payment amount, and the card for which the sum of the individual weights is the largest may be recommended as an optimal card.

Here, the multiple cards may include payment cards such as a cash card, a debit card, and a credit card for payment. Further, the multiple cards may include a membership card, a cash-back card, and a discount card, which enable points to be accumulated or discounts to be provided when commodities are purchased.

Here, the application may include a mobile payment application, a mobile electronic wallet application, etc., which register the card information of the user and allow the terminal to perform payment using the card information.

Here, when the payment section is the first section among the multiple sections, an optimal card may be recommended among the multiple cards in consideration of benefits. When the payment section is the second section among the multiple sections, an optimal card may be recommended among the multiple cards in consideration of both benefits and the usage record in the current month. When the payment section is the third section among the multiple sections, an optimal card may be recommended among the multiple cards in consideration of the usage record in the current month.

At this time, the first section may be a section corresponding to a first part of the usage record determination period, the second section may be a section corresponding to the middle part of the usage record determination period, and the third section may be a section corresponding to the last part of the usage record determination period.

Therefore, since the first section is not yet the time during which the usage record in the current month is to be considered, the card that provides the maximum benefits may be recommended as an optimal card in consideration of benefits such as discounts or accumulation.

Further, in the second section, a card which provides more benefits, among cards for which the usage records in the current month have not yet reached target usage records, may be recommended as an optimal card in consideration of the usage record in the current month together with benefits. For example, it may be assumed that, when payment is performed using card A, for which the usage record in the current month has reached the target usage record, a discount benefit of 1,000 Won may be obtained, and that when payment is performed using card B, for which the usage record in the current month has not yet reached the target usage record, a discount benefit 800 Won may be obtained. Here, when an optimal card is recommended by assigning a weight to the usage record in the current month for card B, card B may be recommended as an optimal card even if the discount amount of card B is lower than that of card A by 200 Won.

Furthermore, in the third section, a card for which the usage record in the current month is expected to reach the target usage record during the period remaining until the opening date of the next card usage period may be recommended as an optimal card, among cards for which usage records in the current month have not yet reached the target usage records, in consideration of the usage record in the current month. For example, it may be assumed that when payment is performed using card C, for which 100,000 Won remains in order for the usage record in the current month to reach the target usage record, a discount benefit of 500 Won may be obtained, and when payment is performed using card D, for which 10,000 Won remains in order for the usage record in the current month to reach the target usage record, a discount benefit of 300 Won is obtained. Here, assuming that the same period of three days remains until the opening dates of the card usage periods of card C and card D, card D, which is expected to reach the target usage record in the remaining three days based on the payment pattern of the user, may be recommended as the optimal card even if a 200-Won discount is not immediately obtained.

Here, when the payment section is the first section, and there are cards having the same benefits, among multiple cards, an optimal card may be recommended in the sequence of usage records in the current month from lowest to highest usage records. When the payment section is the second section, and there are cards having the same benefits, among the multiple cards, an optimal card may be recommended in the sequence of usage records in the current month from closest to farthest from target usage records for respective cards. That is, when there are cards for which recommendation criteria for respective sections are identical to each other, the usage record in the current month may be accumulated by prompting the user to primarily use a card having a low usage record in the current month in the first section. Further, a card for which the usage record has not yet reached the target usage record, but is expected to reach the target usage record because the usage record in the current month is high, may be recommended in the second section.

In this case, it is possible to determine which one of the multiple sections corresponds to the payment section, select one or more group-based optimal cards from each of one or more card groups, and recommend an optimal card, among the one or more group-based optimal cards, in consideration of at least one of the benefits and the usage record in the current month.

For example, it may be assumed that cards A, B, and C are included in the first card group, the opening date of the card usage period of which is the first day of each month, and that cards D and E are included in the second card group, the opening date of the card usage period of which is the 11th of each month. Here, it may also be assumed that, for the first card group, the first section may range from the first to the 10th of the month, the second section may range from the 11th to the 20th, and the third section may range from the 21st to the last day, and for the second card group, the first section may range from the 11th to the 20th, the second section may range from the 21st to the last day, the third section may range from the first to the 10th, and a payment due date is the 12th. At this time, in the first card group, the payment due date may fall within the second section, and in the second card group, the payment due date may fall within the first section. Therefore, in the first card group, one of cards A, B, and C may be selected based on the recommendation algorithm applied to the second section, and in the second card group, one of cards D and E may be selected based on the recommendation algorithm applied to the first section.

Assuming that card A is selected from the first card group and that card D is selected from the second card group, one of the selected cards may be recommended as an optimal card in consideration of at least one of the benefits of cards A and D and the usage records in the current month for cards A and D.

Here, among one or more payment cards included in the multiple cards, an optimal payment card may be recommended.

In an embodiment, since discount or accumulation rates may differ from each other depending on whether the payment card is a credit card, a cash card or a debit card, the discount rates and accumulation rates for respective types of payment cards may be checked, and the card having the maximum benefits may be recommended as the optimal payment card when the payment section of the corresponding card is a section in which benefits are considered depending on the payment sections of respective payment cards.

In another embodiment, discount rates or accumulation rates for respective card companies and banks corresponding to credit cards or debit cards may differ. Thus, the discount rates and accumulation rates for respective card companies and banks may be checked so as to recommend an optimal card.

In a further embodiment, since the benefits of respective credit cards or debit cards may be provided differently depending on the card usage record in the previous month, an optimal card may be recommended by additionally considering whether the card usage record in a previous month has been achieved.

Further, among one or more membership cards included in the multiple cards, an optimal membership card may be recommended together with the optimal payment card.

For example, when an optimal payment card is recommended, a membership card, which can be used together with the recommended payment card and can be used at the corresponding store, is recommended together with the payment card, thus allowing the user to be sufficiently provided with the benefits of discounts and accumulation without missing the benefits.

Furthermore, when it is possible to purchase a commodity using points accumulated in a membership card, the corresponding membership card may be included in a card recommendation list for payment and may also be recommended. In addition, when payment using points is possible according to the setting of the user, the recommendation priority of the corresponding membership card is designated to be higher than that of a credit card or a debit card, and then the membership card may be primarily recommended.

Here, information about an optimal payment card and an optimal membership card may be provided together through the application. For example, information about the optimal membership card that matches information about the optimal payment card may be displayed together on a single screen of the application. Alternatively, when the optimal payment card is clicked, optimal membership cards that can be used together with the clicked optimal payment card may be provided in the form of a list in descending order of benefit amount.

As described above, the storage unit 2190 stores various types of information generated during a procedure for providing the optimal card recommendation service according to an embodiment of the present invention.

In an embodiment, the storage unit 2190 may be implemented independently of the optimal card recommendation apparatus 2100 and may then support a function for the optimal card recommendation service. Here, the storage unit 2190 may function as separate large-capacity storage and may include a control function for performing operations.

Meanwhile, the optimal card recommendation apparatus 2100 is equipped with memory and may store information in the apparatus. In an exemplary embodiment, the memory is a computer-readable medium. In an exemplary embodiment, the memory may be a volatile memory unit, and in another exemplary embodiment, the memory may be a nonvolatile memory unit. In an embodiment, the storage may be a computer-readable medium. In various different embodiments, the storage may include, for example, a hard disk device, an optical disk device or other types of large-capacity storage device.

Such an optimal card recommendation apparatus 2100 is used, and thus the user may use an automatic payment service with a previously recommended payment card when paying for a commodity at a store using his or her mobile terminal.

Further, a payment card and a membership card which allow the user to obtain the maximum benefits, such as discounts or accumulation, are recommended depending on the commodity expected to be purchased by the user and the expected payment amount, thus inducing the user to consume appropriately and helping the user make a reasonable purchase.

Furthermore, an operation required by the user to pay at a store using a mobile terminal may be minimized, and thus there is an advantage in that the user's convenience may be maximized when commodities are purchased.

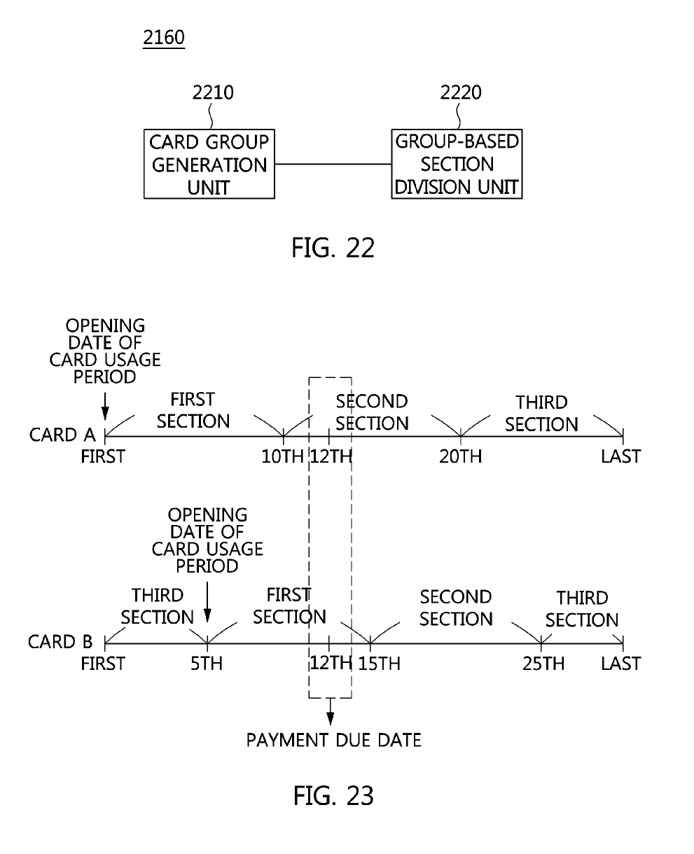

FIG. 22 is a block diagram showing in detail the section division unit shown in FIG. 21.

Referring to FIG. 22, the section division unit 2160 shown in FIG. 21 includes a card group generation unit 2210 and a group-based section division unit 2220.

The card group generation unit 2210 may generate one or more card groups by grouping cards having the same card usage period opening date, among multiple cards.

For example, it may be assumed that five credit cards corresponding to A to E are registered in the application and that the opening dates of card usage periods of cards A to C are the first day of each month, but the opening dates of card usage periods of cards D and E are the 11th of each month. Here, cards A, B, and C may be grouped to generate a first card group, and cards D and E may be grouped to generate a second card group.

The group-based section division unit 2220 may divide a usage record determination period corresponding to each of the one or more card groups into multiple group-based sections.

That is, in the above example, since the opening date of the card usage period for the first card group is the first day of each month, the usage record determination period may be divided into multiple sections such that an interval ranging from the first to the 10th of the month is a first section, an interval ranging from the 11th to the 20th is a second section, and an interval ranging from the 21st to the last day is a third section. Further, since the opening date of the card usage period for the second card group is the 11th of each month, the usage record determination period may be divided into multiple sections such that an interval ranging from the 11th to the 20th of the month is a first section, an interval ranging from the 21st to the last day is a second section, and an interval ranging from the first to the 10th is a third section.

FIG. 23 is a diagram showing sections obtained by dividing a usage record determination period according to an embodiment of the present invention.

Referring to FIG. 23, the usage record determination period according to the embodiment of the present invention may be determined differently depending on the opening dates of card usage periods for respective cards.

For example, with reference to the usage record determination periods of card A and card B, shown in FIG. 23, the opening date of the card usage period of card A is the first day of each month, and thus a period ranging from the first to the last day of the month may correspond to the usage record determination period. However, the opening date of the card usage period of card B is the fifth of each month, and thus a period ranging from the fifth of this month to the fourth of the next month may correspond to the usage record determination period.

In this way, since usage record determination periods differ from each other depending on the opening dates of card usage periods, cards having different card usage period opening dates may be configured so as to divide their usage record determination periods into different sections.

That is, in the case of card A, the usage record determination period may be divided into sections such that an interval ranging from the first of the month, which is the opening date of the card usage period, to the 10th is the first section, an interval ranging from the 11th to the 20th of the month is the second section, and an interval ranging from the 21st to the last of the month is the third section. In contrast, even if the usage record determination period of card B is divided in the same way as card A, it may be divided into sections such that an interval ranging from the fifth of the month, which is the opening date of the card usage period, to the 15th is the first section, an interval ranging from the 16th to the 25th is the second section, and an interval ranging from the 26th of the month to the fourth of the next month is the third section.

Therefore, assuming that the current date, on which the user enters a store, is the 12th, the date may correspond to the second section of card A, but the date may correspond to the first section of card B. Therefore, when a recommendation algorithm depending on the payment section is applied, recommendation priority may be assigned to card A based on the recommendation algorithm corresponding to the second section, and recommendation priority may be assigned to card B based on the recommendation algorithm corresponding to the first section.

For example, it may be assumed that an algorithm for recommending an optimal card in consideration of benefits is used in the first section of payment sections for respective cards, an algorithm for recommending an optimal card in consideration of both benefits and the usage record in the current month is used in the second section, and an algorithm for recommending an optimal card in consideration of the usage record in the current month is used in the third section. Here, since the payment due date of card A corresponds to the second section, it is determined whether card A is the target to be recommended in consideration of both benefits and the usage record in the current month. Since the payment due date of card B corresponds to the first section, it may be determined whether card B is the target to be recommended in consideration of only benefits.

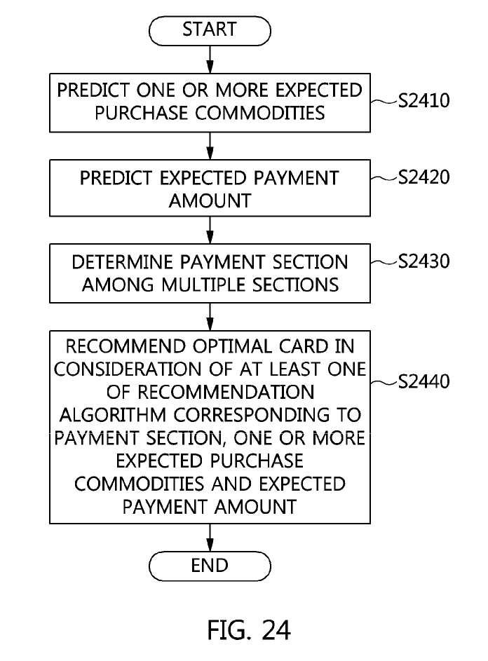

FIG. 24 is an operation flowchart showing a payment time-based optimal card recommendation method according to an embodiment of the present invention.

Referring to FIG. 24, the payment time-based optimal card recommendation method according to the embodiment of the present invention is an optimal card recommendation method performed by the payment time-based optimal card recommendation apparatus. First, the payment time-based optimal card recommendation method predicts one or more purchase commodities that are expected to be purchased by the user at a store at step S2410. That is, conventional card recommendation technology is configured to recommend an optimal payment card and an optimal membership card in consideration of information about the type and price of the corresponding commodity to be purchased by the user in the state in which the commodity to be purchased by the user has been fixed. Thus, the conventional card recommendation technology merely enables a card to be recommended only when the user enters information about the commodity to be purchased through the application, or only when commodity information is provided through the POS device at the store. However, such card recommendation technology cannot provide a particular advantage except for convenience in that information about the card to be used for payment is provided when the user purchases a commodity through the POS device.

In contrast, the present invention predicts in advance commodities expected to be purchased by the user and recommends a card in the state in which the commodity to be purchased by the user at the store is not yet fixed, thus providing assistance in further simplifying and facilitating the procedure in which the user actually performs payment through the POS device.

Here, one or more commodities expected to be purchased may be predicted in consideration of at least one of the purchasing pattern of the user in an affiliated store group corresponding to the store, the purchasing pattern of a user group identical to the user in the affiliated store group, benefit information provided by each store, and the utilization of benefits by the user.

In an embodiment, the purchasing patterns of the user for respective affiliated store groups may be generated using information, such as the types of commodities purchased by the user in each affiliated store group, which sells household items, the time of the purchase, or the price range of purchased commodities.

In another embodiment, based on the age, gender, occupation, and preference information of the user, a user group may be generated based on other users corresponding to information similar to the above information, and the purchasing pattern of the corresponding user group may be generated and may be used to predict commodities that are expected to be purchased.

In a further embodiment, information about the store visited by the user may be obtained, and benefit information currently provided by the store, that is, information about discounted commodities, commodities corresponding to a Buy-One-Get-One-Free (BOGOF) offer, or commodities available for a limited time, may be obtained and used to predict the commodities that are expected to be purchased.

In yet another embodiment, commodities expected to be purchased may be predicted in consideration of how the user has utilized benefits obtained from the purchase of commodities. That is, benefit information preferred by the user between discounts and accumulation may be considered, or a usage pattern for accumulated points may be considered when the commodities expected to be purchased are predicted.

Here, unnecessary commodity items may be detected in consideration of at least one of information about the commodity most recently purchased by the user in the affiliated store group and the time of the purchase, and may be excluded when one or more commodities expected to be purchased are predicted.

For example, when there is a commodity purchased by the user in an affiliated store group identical to a specific store before the user visits the specific store, there is a low probability that the user will purchase the corresponding commodity at the current store. Therefore, when the commodity expected to be purchased at the current store is predicted, the commodity previously purchased in the same affiliated store group may be recognized as an unnecessary commodity item, and may be excluded from the commodities expected to be purchased.

In still another embodiment, when there is a commodity purchased by the user in an affiliated store group identical to a specific store before the user visits the specific store, the commodity may instead be predicted to be the commodity expected to be purchased in consideration of the time at which the corresponding commodity was purchased and whether the commodity is discounted or not. That is, assuming that hair gel is on sale at a discount price at a hair product shop visited by the user, and the user purchased the hair gel one month ago, there may be a high probability that the user will purchase the hair gel owing to the benefits of the discount price at this visit.

Further, the payment time-based optimal card recommendation method according to the embodiment of the present invention predicts the amount of the payment that is expected to be made by the user at the store at step S2420.

Here, the reason for additionally predicting an expected payment amount as well as an expected purchase commodity so as to recommend an optimal card is that there may be benefits that are provided when a predetermined amount or more is paid at each store. Therefore, the amount required to purchase a commodity, that is, the payment amount, may be a very important factor in recommending a card. For example, assuming that a discount benefit is provided when commodities corresponding to more than 100,000 Won are purchased with a specific payment card at a store visited by the user, a payment amount for purchase commodities, which are expected to be purchased by the user at the corresponding store, is predicted to reach an amount of 100,000 Won, thus allowing the user to obtain more benefits.

Here, the expected payment amount may be predicted in consideration of at least one of the purchasing pattern of the user, information about the amount of the purchase by a single user at the store, and information about the amount of each purchase by a user group identical to the user in an affiliated store group.

In an embodiment, when the purchasing pattern of the user, which was considered when the expected purchase commodity was predicted, is used, information about the prices of commodities to be purchased by the user may be acquired, and thus the expected payment amount may be predicted in consideration of the purchasing pattern of the user.

In another embodiment, an expected payment amount may be predicted using information about the average purchase amount by a single user at the store visited by the user.

In a further embodiment, whether the store visited by the user is a jewelry shop which sells relatively expensive goods, or a grocery shop which sells relatively cheap goods, is determined, and information about the amount of each purchase in the corresponding affiliated store group may be considered. Further, whether a user is a student, a housewife, or an office worker is determined, and thus information about the amount of each purchase by a user group identical to the user may be considered. That is, in the cases where the user is a student and where the user is an office worker, there may be a great difference in consumption tendencies, and thus an expected payment amount may be predicted in consideration of the purchase amount information based on the user group.

Further, although not shown in FIG. 24, the payment time-based optimal card recommendation method according to the embodiment of the present invention determines whether to match the one or more expected purchase commodities with the expected payment amount by comparing the total amount of one or more expected purchase commodities with the expected payment amount. For example, assuming that the expected payment amount is predicted to be excessively high compared to the number of the one or more expected purchase commodities, there is the possibility that the reliability of the recommended card may be deteriorated because the tendencies of two conditions that are considered when recommending an optimal card are different from each other. Therefore, it is possible to compare the total amount obtained by summing the prices of one or more expected purchase commodities with the expected payment amount, and to determine to match the expected purchase commodities with the expected payment amount if it is determined that a difference is present between the total amount and the expected payment amount. Then, an algorithm for performing matching may be executed.

Further, if it is determined that the total amount is relatively similar to the expected payment amount when comparing the total amount with the expected payment amount, matching is not performed, and the expected payment amount may be used as a reference value that is considered when recommending an optimal card.

At this time, when the difference between the total amount and the expected payment amount is equal to or greater than a preset reference difference, it may be determined that matching is to be performed. For example, when the preset reference difference is 30,000 Won, matching may be performed when the difference between the total amount and the expected payment amount is 30,000 Won or more.

Here, the preset reference difference may be set to different values depending on affiliated store groups. For example, the reference difference in an affiliated store group that sells expensive commodities is set to a value larger than that of the reference difference in an affiliated store group that sells relatively inexpensive commodities, thus preventing unnecessary matching from being performed. Further, the reference difference in an affiliated store group that sells inexpensive commodities is set to a smaller value, thus improving the accuracy of the algorithm for recommending an optimal card.

Furthermore, although not shown in FIG. 24, the payment time-based optimal card recommendation method according to the embodiment of the present invention matches the one or more expected purchase commodities with the expected payment amount by adjusting any one of the expected payment amount and the one or more expected purchase commodities if it is determined to match the one or more expected purchase commodities with the expected payment amount. That is, any one of the total amount of the one or more expected purchase commodities and the expected payment amount may be adjusted so as to reduce the difference between the total amount and the expected payment amount.

Here, when the total amount is greater than the expected payment amount, a commodity having a low probability of being purchased is first excluded from the one or more expected purchase commodities, and thus the total amount may be adjusted to match the expected payment amount. For example, it may be assumed that there are 10 expected purchase commodities, that the total amount is greater than the expected payment amount, and that the difference between the total amount and the expected payment amount is greater than a preset reference difference by 50,000 Won. In this case, it is determined that an unnecessary commodity is further included in the expected purchase commodities, the probabilities of being purchased are determined for 10 respective expected purchase commodities, and the commodity having the lowest probability of being purchased may be excluded first.

Further, when the total amount is less than the expected payment amount, the expected payment amount is adjusted to match the total amount, and thus the one or more expected purchase commodities may match the expected payment amount. For example, it may be assumed that there are five expected purchase commodities, that the total amount is less than the expected payment amount, and that the difference between the total amount and the expected payment amount is greater than a preset reference difference by 50,000 Won. In this case, it is preferable to recommend a card using a method for adjusting the expected payment amount to match the total amount, rather than using a method for adding a commodity having a low probability of being purchased to the expected purchase commodities for the additional purchase of the commodity. That is, since the probability that the user will purchase an unnecessary commodity is low, the accuracy of the algorithm for recommending a card may be improved by decreasing the expected payment amount.

Furthermore, although not shown in FIG. 24, the payment time-based optimal card recommendation method according to the embodiment of the present invention checks the opening dates of card usage periods of multiple cards registered in the application, and divides each of the usage record determination periods corresponding to one month from the card usage period opening dates into a plurality of sections. For example, assuming that the opening date of the card usage period is the first day of each month, the usage record determination period may be divided into sections such that an interval ranging from the opening date to ⅓ of the usage record determination period is a first section, an interval ranging from the end of the first section to ⅔ of the usage record determination period is a second section, and an interval corresponding to the remaining ⅓ of the usage record determination period is a third section.

Here, since the opening dates of card usage periods of respective cards may be different from each other, the usage record determination periods may be divided into multiple sections in different ways for multiple respective cards.

In this case, separate recommendation algorithms may be applied to respective sections. For example, an algorithm for recommending an optimal card in consideration of benefits may be applied to the first section, an algorithm for recommending an optimal card in consideration of both benefits and the card usage record in the current month may be applied to the second section, and an algorithm for recommending an optimal card in consideration of only the card usage record in the current month may be applied to the third section. Further, when the card usage record is considered, as in the case of the second section or the third section, a card may also be recommended in consideration of the usage record in the future by operating in conjunction with other applications, such as the calendar or housekeeping book of the user terminal.

Further, recommendation factors, such as discounts or accumulation, the achievement rate of the usage record in the current month, or the non-achievement rate of the usage record in the current month, are designated for respective sections to which recommendation algorithms are applied, and weights may be differently set for respective recommendation factors. Furthermore, weights for respective recommendation factors may be set differently for respective cards. For example, the weights of discounts and accumulation for card A may be set to values greater than those of card B.

In this case, the multiple sections may be variously set and divided depending on the optimal card recommendation system.

Here, cards having the same card usage period opening date, among the multiple cards, may be grouped, and then one or more card groups may be generated. For example, it may be assumed that five credit cards corresponding to A to E are registered in the application and that the opening dates of card usage periods of cards A to C are the first day of each month, but the opening dates of card usage periods of cards D and E are the 11th of each month. Here, cards A, B, and C may be grouped to generate a first card group, and cards D and E may be grouped to generate a second card group.

In this case, the usage record determination period corresponding to each of the one or more card groups may be divided into multiple group-based sections. That is, in the above example, since the opening date of the card usage period for the first card group is the first day of each month, the usage record determination period may be divided into multiple sections such that an interval ranging from the first to the 10th of the month is a first section, an interval ranging from the 11th to the 20th is a second section, and an interval ranging from the 21st to the last day is a third section. Further, since the opening date of the card usage period for the second card group is the 11th of each month, the usage record determination period may be divided into multiple sections such that an interval ranging from the 11th to the 20th of the month is a first section, an interval ranging from the 21st to the last day is a second section, and an interval ranging from the first to the 10th is a third section.

Further, the payment time-based optimal card recommendation method according to the embodiment of the present invention determines a payment section corresponding to the current date, among the sections corresponding to the usage record determination period, at step S2430. That is, among the multiple sections, the section in which the current date, on which the user enters a store, falls may be determined.

Furthermore, the payment time-based optimal card recommendation method according to the embodiment of the present invention recommends an optimal card, among the multiple cards registered in the application, in consideration of at least one of the recommendation algorithm corresponding to the payment section, the one or more expected purchase commodities, and the expected payment amount at step S2440.

Here, weights for recommendation are respectively assigned to the recommendation algorithm corresponding to the payment section, the one or more expected purchase commodities, and the expected payment amount, and the card for which the sum of the individual weights is the largest may be recommended as an optimal card.

Here, the multiple cards may include payment cards such as a cash card, a debit card, and a credit card for payment. Further, the multiple cards may include a membership card, a cash-back card, and a discount card, which enable points to be accumulated or discounts to be provided when commodities are purchased.

Here, the application may include a mobile payment application, a mobile electronic wallet application, etc., which register the card information of the user and allow the terminal to perform payment using the card information.

Here, when the payment section is the first section among the multiple sections, an optimal card may be recommended among the multiple cards in consideration of benefits. When the payment section is the second section among the multiple sections, an optimal card may be recommended among the multiple cards in consideration of both benefits and the usage record in the current month. When the payment section is the third section among the multiple sections, an optimal card may be recommended among the multiple cards in consideration of the usage record in the current month.

At this time, the first section may be a section corresponding to a first part of the usage record determination period, the second section may be a section corresponding to the middle part of the usage record determination period, and the third section may be a section corresponding to the last part of the usage record determination period.

Therefore, since the first section is not yet the time during which the usage record in the current month is to be considered, the card that provides the maximum benefits may be recommended as an optimal card in consideration of benefits such as discounts or accumulation.

Further, in the second section, a card which provides more benefits, among cards for which the usage records in the current month have not yet reached target usage records, may be recommended as an optimal card in consideration of the usage record in the current month together with benefits. For example, it may be assumed that, when payment is performed using card A, for which the usage record in the current month has reached the target usage record, a discount benefit of 1,000 Won may be obtained, and that when payment is performed using card B, for which the usage record in the current month has not yet reached the target usage record, a discount benefit 800 Won may be obtained. Here, when an optimal card is recommended by assigning a weight to the usage record in the current month for card B, card B may be recommended as an optimal card even if the discount amount of card B is lower than that of card A by 200 Won.

Furthermore, in the third section, a card for which the usage record in the current month is expected to reach the target usage record during the period remaining until the opening date of the next card usage period may be recommended as an optimal card, among cards for which usage records in the current month have not yet reached the target usage records, in consideration of the usage record in the current month. For example, it may be assumed that when payment is performed using card C, for which 100,000 Won remains in order for the usage record in the current month to reach the target usage record, a discount benefit of 500 Won may be obtained, and when payment is performed using card D, for which 10,000 Won remains in order for the usage record in the current month to reach the target usage record, a discount benefit of 300 Won is obtained. Here, assuming that the same period of three days remains until the opening dates of the card usage periods of card C and card D, card D, which is expected to reach the target usage record in the remaining three days based on the payment pattern of the user, may be recommended as the optimal card even if a 200-Won discount is not immediately obtained.

Here, when the payment section is the first section, and there are cards having the same benefits, among multiple cards, an optimal card may be recommended in the sequence of usage records in the current month from lowest to highest usage records. When the payment section is the second section, and there are cards having the same benefits, among the multiple cards, an optimal card may be recommended in the sequence of usage records in the current month from closest to farthest from target usage records for respective cards. That is, when there are cards for which recommendation criteria for respective sections are identical to each other, the usage record in the current month may be accumulated by prompting the user to primarily use a card having a low usage record in the current month in the first section. Further, a card for which the usage record has not yet reached the target usage record, but is expected to reach the target usage record because the usage record in the current month is high, may be recommended in the second section.

In this case, it is possible to determine which one of the multiple sections corresponds to the payment section, select one or more group-based optimal cards from each of one or more card groups, and recommend an optimal card, among the one or more group-based optimal cards, in consideration of at least one of the benefits and the usage record in the current month.

For example, it may be assumed that cards A, B, and C are included in the first card group, the opening date of the card usage period of which is the first day of each month, and that cards D and E are included in the second card group, the opening date of the card usage period of which is the 11th of each month. Here, it may also be assumed that, for the first card group, the first section may range from the first to the 10th of the month, the second section may range from the 11th to the 20th, and the third section may range from the 21st to the last day, and for the second card group, the first section may range from the 11th to the 20th, the second section may range from the 21st to the last day, the third section may range from the first to the 10th, and a payment due date is the 12th. At this time, in the first card group, the payment due date may fall within the second section, and in the second card group, the payment due date may fall within the first section. Therefore, in the first card group, one of cards A, B, and C may be selected based on the recommendation algorithm applied to the second section, and in the second card group, one of cards D and E may be selected based on the recommendation algorithm applied to the first section.

Assuming that card A is selected from the first card group and that card D is selected from the second card group, one of the selected cards may be recommended as an optimal card in consideration of at least one of the benefits of cards A and D and the usage records in the current month for cards A and D.

Here, among one or more payment cards included in the multiple cards, an optimal payment card may be recommended.

In an embodiment, since discount or accumulation rates may differ from each other depending on whether the payment card is a credit card, a cash card or a debit card, the discount rates and accumulation rates for respective types of payment cards may be checked, and the card having the maximum benefits may be recommended as the optimal payment card when the payment section of the corresponding card is a section in which benefits are considered depending on the payment sections of respective payment cards.

In another embodiment, discount rates or accumulation rates for respective card companies and banks corresponding to credit cards or debit cards may differ. Thus, the discount rates and accumulation rates for respective card companies and banks may be checked so as to recommend an optimal card.

In a further embodiment, since the benefits of respective credit cards or debit cards may be provided differently depending on the card usage record in the previous month, an optimal card may be recommended by additionally considering whether the card usage record in a previous month has been achieved.

Further, among one or more membership cards included in the multiple cards, an optimal membership card may be recommended together with the optimal payment card.

For example, when an optimal payment card is recommended, a membership card, which can be used together with the recommended payment card and can be used at the corresponding store, is recommended together with the payment card, thus allowing the user to be sufficiently provided with the benefits of discounts and accumulation without missing the benefits.

Furthermore, when it is possible to purchase a commodity using points accumulated in a membership card, the corresponding membership card may be included in a card recommendation list for payment and may also be recommended. In addition, when payment using points is possible according to the setting of the user, the recommendation priority of the corresponding membership card is designated to be higher than that of a credit card or a debit card, and then the membership card may be primarily recommended.

Here, information about an optimal payment card and an optimal membership card may be provided together through the application. For example, information about the optimal membership card that matches information about the optimal payment card may be displayed together on a single screen of the application. Alternatively, when the optimal payment card is clicked, optimal membership cards that can be used together with the clicked optimal payment card may be provided in the form of a list in descending order of benefit amount.

Further, although not shown in FIG. 24, in the payment time-based optimal card recommendation method according to the embodiment of the present invention, the optimal card recommendation apparatus transmits and receives information required to recommend an optimal card to and from the terminal of the user over a communication network, such as a typical network, through a separate communication module. In particular, the communication module according to the embodiment of the present invention may receive information required to predict the one or more expected purchase commodities and the expected payment amount from the terminal, and may provide information corresponding to the optimal card to the terminal. Further, information about the opening dates of card usage periods for respective cards registered in the application may be received through the homepages of respective card companies connected to the application server.

Here, information required to predict the one or more expected purchase commodities and the expected payment amount may be received from a separate application server. For example, user information, such as the purchase information, personal information, possessed payment card information, and possessed membership card information of the user, and various types of information, pertaining for example to events, discounts, and marketing information provided by the corresponding store, may be received.

Furthermore, although not shown in FIG. 24, the payment time-based optimal card recommendation method according to the embodiment of the present invention stores various types of information, generated during a procedure for providing the optimal card recommendation service according to the embodiment of the present invention, in a storage module.

Here, the storage module may be implemented independently of the optimal card recommendation apparatus to support a function for the optimal card recommendation service. Here, the storage module may function as separate large-capacity storage, and may include a control function for performing operations.

By means of such an optimal card recommendation method, when the user pays for a commodity at a store using his or her mobile terminal, an automatic payment service may be used using a payment card that is recommended in advance.

Further, a payment card and a membership card that allow the user to obtain the maximum benefits, such as discounts or accumulation, are recommended depending on the commodities expected to be purchased by the user and the amount of the payment expected to be made by the user, thus inducing the user to consume appropriately and helping the user make reasonable purchases.

Furthermore, the number of operations required by the user to pay at the store using the mobile terminal may be minimized, and thus there is an advantage in that the convenience of the user may be maximized when commodities are purchased

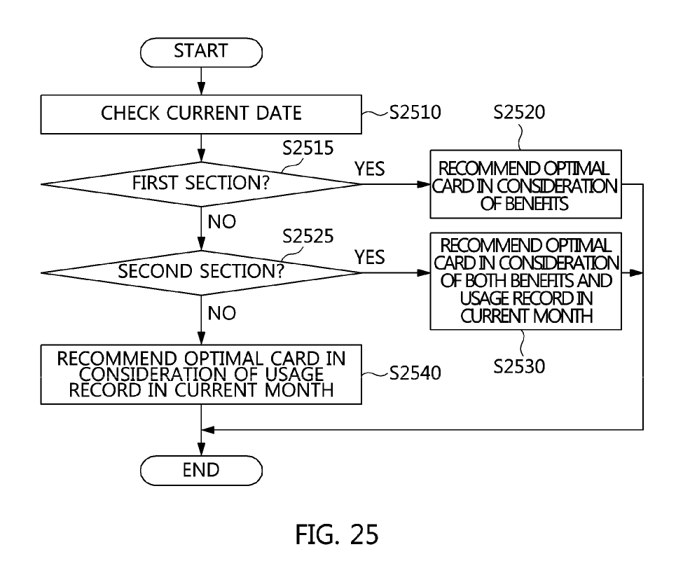

FIG. 25 is a diagram showing in detail a procedure for determining recommendation algorithms depending on payment sections in the payment time-based optimal card recommendation method according to an embodiment of the present invention.

Referring to FIG. 25, the procedure for determining recommendation algorithms depending on payment sections in the payment time-based optimal card recommendation method according to the embodiment of the present invention checks the current date on which the user enters a store at step S2510.

Next, it is determined whether the current date falls within a first section, among the multiple sections corresponding to the usage record determination period, at step S2515.

Here, the usage record determination period may be divided into multiple sections based on the opening dates of card usage periods of the multiple cards registered in the application. For example, assuming that the opening date of the card usage period is the first day of each month, the usage record determination period may be divided into sections such that an interval ranging from the opening date to ⅓ of the usage record determination period is a first section, an interval ranging from the end of the first section to ⅔ of the usage record determination period is a second section, and an interval corresponding to the remaining ⅓ of the usage record determination period is a third section.

Here, since the opening dates of card usage periods of respective cards may be different from each other, the usage record determination periods may be divided into multiple sections in different ways for multiple respective cards.

In this case, separate recommendation algorithms may be applied to respective sections. For example, an algorithm for recommending an optimal card in consideration of benefits may be applied to the first section, an algorithm for recommending an optimal card in consideration of both benefits and the card usage record in the current month may be applied to the second section, and an algorithm for recommending an optimal card in consideration of only the card usage record in the current month may be applied to the third section. Further, when the card usage record is considered, as in the case of the second section or the third section, a card may also be recommended in consideration of the usage record in the future by operating in conjunction with other applications, such as the calendar or housekeeping book of the user terminal.

If it is determined at step S2515 that the current date falls within the first section, an optimal card is recommended in consideration of benefits, together with the expected purchase commodities and the expected payment amount, at step S2520.

If it is determined at step S2515 that the current date does not fall within the first section, it is determined whether the current date falls within a second section, among the multiple sections corresponding to the usage record determination period, at step S2525.

If it is determined at step S2525 that the current date falls within the second section, an optimal card is recommended in consideration of both benefits and the usage record in the current month, together with the expected purchase commodities and the expected payment amount, at step S2530.

If it is determined at step S2525 that the current date does not fall within the second section, it is determined that the current date falls within a third section, among the multiple sections corresponding to the usage record determination period, and an optimal card is recommended in consideration of the usage record in the current month, together with the expected purchase commodities and the expected payment amount, at step S2540.

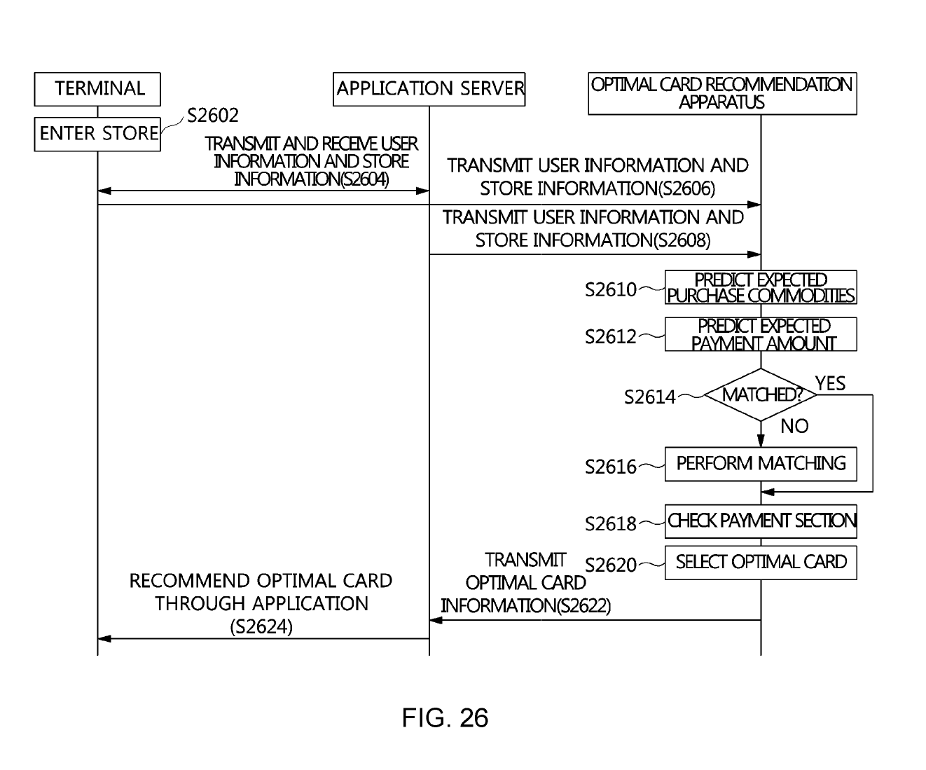

FIG. 26 is a diagram showing a payment time-based optimal card recommendation process according to an embodiment of the present invention.

Referring to FIG. 26, in the payment time-based optimal card recommendation process according to the embodiment of the present invention, the user enters an offline store while holding his or her terminal at step S2602.

Next, an application server checks the terminal of the user based on information received through at least one BLE device, that is, at least one beacon, installed at the store, and transmits and receives user information and store information to and from the terminal of the user at step S2604.

Thereafter, the user information and the store information are transmitted to the optimal card recommendation apparatus through the terminal or the application server at steps S2606 and S2608.

Here, the user information may be private user information related to the personal information, purchase history information, and commodity-of-interest information of the user who has subscribed to the application, and the store information may correspond to information, such as events, discounts and benefits corresponding to an offline store visited by the user.

Thereafter, the optimal card recommendation apparatus obtains at least one of the purchasing pattern of the user in an affiliated store group corresponding to the store, the purchasing pattern of a user group identical to the user in the affiliated store group, benefit information provided by each store, and the utilization of benefits by the user, based on the user information and the store information, and then predicts one or more expected purchase commodities at step S2610.

Next, the optimal card recommendation apparatus obtains information about an expected payment amount in consideration of at least one of the purchasing pattern of the user, information about the amount of the purchase by a single user at the store, and information about the amount of each purchase by the identical user group in the affiliated store group, based on the user information and the store information, and then predicts the expected payment amount at step S2612.

Thereafter, it is determined whether to match the one or more expected purchase commodities with the expected payment amount at step S2614.

Here, the prices of the one or more expected purchase commodities are summed, and thus the total amount is calculated. Whether the difference between the total amount and the expected payment amount is equal to or greater than a preset reference difference is determined. If it is determined that the difference is equal to or greater than the preset reference difference, matching may be performed.

If it is determined at step S2614 that matching is to be performed, matching is performed by excluding a commodity having a low probability of being purchased from the one or more expected purchase commodities, whereas when the total amount is less than the expected payment amount, matching is performed by adjusting the expected payment amount at step S2616.

Thereafter, among multiple sections corresponding to the usage record determination period, the payment section corresponding to the current date is determined at step S2618.

Next, an optimal card required for payment is selected from among the cards of the user registered in the application in consideration of at least one of the recommendation algorithm corresponding to the payment section and the one or more expected purchase commodities and the expected payment amount which have been matched, at step S2620.

In contrast, if it is determined at step S2614 that matching is not to be performed, the payment section is determined at step S2618, and an optimal card is selected in consideration of at least one of the recommendation algorithm corresponding to the payment section, the one or more expected purchase commodities, and the expected payment amount at step S2620.

Thereafter, information about the selected optimal card is delivered to the application server at step S2622, and the application server recommends the optimal card by displaying the optimal card information to the user through the application at step S2624.

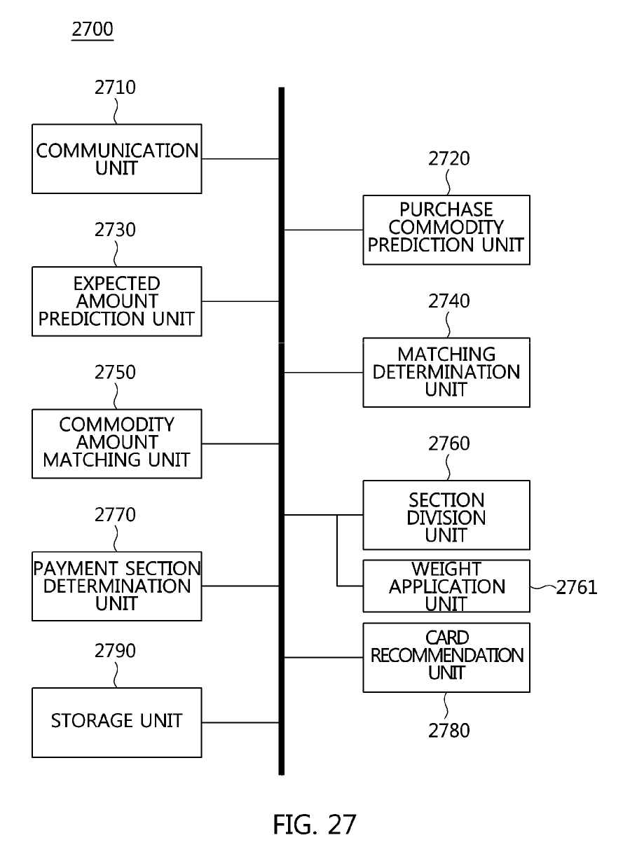

FIG. 27 is a block diagram showing an optimal card recommendation apparatus according to yet another embodiment of the present invention.

Referring to FIG. 27, an optimal card recommendation apparatus 2700 according to yet another embodiment of the present invention includes a communication unit 2710, a purchase commodity prediction unit 2720, an expected amount prediction unit 2730, a matching determination unit 2740, a commodity amount matching unit 2750, a section division unit 2760, a weight application unit 2761, a payment section determination unit 2770, a card recommendation unit 2780, and a storage unit 2790.

The communication unit 2710 functions to transmit and receive information required to recommend an optimal card to and from the terminal of the user over a communication network, such as a typical network. In particular, the communication unit 2710 according to an embodiment may receive pieces of information required to predict one or more expected purchase commodities and an expected payment amount from the terminal, and may provide information corresponding to the optimal card to the terminal. Further, information about the opening dates of card usage periods for respective cards registered in the application may be received through the homepages of respective card companies connected to the application server.

Here, information required to predict the one or more expected purchase commodities and the expected payment amount may be received from a separate application server. For example, user information, such as the purchase information, personal information, possessed payment card information, and possessed membership card information of the user, and various types of information, pertaining for example to events, discounts, and marketing information provided by the corresponding store, may be received.

The purchase commodity prediction unit 2720 predicts one or more purchase commodities that are expected to be purchased by the user at a store. That is, conventional card recommendation technology is configured to recommend an optimal payment card and an optimal membership card in consideration of information about the type and price of the corresponding commodity to be purchased by the user in the state in which the commodity to be purchased by the user has been fixed. Thus, the conventional card recommendation technology merely enables a card to be recommended only when the user enters information about the commodity to be purchased through the application, or only when commodity information is provided through the POS device at the store. However, such card recommendation technology cannot provide a particular advantage except for convenience in that information about the card to be used for payment is provided when the user purchases a commodity through the POS device.

In contrast, the present invention predicts in advance commodities expected to be purchased by the user and recommends a card in the state in which the commodity to be purchased by the user at the store is not yet fixed, thus providing assistance in further simplifying and facilitating the procedure in which the user actually performs payment through the POS device.

Here, one or more commodities expected to be purchased may be predicted in consideration of at least one of the purchasing pattern of the user in an affiliated store group corresponding to the store, the purchasing pattern of a user group identical to the user in the affiliated store group, benefit information provided by each store, and the utilization of benefits by the user.

In an embodiment, the purchasing patterns of the user for respective affiliated store groups may be generated using information, such as the types of commodities purchased by the user in each affiliated store group, which sells household items, the time of the purchase, or the price range of purchased commodities.

In another embodiment, based on the age, gender, occupation, and preference information of the user, a user group may be generated based on other users corresponding to information similar to the above information, and the purchasing pattern of the corresponding user group may be generated and may be used to predict commodities that are expected to be purchased.

In a further embodiment, information about the store visited by the user may be obtained, and benefit information currently provided by the store, that is, information about discounted commodities, commodities corresponding to a Buy-One-Get-One-Free (BOGOF) offer, or commodities available for a limited time, may be obtained and used to predict the commodities that are expected to be purchased.

In yet another embodiment, commodities expected to be purchased may be predicted in consideration of how the user has utilized benefits obtained from the purchase of commodities. That is, benefit information preferred by the user between discounts and accumulation may be considered, or a usage pattern for accumulated points may be considered when the commodities expected to be purchased are predicted.

Here, unnecessary commodity items may be detected in consideration of at least one of information about the commodity most recently purchased by the user in the affiliated store group and the time of the purchase, and may be excluded when one or more commodities expected to be purchased are predicted.

For example, when there is a commodity purchased by the user in an affiliated store group identical to a specific store before the user visits the specific store, there is a low probability that the user will purchase the corresponding commodity at the current store. Therefore, when the commodity expected to be purchased at the current store is predicted, the commodity previously purchased in the same affiliated store group may be recognized as an unnecessary commodity item, and may be excluded from the commodities expected to be purchased.

In still another embodiment, when there is a commodity purchased by the user in an affiliated store group identical to a specific store before the user visits the specific store, the commodity may instead be predicted to be the commodity expected to be purchased in consideration of the time at which the corresponding commodity was purchased and whether the commodity is discounted or not. That is, assuming that hair gel is on sale at a discount price at a hair product shop visited by the user, and the user purchased the hair gel one month ago, there may be a high probability that the user will purchase the hair gel owing to the benefits of the discount price at this visit.

The expected amount prediction unit 2730 predicts the amount of the payment that is expected to be made by the user at the store.

Here, the reason for additionally predicting an expected payment amount as well as an expected purchase commodity so as to recommend an optimal card is that there may be benefits that are provided when a predetermined amount or more is paid at each store. Therefore, the amount required to purchase a commodity, that is, the payment amount, may be a very important factor in recommending a card. For example, assuming that a discount benefit is provided when commodities corresponding to more than 100,000 Won are purchased with a specific payment card at a store visited by the user, a payment amount for purchase commodities, which are expected to be purchased by the user at the corresponding store, is predicted to reach an amount of 100,000 Won, thus allowing the user to obtain more benefits.

Here, the expected payment amount may be predicted in consideration of at least one of the purchasing pattern of the user, information about the amount of the purchase by a single user at the store, and information about the amount of each purchase by a user group identical to the user in an affiliated store group.

In an embodiment, when the purchasing pattern of the user, which was considered when the expected purchase commodity was predicted, is used, information about the prices of commodities to be purchased by the user may be acquired, and thus the expected payment amount may be predicted in consideration of the purchasing pattern of the user.

In another embodiment, an expected payment amount may be predicted using information about the average purchase amount by a single user at the store visited by the user.

In a further embodiment, whether the store visited by the user is a jewelry shop which sells relatively expensive goods, or a grocery shop which sells relatively cheap goods, is determined, and information about the amount of each purchase in the corresponding affiliated store group may be considered. Further, whether a user is a student, a housewife, or an office worker is determined, and thus information about the amount of each purchase by a user group identical to the user may be considered. That is, in the cases where the user is a student and where the user is an office worker, there may be a great difference in consumption tendencies, and thus an expected payment amount may be predicted in consideration of the purchase amount information based on the user group.

The matching determination unit 2740 determines whether to match the one or more expected purchase commodities with the expected payment amount by comparing the total amount of one or more expected purchase commodities with the expected payment amount. For example, assuming that the expected payment amount is predicted to be excessively high compared to the number of the one or more expected purchase commodities, there is the possibility that the reliability of the recommended card may be deteriorated because the tendencies of two conditions that are considered when recommending an optimal card are different from each other. Therefore, it is possible to compare the total amount obtained by summing the prices of one or more expected purchase commodities with the expected payment amount, and to determine to match the expected purchase commodities with the expected payment amount if it is determined that a difference is present between the total amount and the expected payment amount. Then, an algorithm for performing matching may be executed.

Further, if it is determined that the total amount is relatively similar to the expected payment amount when comparing the total amount with the expected payment amount, matching is not performed, and the expected payment amount may be used as a reference value that is considered when recommending an optimal card.

At this time, when the difference between the total amount and the expected payment amount is equal to or greater than a preset reference difference, it may be determined that matching is to be performed. For example, when the preset reference difference is 30,000 Won, matching may be performed when the difference between the total amount and the expected payment amount is 30,000 Won or more.

Here, the preset reference difference may be set to different values depending on affiliated store groups. For example, the reference difference in an affiliated store group that sells expensive commodities is set to a value larger than that of the reference difference in an affiliated store group that sells relatively inexpensive commodities, thus preventing unnecessary matching from being performed. Further, the reference difference in an affiliated store group that sells inexpensive commodities is set to a smaller value, thus improving the accuracy of the algorithm for recommending an optimal card.

The commodity amount matching unit 2750 is configured to, when performing matching between the one or more expected purchase commodities and the expected payment amount, adjust any one of the expected payment amount and the one or more expected purchase commodities, and then match the one or more expected purchase commodities with the expected payment amount. That is, in order to reduce the difference between the total amount of the one or more expected purchase commodities and the expected payment amount, any one of the total amount and the expected payment amount may be adjusted.

Here, when the total amount is greater than the expected payment amount, a commodity having a low probability of being purchased is first excluded from the one or more expected purchase commodities, and thus the total amount may be adjusted to match the expected payment amount. For example, it may be assumed that there are 10 expected purchase commodities, that the total amount is greater than the expected payment amount, and that the difference between the total amount and the expected payment amount is greater than a preset reference difference by 50,000 Won. In this case, it is determined that an unnecessary commodity is further included in the expected purchase commodities, the probabilities of being purchased are determined for 10 respective expected purchase commodities, and the commodity having the lowest probability of being purchased may be excluded first.

Further, when the total amount is less than the expected payment amount, the expected payment amount is adjusted to match the total amount, and thus the one or more expected purchase commodities may match the expected payment amount. For example, it may be assumed that there are five expected purchase commodities, that the total amount is less than the expected payment amount, and that the difference between the total amount and the expected payment amount is greater than a preset reference difference by 50,000 Won. In this case, it is preferable to recommend a card using a method for adjusting the expected payment amount to match the total amount, rather than using a method for adding a commodity having a low probability of being purchased to the expected purchase commodities for the additional purchase of the commodity. That is, since the probability that the user will purchase an unnecessary commodity is low, the accuracy of the algorithm for recommending a card may be improved by decreasing the expected payment amount.

The section division unit 2760 checks the opening dates of card usage periods of multiple cards registered in the application, and divides each of the usage record determination periods corresponding to one month from the card usage period opening dates into a plurality of sections. For example, assuming that the opening date of the card usage period is the first day of each month, the usage record determination period may be divided into sections such that an interval ranging from the opening date to ⅓ of the usage record determination period is a first section, an interval ranging from the end of the first section to ⅔ of the usage record determination period is a second section, and an interval corresponding to the remaining ⅓ of the usage record determination period is a third section.

Here, since the opening dates of card usage periods of respective cards may be different from each other, the usage record determination periods may be divided into multiple sections in different ways for multiple respective cards.

Here, the multiple sections may be variously set and divided depending on an optimal card recommendation system.

The weight application unit 2761 applies a first weight to any one of discount rates and accumulation rates corresponding to multiple cards in the first section, among multiple sections, applies a second weight to any one of discount rates and accumulation rates in the second section, among the multiple sections, and applies a third weight to any one of discount rates and accumulation rates in the third section, among the multiple sections.

In this case, the weights may be applied such that discount rates are greater than accumulation rates. Generally, it may be determined that a benefit corresponding to an amount that is immediately discounted when a commodity is purchased is higher than a benefit corresponding to accumulated points or amounts. Further, in the case of discounts, there are many cases where an actual cash discount is made, but in the case of points, in most cases points that may be used only in a specific store are accumulated. Further, the accumulated points may be used only when they reach a specific number of points. Therefore, from the standpoint of benefits, it may be determined that discounts provide more benefits than those of accumulation. Further, a higher weight may be applied to discount rates such that, when a discount amount is identical to an accumulated amount, a card for providing a discount is recommended.

For example, the first weight may be applied to the first section so that the ratio of the discount rate to the accumulation rate is 1.5:1 so as to recommend the card having the maximum discount benefits. The second weight may be applied to the second section so that the ratio of the discount rate to the accumulation rate is 1.4:1 so as to recommend the card having more discount benefits while also considering the usage record in the current month. The third weight may be applied to the third section so that the ratio of the discount rate to the accumulation rate is 1.2:1 so as to prevent the difference between the discount benefits and the accumulation benefits from being large because an object to cause the usage record in the current month to reach the target usage record may be primarily considered.

In this case, separate recommendation algorithms may be applied to respective sections. For example, an algorithm for recommending an optimal card in consideration of benefits may be applied to the first section, an algorithm for recommending an optimal card in consideration of both benefits and the card usage record in the current month may be applied to the second section, and an algorithm for recommending an optimal card in consideration of only the card usage record in the current month may be applied to the third section. Further, when the card usage record is considered, as in the case of the second section or the third section, a card may also be recommended in consideration of the usage record in the future by operating in conjunction with other applications, such as the calendar or housekeeping book of the user terminal.

Further, recommendation factors, such as discounts or accumulation, the achievement rate of a target usage record in the current month, or the non-achievement rate of the target usage record in the current month, are designated, and weights for respective recommendation factors may be set differently depending on the type of card. For example, the weights for discounts and accumulation of card A may set to values greater than those of card B.

Here, cards having the same card usage period opening date, among the multiple cards, may be grouped, and then one or more card groups may be generated. For example, it may be assumed that five credit cards corresponding to A to E are registered in the application and that the opening dates of card usage periods of cards A to C are the first day of each month, but the opening dates of card usage periods of cards D and E are the 11th of each month. Here, cards A, B, and C may be grouped to generate a first card group, and cards D and E may be grouped to generate a second card group.

In this case, the usage record determination period corresponding to each of the one or more card groups may be divided into multiple group-based sections. That is, in the above example, since the opening date of the card usage period for the first card group is the first day of each month, the usage record determination period may be divided into multiple sections such that an interval ranging from the first to the 10th of the month is a first section, an interval ranging from the 11th to the 20th is a second section, and an interval ranging from the 21st to the last day is a third section. Further, since the opening date of the card usage period for the second card group is the 11th of each month, the usage record determination period may be divided into multiple sections such that an interval ranging from the 11th to the 20th of the month is a first section, an interval ranging from the 21st to the last day is a second section, and an interval ranging from the first to the 10th is a third section.

The payment section determination unit 2770 determines a payment section corresponding to the current date, among the multiple sections corresponding to the usage record determination period. That is, among the multiple sections, the section in which the current date, on which the user enters the store, falls may be determined.

The card recommendation unit 2780 recommends an optimal card, among multiple cards registered in the application, in consideration of at least one of a recommendation algorithm to which the weight corresponding to the payment section is applied, the one or more expected purchase commodities, and the expected payment amount.

Here, weights for recommendation are respectively assigned to the recommendation algorithm corresponding to the payment section, the one or more expected purchase commodities, and the expected payment amount, and a card obtained as a result of applying individual weights may be recommended as an optimal card.

Here, the multiple cards may include payment cards such as a cash card, a debit card, and a credit card for payment. Further, the multiple cards may include a membership card, a cash-back card, and a discount card, which enable points to be accumulated or discounts to be provided when commodities are purchased.

Here, the application may include a mobile payment application, a mobile electronic wallet application, etc., which register the card information of the user and allow the terminal to perform payment using the card information.

Here, when the payment section is the first section among the multiple sections, an optimal card may be recommended among the multiple cards in consideration of benefits including discount rates and accumulation rates. When the payment section is the second section among the multiple sections, an optimal card may be recommended among the multiple cards in consideration of both benefits and the usage record in the current month. When the payment section is the third section among the multiple sections, an optimal card may be recommended among the multiple cards in consideration of the usage record in the current month.

At this time, the first section may be a section corresponding to a first part of the usage record determination period, the second section may be a section corresponding to the middle part of the usage record determination period, and the third section may be a section corresponding to the last part of the usage record determination period.

Therefore, the first section is not yet a time during which a usage record in the current month is to be considered, and thus a card is preferably recommended so that benefits, such as accumulation or discounts, are maximally given. For example, in the first section, a card having high discount benefits may be recommended by setting the weight applied to the discount rates to a value much greater than the weight applied to the accumulation rates.

Further, in the second section, the card that provides more benefits may be recommended as the optimal card, among cards for which the usage record in the current month has not yet reached a target usage record, in consideration of the usage record in the current month, together with benefits. That is, in the second section, multiple cards are divided into cards having the possibility that the usage record in the current month will reach a target usage record and cards having no such possibility. Among the cards having the possibility that the usage record in the current month will reach the target usage record, the card to which accumulation rather than discounts is applied may be preferably recommended as the optimal card.

For example, it may be assumed that when payment is performed using card A, for which the usage record in the current month has reached the target usage record, a discount benefit of 1,000 Won may be obtained, and when payment is performed using card B, for which the usage record in the current month has not yet reached the target usage record, a discount benefit of 800 Won may be obtained, and that when payment is performed using card C, for which the usage record in the current month has not yet reached the target usage record, an accumulation benefit of 1,000 Won may be obtained. In this case, if both cards B and C have the possibility of reaching the target usage records and the payment section is the second section, card C may be recommended as the optimal card, rather than card A, for which the usage record has reached the target usage record, or card B, which provides discount benefits.

Further, in the third section, the card for which the usage record in the current month is expected to reach the target usage record during the period remaining until the opening date of the next card usage period may be recommended as the optimal card, among cards for which the usage records in the current month have not yet reached the target usage records, in consideration of the usage record in the current month. Furthermore, the third section is the section corresponding to the last period for the calculation of the usage record, and may be a section in which it is more important to obtain benefits for the next month by achieving the usage records of cards that have a possibility of reaching the target usage record, among the cards for which usage records in the current month have not yet reached the target usage records, than to obtain instant discount benefits. Therefore, in the situation in which the usage record of a specific card fails to achieve the target usage record by 200 Won, even the card to which accumulation rather than discounts is applied may be primarily recommended as an optimal card.

For example, it may be assumed that when payment is performed using card C, for which 100,000 Won remains in order for the usage record in the current month to reach the target usage record, a discount benefit of 1,000 Won may be obtained, and when payment is performed using card D, for which 5,000 Won remains in order for the usage record in the current month to reach the target usage record, a discount benefit of 300 Won may be obtained. Here, assuming that the same period of three days remains until the opening dates of the card usage periods of cards C and D, card D, which is expected to reach the target usage record in the remaining three days based on the payment pattern of the user, may be recommended as an optimal card even if a 1,000-Won discount is not immediately obtained.

Here, when the payment section is the first section, and there are cards having the same benefits including discount rates and accumulation rates, among multiple cards, an optimal card may be recommended in the sequence of usage records in the current month from lowest to highest usage records. When the payment section is the second section, and there are cards having the same benefits, among the multiple cards, an optimal card may be recommended in the sequence of usage records in the current month from closest to farthest from target usage records for respective cards. That is, when there are cards for which recommendation criteria for respective sections are identical to each other, the usage record in the current month may be accumulated by prompting the user to primarily use a card having a low usage record in the current month in the first section. Further, a card for which the usage record has not yet reached the target usage record, but is expected to reach the target usage record because the usage record in the current month is high, may be recommended in the second section.

In this case, it is possible to determine which one of the multiple sections corresponds to the payment section, select one or more group-based optimal cards from each of one or more card groups, and recommend an optimal card, among the one or more group-based optimal cards, in consideration of at least one of the benefits and the usage record in the current month.

For example, it may be assumed that cards A, B, and C are included in the first card group, the opening date of the card usage period of which is the first day of each month, and that cards D and E are included in the second card group, the opening date of the card usage period of which is the 11th of each month. Here, it may also be assumed that, for the first card group, the first section may range from the first to the 10th of the month, the second section may range from the 11th to the 20th, and the third section may range from the 21st to the last day, and for the second card group, the first section may range from the 11th to the 20th, the second section may range from the 21st to the last day, the third section may range from the first to the 10th, and a payment due date is the 12th. At this time, in the first card group, the payment due date may fall within the second section, and in the second card group, the payment due date may fall within the first section. Therefore, in the first card group, one of cards A, B, and C may be selected based on the recommendation algorithm applied to the second section, and in the second card group, one of cards D and E may be selected based on the recommendation algorithm applied to the first section.

Assuming that card A is selected from the first card group and that card D is selected from the second card group, one of the selected cards may be recommended as an optimal card in consideration of at least one of the benefits of cards A and D and the usage records in the current month for cards A and D.

Here, among one or more payment cards included in the multiple cards, an optimal payment card may be recommended.

In an embodiment, since discount or accumulation rates may differ from each other depending on whether the payment card is a credit card, a cash card or a debit card, the discount rates and accumulation rates for respective types of payment cards may be checked, and the card having the maximum benefits may be recommended as the optimal payment card when the payment section of the corresponding card is a section in which benefits are considered depending on the payment sections of respective payment cards.

In another embodiment, since the benefits of respective credit cards or debit cards may be provided differently depending on the card usage record in the previous month, an optimal card may be recommended by additionally considering whether the card usage record in a previous month has been achieved.

Further, among one or more membership cards included in the multiple cards, an optimal membership card may be recommended together with the optimal payment card.

For example, when an optimal payment card is recommended, a membership card, which can be used together with the recommended payment card and can be used at the corresponding store, is recommended together with the payment card, thus allowing the user to be sufficiently provided with the benefits of discounts and accumulation without missing the benefits.

Furthermore, when it is possible to purchase a commodity using points accumulated in a membership card, the corresponding membership card may be included in a card recommendation list for payment and may also be recommended. In addition, when payment using points is possible according to the setting of the user, the recommendation priority of the corresponding membership card is designated to be higher than that of a credit card or a debit card, and then the membership card may be primarily recommended.

Here, information about an optimal payment card and an optimal membership card may be provided together through the application. For example, information about the optimal membership card that matches information about the optimal payment card may be displayed together on a single screen of the application. Alternatively, when the optimal payment card is clicked, optimal membership cards that can be used together with the clicked optimal payment card may be provided in the form of a list in descending order of benefit amount.

As described above, the storage unit 2790 stores various types of information generated during a procedure for providing the optimal card recommendation service according to an embodiment of the present invention.

In an embodiment, the storage unit 2790 may be implemented independently of the optimal card recommendation apparatus 2700 and may then support a function for the optimal card recommendation service. Here, the storage unit 2790 may function as separate large-capacity storage and may include a control function for performing operations.

Meanwhile, the optimal card recommendation apparatus 2700 is equipped with memory and may store information in the apparatus. In an exemplary embodiment, the memory is a computer-readable medium. In an exemplary embodiment, the memory may be a volatile memory unit, and in another exemplary embodiment, the memory may be a nonvolatile memory unit. In an embodiment, the storage may be a computer-readable medium. In various different embodiments, the storage may include, for example, a hard disk device, an optical disk device or other types of large-capacity storage device.

Such an optimal card recommendation apparatus 2700 is used, and thus the user may use an automatic payment service with a previously recommended payment card when paying for a commodity at a store using his or her mobile terminal.

Further, a payment card and a membership card which allow the user to obtain the maximum benefits, such as discounts or accumulation, are recommended depending on the commodity expected to be purchased by the user and the expected payment amount, thus inducing the user to consume appropriately and helping the user make a reasonable purchase.

Furthermore, an operation required by the user to pay at a store using a mobile terminal may be minimized, and thus there is an advantage in that the user's convenience may be maximized when commodities are purchased.

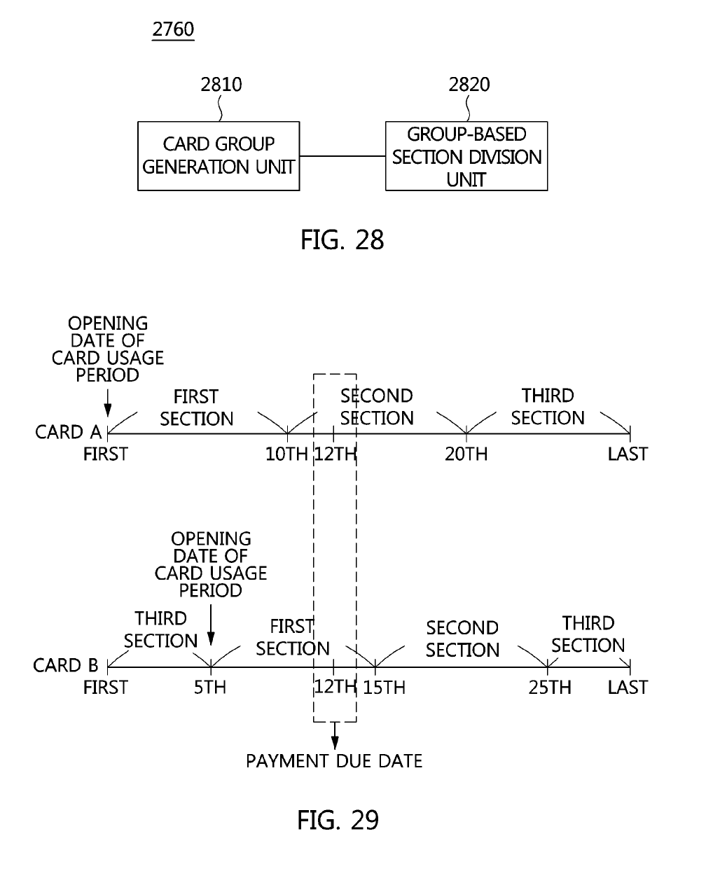

FIG. 28 is a block diagram showing in detail the section division unit shown in FIG. 27.

Referring to FIG. 28, the section division unit 2760 shown in FIG. 27 includes a card group generation unit 2810 and a group-based section division unit 2820.

The card group generation unit 2810 may generate one or more card groups by grouping cards having the same card usage period opening date, among multiple cards.

For example, it may be assumed that five credit cards corresponding to A to E are registered in the application and that the opening dates of card usage periods of cards A to C are the first day of each month, but the opening dates of card usage periods of cards D and E are the 11th of each month. Here, cards A, B, and C may be grouped to generate a first card group, and cards D and E may be grouped to generate a second card group.

The group-based section division unit 2820 may divide a usage record determination period corresponding to each of the one or more card groups into multiple group-based sections.

That is, in the above example, since the opening date of the card usage period for the first card group is the first day of each month, the usage record determination period may be divided into multiple sections such that an interval ranging from the first to the 10th of the month is a first section, an interval ranging from the 11th to the 20th is a second section, and an interval ranging from the 21st to the last day is a third section. Further, since the opening date of the card usage period for the second card group is the 11th of each month, the usage record determination period may be divided into multiple sections such that an interval ranging from the 11th to the 20th of the month is a first section, an interval ranging from the 21st to the last day is a second section, and an interval ranging from the first to the 10th is a third section.

FIG. 29 is a diagram showing sections obtained by dividing a usage record determination period according to an embodiment of the present invention.

Referring to FIG. 29, the usage record determination period according to the embodiment of the present invention may be determined differently depending on the opening dates of card usage periods of respective cards.

For example, with reference to the usage record determination periods of card A and card B, shown in FIG. 29, the opening date of the card usage period of card A is the first day of each month, and thus a period ranging from the first to the last day of the month may correspond to the usage record determination period. However, the opening date of the card usage period of card B is the fifth of each month, and thus a period ranging from the fifth of this month to the fourth of the next month may correspond to the usage record determination period.

In this way, since usage record determination periods differ from each other depending on the opening dates of card usage periods, cards having different card usage period opening dates may be configured so as to divide their usage record determination periods into different sections.

That is, in the case of card A, the usage record determination period may be divided into sections such that an interval ranging from the first of the month, which is the opening date of the card usage period, to the 10th is the first section, an interval ranging from the 11th to the 20th of the month is the second section, and an interval ranging from the 21st to the last of the month is the third section. In contrast, even if the usage record determination period of card B is divided in the same way as card A, it may be divided into sections such that an interval ranging from the fifth of the month, which is the opening date of the card usage period, to the 15th is the first section, an interval ranging from the 16th to the 25th is the second section, and an interval ranging from the 26th of the month to the fourth of the next month is the third section.

Therefore, assuming that the date on which the user enters a store is the 12th, the date may correspond to the second section of card A, but the date may correspond to the first section of card B. Accordingly, when the recommendation algorithms depending on the payment sections are applied, recommendation priority may be assigned to card A based on the recommendation algorithm to which the weight corresponding to the second section is applied, and recommendation priority may be assigned to card B based on the recommendation algorithm to which the weight corresponding to the first section is applied.

For example, it may be assumed that an algorithm for recommending an optimal card in consideration of benefits, to which weights corresponding to the ratio of 1.5:1 between a discount rate and an accumulation rate are applied, is used in the first section of payment sections for respective cards, an algorithm for recommending an optimal card in consideration of both benefits, to which weights corresponding to the ratio of 1.4:1 between a discount rate and an accumulation rate are applied, and a usage record in the current month is used in the second section, and an algorithm for recommending an optimal card in consideration of a usage record in the current month is used in the third section. Here, since the payment due date of card A corresponds to the second section, it is determined whether card A is the target to be recommended in consideration of both benefits and the usage record in the current month. Since the payment due date of card B corresponds to the first section, it may be determined whether card B is the target to be recommended in consideration of only benefits.

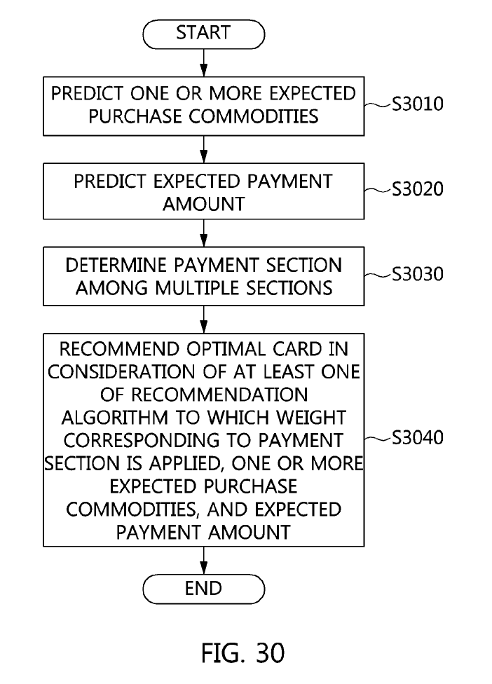

FIG. 30 is an operation flowchart showing an optimal card recommendation method based on weights depending on payment times according to an embodiment of the present invention.

Referring to FIG. 30, the optimal card recommendation method based on weights depending on payment times according to the embodiment of the present invention is an optimal card recommendation method performed by the optimal card recommendation apparatus based on weights depending on payment times according to the embodiment of the present invention. First, the optimal card recommendation method predicts one or more purchase commodities that are expected to be purchased by the user at a store at step S3010. That is, conventional card recommendation technology is configured to recommend an optimal payment card and an optimal membership card in consideration of information about the type and price of the corresponding commodity to be purchased by the user in the state in which the commodity to be purchased by the user has been fixed. Thus, the conventional card recommendation technology merely enables a card to be recommended only when the user enters information about the commodity to be purchased through the application, or only when commodity information is provided through the POS device at the store. However, such card recommendation technology cannot provide a particular advantage except for convenience in that information about the card to be used for payment is provided when the user purchases a commodity through the POS device.

In contrast, the present invention predicts in advance commodities expected to be purchased by the user and recommends a card in the state in which the commodity to be purchased by the user at the store is not yet fixed, thus providing assistance in further simplifying and facilitating the procedure in which the user actually performs payment through the POS device.

Here, one or more commodities expected to be purchased may be predicted in consideration of at least one of the purchasing pattern of the user in an affiliated store group corresponding to the store, the purchasing pattern of a user group identical to the user in the affiliated store group, benefit information provided by each store, and the utilization of benefits by the user.

In an embodiment, the purchasing patterns of the user for respective affiliated store groups may be generated using information, such as the types of commodities purchased by the user in each affiliated store group, which sells household items, the time of the purchase, or the price range of purchased commodities.

In another embodiment, based on the age, gender, occupation, and preference information of the user, a user group may be generated based on other users corresponding to information similar to the above information, and the purchasing pattern of the corresponding user group may be generated and may be used to predict commodities that are expected to be purchased.

In a further embodiment, information about the store visited by the user may be obtained, and benefit information currently provided by the store, that is, information about discounted commodities, commodities corresponding to a Buy-One-Get-One-Free (BOGOF) offer, or commodities available for a limited time, may be obtained and used to predict the commodities that are expected to be purchased.

In yet another embodiment, commodities expected to be purchased may be predicted in consideration of how the user has utilized benefits obtained from the purchase of commodities. That is, benefit information preferred by the user between discounts and accumulation may be considered, or a usage pattern for accumulated points may be considered when the commodities expected to be purchased are predicted.

Here, unnecessary commodity items may be detected in consideration of at least one of information about the commodity most recently purchased by the user in the affiliated store group and the time of the purchase, and may be excluded when one or more commodities expected to be purchased are predicted.

For example, when there is a commodity purchased by the user in an affiliated store group identical to a specific store before the user visits the specific store, there is a low probability that the user will purchase the corresponding commodity at the current store. Therefore, when the commodity expected to be purchased at the current store is predicted, the commodity previously purchased in the same affiliated store group may be recognized as an unnecessary commodity item, and may be excluded from the commodities expected to be purchased.

In still another embodiment, when there is a commodity purchased by the user in an affiliated store group identical to a specific store before the user visits the specific store, the commodity may instead be predicted to be the commodity expected to be purchased in consideration of the time at which the corresponding commodity was purchased and whether the commodity is discounted or not. That is, assuming that hair gel is on sale at a discount price at a hair product shop visited by the user, and the user purchased the hair gel one month ago, there may be a high probability that the user will purchase the hair gel owing to the benefits of the discount price at this visit.

Further, the optimal card recommendation method based on weights depending on payment times according to the embodiment of the present invention predicts the amount of the payment that is expected to be made by the user at the store at step S3020.

Here, the reason for additionally predicting an expected payment amount as well as an expected purchase commodity so as to recommend an optimal card is that there may be benefits that are provided when a predetermined amount or more is paid at each store. Therefore, the amount required to purchase a commodity, that is, the payment amount, may be a very important factor in recommending a card. For example, assuming that a discount benefit is provided when commodities corresponding to more than 100,000 Won are purchased with a specific payment card at a store visited by the user, a payment amount for purchase commodities, which are expected to be purchased by the user at the corresponding store, is predicted to reach an amount of 100,000 Won, thus allowing the user to obtain more benefits.

Here, the expected payment amount may be predicted in consideration of at least one of the purchasing pattern of the user, information about the amount of the purchase by a single user at the store, and information about the amount of each purchase by a user group identical to the user in an affiliated store group.

In an embodiment, when the purchasing pattern of the user, which was considered when the expected purchase commodity was predicted, is used, information about the prices of commodities to be purchased by the user may be acquired, and thus the expected payment amount may be predicted in consideration of the purchasing pattern of the user.

In another embodiment, an expected payment amount may be predicted using information about the average purchase amount by a single user at the store visited by the user.

In a further embodiment, whether the store visited by the user is a jewelry shop which sells relatively expensive goods, or a grocery shop which sells relatively cheap goods, is determined, and information about the amount of each purchase in the corresponding affiliated store group may be considered. Further, whether a user is a student, a housewife, or an office worker is determined, and thus information about the amount of each purchase by a user group identical to the user may be considered. That is, in the cases where the user is a student and where the user is an office worker, there may be a great difference in consumption tendencies, and thus an expected payment amount may be predicted in consideration of the purchase amount information based on the user group.

Further, although not shown in FIG. 30, the optimal card recommendation method based on weights depending on payment times according to the embodiment of the present invention determines whether to match the one or more expected purchase commodities with the expected payment amount by comparing the total amount of one or more expected purchase commodities with the expected payment amount. For example, assuming that the expected payment amount is predicted to be excessively high compared to the number of the one or more expected purchase commodities, there is the possibility that the reliability of the recommended card may be deteriorated because the tendencies of two conditions that are considered when recommending an optimal card are different from each other. Therefore, it is possible to compare the total amount obtained by summing the prices of one or more expected purchase commodities with the expected payment amount, and to determine to match the expected purchase commodities with the expected payment amount if it is determined that a difference is present between the total amount and the expected payment amount. Then, an algorithm for performing matching may be executed.

Further, if it is determined that the total amount is relatively similar to the expected payment amount when comparing the total amount with the expected payment amount, matching is not performed, and the expected payment amount may be used as a reference value that is considered when recommending an optimal card.

At this time, when the difference between the total amount and the expected payment amount is equal to or greater than a preset reference difference, it may be determined that matching is to be performed. For example, when the preset reference difference is 30,000 Won, matching may be performed when the difference between the total amount and the expected payment amount is 30,000 Won or more.

Here, the preset reference difference may be set to different values depending on affiliated store groups. For example, the reference difference in an affiliated store group that sells expensive commodities is set to a value larger than that of the reference difference in an affiliated store group that sells relatively inexpensive commodities, thus preventing unnecessary matching from being performed. Further, the reference difference in an affiliated store group that sells inexpensive commodities is set to a smaller value, thus improving the accuracy of the algorithm for recommending an optimal card.

Furthermore, although not shown in FIG. 30, the optimal card recommendation method based on weights depending on payment times according to the embodiment of the present invention is configured to, when performing matching between the one or more expected purchase commodities and the expected payment amount, adjust any one of the expected payment amount and the one or more expected purchase commodities, and then match the one or more expected purchase commodities with the expected payment amount. That is, in order to reduce the difference between the total amount of the one or more expected purchase commodities and the expected payment amount, any one of the total amount and the expected payment amount may be adjusted.

Here, when the total amount is greater than the expected payment amount, a commodity having a low probability of being purchased is first excluded from the one or more expected purchase commodities, and thus the total amount may be adjusted to match the expected payment amount. For example, it may be assumed that there are 10 expected purchase commodities, that the total amount is greater than the expected payment amount, and that the difference between the total amount and the expected payment amount is greater than a preset reference difference by 50,000 Won. In this case, it is determined that an unnecessary commodity is further included in the expected purchase commodities, the probabilities of being purchased are determined for 10 respective expected purchase commodities, and the commodity having the lowest probability of being purchased may be excluded first.

Further, when the total amount is less than the expected payment amount, the expected payment amount is adjusted to match the total amount, and thus the one or more expected purchase commodities may match the expected payment amount. For example, it may be assumed that there are five expected purchase commodities, that the total amount is less than the expected payment amount, and that the difference between the total amount and the expected payment amount is greater than a preset reference difference by 50,000 Won. In this case, it is preferable to recommend a card using a method for adjusting the expected payment amount to match the total amount, rather than using a method for adding a commodity having a low probability of being purchased to the expected purchase commodities for the additional purchase of the commodity. That is, since the probability that the user will purchase an unnecessary commodity is low, the accuracy of the algorithm for recommending a card may be improved by decreasing the expected payment amount.

Further, although not shown in FIG. 30, the optimal card recommendation method based on weights depending on payment times according to the embodiment of the present invention checks the opening dates of card usage periods of multiple cards registered in the application, and divides each of the usage record determination periods corresponding to one month from the card usage period opening dates into a plurality of sections. For example, assuming that the opening date of the card usage period is the first day of each month, the usage record determination period may be divided into sections such that an interval ranging from the opening date to ⅓ of the usage record determination period is a first section, an interval ranging from the end of the first section to ⅔ of the usage record determination period is a second section, and an interval corresponding to the remaining ⅓ of the usage record determination period is a third section.

Here, since the opening dates of card usage periods of respective cards may be different from each other, the usage record determination periods may be divided into multiple sections in different ways for multiple respective cards.

Here, the multiple sections may be variously set and divided depending on an optimal card recommendation system.

Furthermore, although not shown in FIG. 30, the optimal card recommendation method based on weights depending on payment times according to the embodiment of the present invention applies a first weight to any one of discount rates and accumulation rates corresponding to multiple cards in the first section, among multiple sections, applies a second weight to any one of discount rates and accumulation rates in the second section, among the multiple sections, and applies a third weight to any one of discount rates and accumulation rates in the third section, among the multiple sections.

In this case, the weights may be applied such that discount rates are greater than accumulation rates. Generally, it may be determined that a benefit corresponding to an amount that is immediately discounted when a commodity is purchased is higher than a benefit corresponding to accumulated points or amounts. Further, in the case of discounts, there are many cases where an actual cash discount is made, but in the case of points, in most cases points that may be used only in a specific store are accumulated. Further, the accumulated points may be used only when they reach a specific number of points. Therefore, from the standpoint of benefits, it may be determined that discounts provide more benefits than those of accumulation. Further, a higher weight may be applied to discount rates such that, when a discount amount is identical to an accumulated amount, a card for providing a discount is recommended.

For example, the first weight may be applied to the first section so that the ratio of the discount rate to the accumulation rate is 1.5:1 so as to recommend the card having the maximum discount benefits. The second weight may be applied to the second section so that the ratio of the discount rate to the accumulation rate is 1.4:1 so as to recommend the card having more discount benefits while also considering the usage record in the current month. The third weight may be applied to the third section so that the ratio of the discount rate to the accumulation rate is 1.2:1 so as to prevent the difference between the discount benefits and the accumulation benefits from being large because an object to cause the usage record in the current month to reach the target usage record may be primarily considered.

In this case, separate recommendation algorithms may be applied to respective sections. For example, an algorithm for recommending an optimal card in consideration of benefits may be applied to the first section, an algorithm for recommending an optimal card in consideration of both benefits and the card usage record in the current month may be applied to the second section, and an algorithm for recommending an optimal card in consideration of only the card usage record in the current month may be applied to the third section. Further, when the card usage record is considered, as in the case of the second section or the third section, a card may also be recommended in consideration of the usage record in the future by operating in conjunction with other applications, such as the calendar or housekeeping book of the user terminal.

Further, recommendation factors, such as discounts or accumulation, the achievement rate of a target usage record in the current month, or the non-achievement rate of the target usage record in the current month, are designated, and weights for respective recommendation factors may be set differently depending on the type of card. For example, the weights for discounts and accumulation of card A may set to values greater than those of card B.

Here, cards having the same card usage period opening date, among the multiple cards, may be grouped, and then one or more card groups may be generated. For example, it may be assumed that five credit cards corresponding to A to E are registered in the application and that the opening dates of card usage periods of cards A to C are the first day of each month, but the opening dates of card usage periods of cards D and E are the 11th of each month. Here, cards A, B, and C may be grouped to generate a first card group, and cards D and E may be grouped to generate a second card group.

In this case, the usage record determination period corresponding to each of the one or more card groups may be divided into multiple group-based sections. That is, in the above example, since the opening date of the card usage period for the first card group is the first day of each month, the usage record determination period may be divided into multiple sections such that an interval ranging from the first to the 10th of the month is a first section, an interval ranging from the 11th to the 20th is a second section, and an interval ranging from the 21st to the last day is a third section. Further, since the opening date of the card usage period for the second card group is the 11th of each month, the usage record determination period may be divided into multiple sections such that an interval ranging from the 11th to the 20th of the month is a first section, an interval ranging from the 21st to the last day is a second section, and an interval ranging from the first to the 10th is a third section.

Therefore, the optimal card recommendation method based on weights depending on payment times according to the embodiment of the present invention determines the payment section corresponding to the current date, among multiple sections corresponding to the usage record determination period, at step S3030. That is, among the multiple sections, the section in which the current date, on which the user enters the store, falls may be determined.

Furthermore, the optimal card recommendation method based on weights depending on payment times according to the embodiment of the present invention recommends an optimal card, among multiple cards registered in the application, in consideration of at least one of the recommendation algorithm to which the weight corresponding to the payment section is applied, the one or more expected purchase commodities, and the expected payment amount at step S3040.

Here, weights for recommendation are respectively assigned to the recommendation algorithm corresponding to the payment section, the one or more expected purchase commodities, and the expected payment amount, and a card obtained as a result of applying individual weights may be recommended as an optimal card.

Here, the multiple cards may include payment cards such as a cash card, a debit card, and a credit card for payment. Further, the multiple cards may include a membership card, a cash-back card, and a discount card, which enable points to be accumulated or discounts to be provided when commodities are purchased.

Here, the application may include a mobile payment application, a mobile electronic wallet application, etc., which register the card information of the user and allow the terminal to perform payment using the card information.

Here, when the payment section is the first section among the multiple sections, an optimal card may be recommended among the multiple cards in consideration of benefits including discount rates and accumulation rates. When the payment section is the second section among the multiple sections, an optimal card may be recommended among the multiple cards in consideration of both benefits and the usage record in the current month. When the payment section is the third section among the multiple sections, an optimal card may be recommended among the multiple cards in consideration of the usage record in the current month.

At this time, the first section may be a section corresponding to a first part of the usage record determination period, the second section may be a section corresponding to the middle part of the usage record determination period, and the third section may be a section corresponding to the last part of the usage record determination period.

Therefore, the first section is not yet a time during which a usage record in the current month is to be considered, and thus a card is preferably recommended so that benefits, such as accumulation or discounts, are maximally given. For example, in the first section, a card having high discount benefits may be recommended by setting the weight applied to the discount rates to a value much greater than the weight applied to the accumulation rates.

Further, in the second section, the card that provides more benefits may be recommended as the optimal card, among cards for which the usage record in the current month has not yet reached a target usage record, in consideration of the usage record in the current month, together with benefits. That is, in the second section, multiple cards are divided into cards having the possibility that the usage record in the current month will reach a target usage record and cards having no such possibility. Among the cards having the possibility that the usage record in the current month will reach the target usage record, the card to which accumulation rather than discounts is applied may be preferably recommended as the optimal card.

For example, it may be assumed that when payment is performed using card A, for which the usage record in the current month has reached the target usage record, a discount benefit of 1,000 Won may be obtained, and when payment is performed using card B, for which the usage record in the current month has not yet reached the target usage record, a discount benefit of 800 Won may be obtained, and that when payment is performed using card C, for which the usage record in the current month has not yet reached the target usage record, an accumulation benefit of 1,000 Won may be obtained. In this case, if both cards B and C have the possibility of reaching the target usage records and the payment section is the second section, card C may be recommended as the optimal card, rather than card A, for which the usage record has reached the target usage record, or card B, which provides discount benefits.

Further, in the third section, the card for which the usage record in the current month is expected to reach the target usage record during the period remaining until the opening date of the next card usage period may be recommended as the optimal card, among cards for which the usage records in the current month have not yet reached the target usage records, in consideration of the usage record in the current month. Furthermore, the third section is the section corresponding to the last period for the calculation of the usage record, and may be a section in which it is more important to obtain benefits for the next month by achieving the usage records of cards that have a possibility of reaching the target usage record, among the cards for which usage records in the current month have not yet reached the target usage records, than to obtain instant discount benefits. Therefore, in the situation in which the usage record of a specific card fails to achieve the target usage record by 200 Won, even the card to which accumulation rather than discounts is applied may be primarily recommended as an optimal card.

For example, it may be assumed that when payment is performed using card C, for which 100,000 Won remains in order for the usage record in the current month to reach the target usage record, a discount benefit of 1,000 Won may be obtained, and when payment is performed using card D, for which 5,000 Won remains in order for the usage record in the current month to reach the target usage record, a discount benefit of 300 Won may be obtained. Here, assuming that the same period of three days remains until the opening dates of the card usage periods of cards C and D, card D, which is expected to reach the target usage record in the remaining three days based on the payment pattern of the user, may be recommended as an optimal card even if a 1,000-Won discount is not immediately obtained.

Here, when the payment section is the first section, and there are cards having the same benefits including discount rates and accumulation rates, among multiple cards, an optimal card may be recommended in the sequence of usage records in the current month from lowest to highest usage records. When the payment section is the second section, and there are cards having the same benefits, among the multiple cards, an optimal card may be recommended in the sequence of usage records in the current month from closest to farthest from target usage records for respective cards. That is, when there are cards for which recommendation criteria for respective sections are identical to each other, the usage record in the current month may be accumulated by prompting the user to primarily use a card having a low usage record in the current month in the first section. Further, a card for which the usage record has not yet reached the target usage record, but is expected to reach the target usage record because the usage record in the current month is high, may be recommended in the second section.

In this case, it is possible to determine which one of the multiple sections corresponds to the payment section, select one or more group-based optimal cards from each of one or more card groups, and recommend an optimal card, among the one or more group-based optimal cards, in consideration of at least one of the benefits and the usage record in the current month.

For example, it may be assumed that cards A, B, and C are included in the first card group, the opening date of the card usage period of which is the first day of each month, and that cards D and E are included in the second card group, the opening date of the card usage period of which is the 11th of each month. Here, it may also be assumed that, for the first card group, the first section may range from the first to the 10th of the month, the second section may range from the 11th to the 20th, and the third section may range from the 21st to the last day, and for the second card group, the first section may range from the 11th to the 20th, the second section may range from the 21st to the last day, the third section may range from the first to the 10th, and a payment due date is the 12th. At this time, in the first card group, the payment due date may fall within the second section, and in the second card group, the payment due date may fall within the first section. Therefore, in the first card group, one of cards A, B, and C may be selected based on the recommendation algorithm applied to the second section, and in the second card group, one of cards D and E may be selected based on the recommendation algorithm applied to the first section.

Assuming that card A is selected from the first card group and that card D is selected from the second card group, one of the selected cards may be recommended as an optimal card in consideration of at least one of the benefits of cards A and D and the usage records in the current month for cards A and D.

Here, among one or more payment cards included in the multiple cards, an optimal payment card may be recommended.

In an embodiment, since discount or accumulation rates may differ from each other depending on whether the payment card is a credit card, a cash card or a debit card, the discount rates and accumulation rates for respective types of payment cards may be checked, and the card having the maximum benefits may be recommended as the optimal payment card when the payment section of the corresponding card is a section in which benefits are considered depending on the payment sections of respective payment cards.

In another embodiment, since the benefits of respective credit cards or debit cards may be provided differently depending on the card usage record in the previous month, an optimal card may be recommended by additionally considering whether the card usage record in a previous month has been achieved.

Further, among one or more membership cards included in the multiple cards, an optimal membership card may be recommended together with the optimal payment card.

For example, when an optimal payment card is recommended, a membership card, which can be used together with the recommended payment card and can be used at the corresponding store, is recommended together with the payment card, thus allowing the user to be sufficiently provided with the benefits of discounts and accumulation without missing the benefits.

Furthermore, when it is possible to purchase a commodity using points accumulated in a membership card, the corresponding membership card may be included in a card recommendation list for payment and may also be recommended. In addition, when payment using points is possible according to the setting of the user, the recommendation priority of the corresponding membership card is designated to be higher than that of a credit card or a debit card, and then the membership card may be primarily recommended.

Here, information about an optimal payment card and an optimal membership card may be provided together through the application. For example, information about the optimal membership card that matches information about the optimal payment card may be displayed together on a single screen of the application. Alternatively, when the optimal payment card is clicked, optimal membership cards that can be used together with the clicked optimal payment card may be provided in the form of a list in descending order of benefit amount.

Furthermore, although not shown in FIG. 30, in the optimal card recommendation method based on weights depending on payment times according to the embodiment of the present invention, the optimal card recommendation apparatus transmits and receives information required to recommend an optimal card to and from the terminal of the user over a communication network, such as a typical network, through a separate communication module. In particular, the communication module according to the embodiment of the present invention may receive information required to predict the one or more expected purchase commodities and the expected payment amount from the terminal, and may provide information corresponding to the optimal card to the terminal. Further, information about the opening dates of card usage periods for respective cards registered in the application may be received through the homepages of respective card companies connected to the application server.

Here, information required to predict the one or more expected purchase commodities and the expected payment amount may be received from a separate application server. For example, user information, such as the purchase information, personal information, possessed payment card information, and possessed membership card information of the user, and various types of information, pertaining for example to events, discounts, and marketing information provided by the corresponding store, may be received.

Furthermore, although not shown in FIG. 30, the optimal card recommendation method based on weights depending on payment times according to the embodiment of the present invention stores various types of information, generated during a procedure for providing the optimal card recommendation service according to the embodiment of the present invention, in a storage module.

Here, the storage module may be implemented independently of the optimal card recommendation apparatus to support a function for the optimal card recommendation service. Here, the storage module may function as separate large-capacity storage, and may include a control function for performing operations.

By means of such an optimal card recommendation method, when the user pays for a commodity at a store using his or her mobile terminal, an automatic payment service may be used using a payment card that is recommended in advance.

Further, a payment card and a membership card that allow the user to obtain the maximum benefits, such as discounts or accumulation, are recommended depending on the commodities expected to be purchased by the user and the amount of the payment expected to be made by the user, thus inducing the user to consume appropriately and helping the user make reasonable purchases.

Furthermore, the number of operations required by the user to pay at the store using the mobile terminal may be minimized, and thus there is an advantage in that the convenience of the user may be maximized when commodities are purchased.

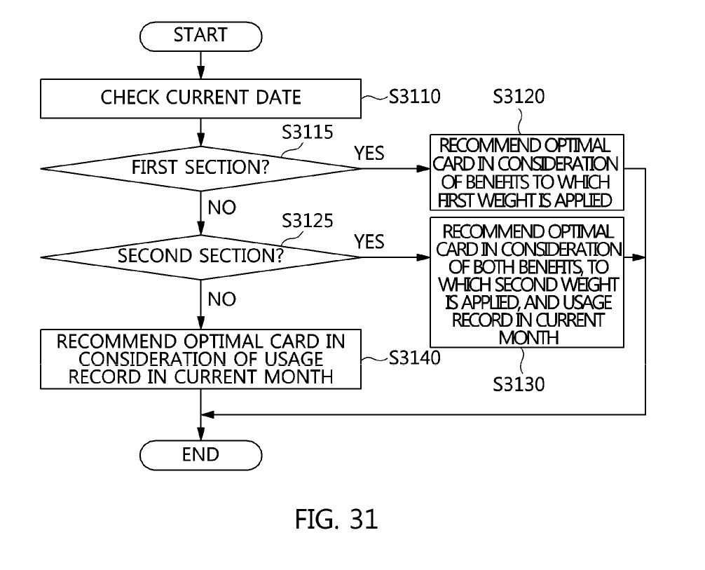

FIG. 31 is a diagram showing in detail a procedure for determining recommendation algorithms depending on payment sections in the optimal card recommendation method based on weights depending on payment times according to an embodiment of the present invention.

Referring to FIG. 31, the procedure for determining recommendation algorithms depending on payment sections in the optimal card recommendation method based on weights depending on payment times according to the embodiment of the present invention checks the date on which the user enters a store at step S3110.

Thereafter, it is determined whether the current date falls within a first section, among the multiple sections corresponding to the usage record determination period, at step S3115.

Here, the usage record determination period may be divided into multiple sections based on the opening dates of card usage periods of the multiple cards registered in the application. For example, assuming that the opening date of the card usage period is the first day of each month, the usage record determination period may be divided into sections such that an interval ranging from the opening date to ⅓ of the usage record determination period is a first section, an interval ranging from the end of the first section to ⅔ of the usage record determination period is a second section, and an interval corresponding to the remaining ⅓ of the usage record determination period is a third section.

Here, since the opening dates of card usage periods of respective cards may be different from each other, the usage record determination periods may be divided into multiple sections in different ways for multiple respective cards.

A first weight may be applied to any one of discount rates and accumulation rates corresponding to multiple cards in the first section, among multiple sections, a second weight may be applied to any one of discount rates and accumulation rates in the second section, among the multiple sections, and a third weight may be applied to any one of discount rates and accumulation rates in the third section, among the multiple sections.

In this case, the weights may be applied such that discount rates are greater than accumulation rates. Generally, it may be determined that a benefit corresponding to an amount that is immediately discounted when a commodity is purchased is higher than a benefit corresponding to accumulated points or amounts. Further, in the case of discounts, there are many cases where an actual cash discount is made, but in the case of points, in most cases points that may be used only in a specific store are accumulated. Further, the accumulated points may be used only when they reach a specific number of points. Therefore, from the standpoint of benefits, it may be determined that discounts provide more benefits than those of accumulation. Further, a higher weight may be applied to discount rates such that, when a discount amount is identical to an accumulated amount, a card for providing a discount is recommended.

In this regard, separate recommendation algorithms may be applied to respective sections. For example, an algorithm for recommending an optimal card in consideration of benefits may be applied to the first section, an algorithm for recommending an optimal card in consideration of both benefits and the card usage record in the current month may be applied to the second section, and an algorithm for recommending an optimal card in consideration of only the card usage record in the current month may be applied to the third section. Further, when the card usage record is considered, as in the case of the second section or the third section, a card may also be recommended in consideration of the usage record in the future by operating in conjunction with other applications, such as the calendar or housekeeping book of the user terminal.

If it is determined at step S3115 that the current date falls within the first section, an optimal card is recommended in consideration of benefits, to which the first weight is applied, together with the expected purchase commodities and the expected payment amount, at step S3120.

If it is determined at step S3115 that the current date does not fall within the first section, it is determined whether the current date falls within the second section, among the multiple sections corresponding to the usage record determination period, at step S3125.

If it is determined at step S3125 that the current date falls within the second section, an optimal card is recommended in consideration of both benefits, to which the second weight is applied, and the usage record in the current month, together with the expected purchase commodities and the expected payment amount, at step S3130.

If it is determined at step S3125 that the current date does not fall within the second section, it is determined that the current date falls within the third section, among the multiple sections corresponding to the usage record determination period, and an optimal card is recommended in consideration of the usage record in the current month, together with the expected purchase commodities and the expected payment amount, at step S3140.

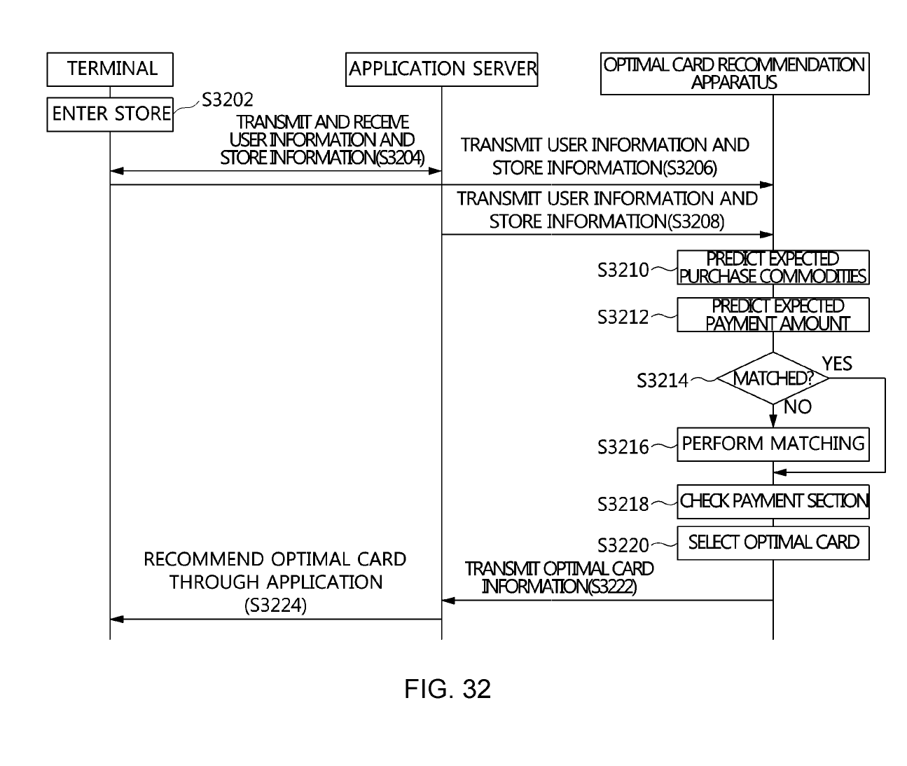

FIG. 32 is a flow diagram showing an optimal card recommendation process based on weights depending on payment times according to an embodiment of the present invention.

Referring to FIG. 32, in the optimal card recommendation method based on weights depending on payment times according to the embodiment of the present invention, the user enters an offline store while holding his or her terminal at step S3202.

Next, an application server checks the terminal of the user based on information received through at least one BLE device, that is, at least one beacon, installed at the store, and transmits and receives user information and store information to and from the terminal of the user at step S3204.

Thereafter, the user information and the store information are transmitted to the optimal card recommendation apparatus through the terminal or the application server at steps S3206 and S3208.

Here, the user information may be private user information related to the personal information, purchase history information, and commodity-of-interest information of the user who has subscribed to the application, and the store information may correspond to information, such as events, discounts and benefits corresponding to an offline store visited by the user.

Thereafter, the optimal card recommendation apparatus obtains at least one of the purchasing pattern of the user in an affiliated store group corresponding to the store, the purchasing pattern of a user group identical to the user in the affiliated store group, benefit information provided by each store, and the utilization of benefits by the user, based on the user information and the store information, and then predicts one or more expected purchase commodities at step S3210.

Next, the optimal card recommendation apparatus obtains information about an expected payment amount in consideration of at least one of the purchasing pattern of the user, information about the amount of the purchase by a single user at the store, and information about the amount of each purchase by the identical user group in the affiliated store group, based on the user information and the store information, and then predicts the expected payment amount at step S3212.

Thereafter, it is determined whether to match the one or more expected purchase commodities with the expected payment amount at step S3214.

Here, the prices of the one or more expected purchase commodities are summed, and thus the total amount is calculated. Whether the difference between the total amount and the expected payment amount is equal to or greater than a preset reference difference is determined. If it is determined that the difference is equal to or greater than the preset reference difference, matching may be performed.

If it is determined at step S3214 that matching is to be performed, matching is performed by excluding a commodity having a low probability of being purchased from the one or more expected purchase commodities, whereas when the total amount is less than the expected payment amount, matching is performed by adjusting the expected payment amount at step S3216.

Thereafter, among multiple sections corresponding to the usage record determination period, the payment section corresponding to the current date is determined at step S3218.

Thereafter, the optimal card for payment is selected from among the cards of the user registered in the application in consideration of at least one of the recommendation algorithm to which the weight corresponding to the payment section is applied, the one or more expected purchase commodities, and the expected payment amount which have been matched has been performed, at step S3220.

In contrast, if it is determined at step S3214 that matching is not to be performed, the payment section is determined at step S3218, and an optimal card is selected in consideration of at least one of the recommendation algorithm corresponding to the payment section, the one or more expected purchase commodities, and the expected payment amount at step S3220.

Thereafter, information about the selected optimal card is delivered to the application server at step S3222, and the application server recommends the optimal card by displaying the optimal card information to the user through the application at step S3224.

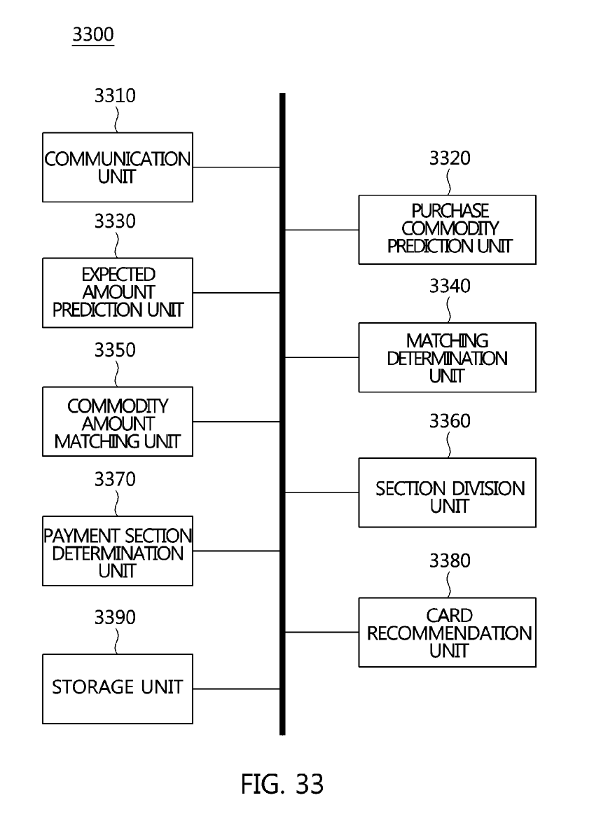

FIG. 33 is a block diagram showing an optimal card recommendation apparatus according to still another embodiment of the present invention.

Referring to FIG. 33, an optimal card recommendation apparatus 3300 according to still another embodiment of the present invention may include a communication unit 3310, a purchase commodity prediction unit 3320, an expected amount prediction unit 3330, a matching determination unit 3340, a commodity amount matching unit 3350, a section division unit 3360, a payment section determination unit 3370, a card recommendation unit 3380, and a storage unit 3390.

The communication unit 3310 functions to transmit and receive information required to recommend an optimal card to and from the terminal of the user over a communication network, such as a typical network. In particular, the communication unit 3310 according to an embodiment may receive pieces of information required to predict one or more expected purchase commodities and an expected payment amount from the terminal, and may provide information corresponding to the optimal card to the terminal. Further, information about the opening dates of card usage periods for respective cards registered in the application may be received through the homepages of respective card companies connected to the application server.

Here, information required to predict the one or more expected purchase commodities and the expected payment amount may be received from a separate application server. For example, user information, such as the purchase information, personal information, possessed payment card information, and possessed membership card information of the user, and various types of information, pertaining for example to events, discounts, and marketing information provided by the corresponding store, may be received.

The purchase commodity prediction unit 3320 predicts one or more purchase commodities that are expected to be purchased by the user at a store. That is, conventional card recommendation technology is configured to recommend an optimal payment card and an optimal membership card in consideration of information about the type and price of the corresponding commodity to be purchased by the user in the state in which the commodity to be purchased by the user has been fixed. Thus, the conventional card recommendation technology merely enables a card to be recommended only when the user enters information about the commodity to be purchased through the application, or only when commodity information is provided through the POS device at the store. However, such card recommendation technology cannot provide a particular advantage except for convenience in that information about the card to be used for payment is provided when the user purchases a commodity through the POS device.

In contrast, the present invention predicts in advance commodities expected to be purchased by the user and recommends a card in the state in which the commodity to be purchased by the user at the store is not yet fixed, thus providing assistance in further simplifying and facilitating the procedure in which the user actually performs payment through the POS device.

Here, one or more commodities expected to be purchased may be predicted in consideration of at least one of the purchasing pattern of the user in an affiliated store group corresponding to the store, the purchasing pattern of a user group identical to the user in the affiliated store group, benefit information provided by each store, and the utilization of benefits by the user.

In an embodiment, the purchasing patterns of the user for respective affiliated store groups may be generated using information, such as the types of commodities purchased by the user in each affiliated store group, which sells household items, the time of the purchase, or the price range of purchased commodities.

In another embodiment, based on the age, gender, occupation, and preference information of the user, a user group may be generated based on other users corresponding to information similar to the above information, and the purchasing pattern of the corresponding user group may be generated and may be used to predict commodities that are expected to be purchased.

In a further embodiment, information about the store visited by the user may be obtained, and benefit information currently provided by the store, that is, information about discounted commodities, commodities corresponding to a Buy-One-Get-One-Free (BOGOF) offer, or commodities available for a limited time, may be obtained and used to predict the commodities that are expected to be purchased.

In yet another embodiment, commodities expected to be purchased may be predicted in consideration of how the user has utilized benefits obtained from the purchase of commodities. That is, benefit information preferred by the user between discounts and accumulation may be considered, or a usage pattern for accumulated points may be considered when the commodities expected to be purchased are predicted.

Here, unnecessary commodity items may be detected in consideration of at least one of information about the commodity most recently purchased by the user in the affiliated store group and the time of the purchase, and may be excluded when one or more commodities expected to be purchased are predicted.

For example, when there is a commodity purchased by the user in an affiliated store group identical to a specific store before the user visits the specific store, there is a low probability that the user will purchase the corresponding commodity at the current store. Therefore, when the commodity expected to be purchased at the current store is predicted, the commodity previously purchased in the same affiliated store group may be recognized as an unnecessary commodity item, and may be excluded from the commodities expected to be purchased.

In still another embodiment, when there is a commodity purchased by the user in an affiliated store group identical to a specific store before the user visits the specific store, the commodity may instead be predicted to be the commodity expected to be purchased in consideration of the time at which the corresponding commodity was purchased and whether the commodity is discounted or not. That is, assuming that hair gel is on sale at a discount price at a hair product shop visited by the user, and the user purchased the hair gel one month ago, there may be a high probability that the user will purchase the hair gel owing to the benefits of the discount price at this visit.

The expected amount prediction unit 3330 predicts the amount of the payment that is expected to be made by the user at a store.

Here, the reason for additionally predicting an expected payment amount as well as an expected purchase commodity so as to recommend an optimal card is that there may be benefits that are provided when a predetermined amount or more is paid at each store. Therefore, the amount required to purchase a commodity, that is, the payment amount, may be a very important factor in recommending a card. For example, assuming that a discount benefit is provided when commodities corresponding to more than 100,000 Won are purchased with a specific payment card at a store visited by the user, a payment amount for purchase commodities, which are expected to be purchased by the user at the corresponding store, is predicted to reach an amount of 100,000 Won, thus allowing the user to obtain more benefits.

Here, the expected payment amount may be predicted in consideration of at least one of the purchasing pattern of the user, information about the amount of the purchase by a single user at the store, and information about the amount of each purchase by a user group identical to the user in an affiliated store group.

In an embodiment, when the purchasing pattern of the user, which was considered when the expected purchase commodity was predicted, is used, information about the prices of commodities to be purchased by the user may be acquired, and thus the expected payment amount may be predicted in consideration of the purchasing pattern of the user.

In another embodiment, an expected payment amount may be predicted using information about the average purchase amount by a single user at the store visited by the user.

In a further embodiment, whether the store visited by the user is a jewelry shop which sells relatively expensive goods, or a grocery shop which sells relatively cheap goods, is determined, and information about the amount of each purchase in the corresponding affiliated store group may be considered. Further, whether a user is a student, a housewife, or an office worker is determined, and thus information about the amount of each purchase by a user group identical to the user may be considered. That is, in the cases where the user is a student and where the user is an office worker, there may be a great difference in consumption tendencies, and thus an expected payment amount may be predicted in consideration of the purchase amount information based on the user group.

The matching determination unit 3340 determines whether to match the one or more expected purchase commodities with the expected payment amount by comparing the total amount of one or more expected purchase commodities with the expected payment amount. For example, assuming that the expected payment amount is predicted to be excessively high compared to the number of the one or more expected purchase commodities, there is the possibility that the reliability of the recommended card may be deteriorated because the tendencies of two conditions that are considered when recommending an optimal card are different from each other. Therefore, it is possible to compare the total amount obtained by summing the prices of one or more expected purchase commodities with the expected payment amount, and to determine to match the expected purchase commodities with the expected payment amount if it is determined that a difference is present between the total amount and the expected payment amount. Then, an algorithm for performing matching may be executed.

Further, if it is determined that the total amount is relatively similar to the expected payment amount when comparing the total amount with the expected payment amount, matching is not performed, and the expected payment amount may be used as a reference value that is considered when recommending an optimal card.

At this time, when the difference between the total amount and the expected payment amount is equal to or greater than a preset reference difference, it may be determined that matching is to be performed. For example, when the preset reference difference is 30,000 Won, matching may be performed when the difference between the total amount and the expected payment amount is 30,000 Won or more.

Here, the preset reference difference may be set to different values depending on affiliated store groups. For example, the reference difference in an affiliated store group that sells expensive commodities is set to a value larger than that of the reference difference in an affiliated store group that sells relatively inexpensive commodities, thus preventing unnecessary matching from being performed. Further, the reference difference in an affiliated store group that sells inexpensive commodities is set to a smaller value, thus improving the accuracy of the algorithm for recommending an optimal card.

The commodity amount matching unit 3350 is configured to, when performing matching between the one or more expected purchase commodities and the expected payment amount, adjust any one of the expected payment amount and the one or more expected purchase commodities, and then match the one or more expected purchase commodities with the expected payment amount. That is, in order to reduce the difference between the total amount of the one or more expected purchase commodities and the expected payment amount, any one of the total amount and the expected payment amount may be adjusted.

Here, when the total amount is greater than the expected payment amount, a commodity having a low probability of being purchased is first excluded from the one or more expected purchase commodities, and thus the total amount may be adjusted to match the expected payment amount. For example, it may be assumed that there are 10 expected purchase commodities, that the total amount is greater than the expected payment amount, and that the difference between the total amount and the expected payment amount is greater than a preset reference difference by 50,000 Won. In this case, it is determined that an unnecessary commodity is further included in the expected purchase commodities, the probabilities of being purchased are determined for 10 respective expected purchase commodities, and the commodity having the lowest probability of being purchased may be excluded first.

Further, when the total amount is less than the expected payment amount, the expected payment amount is adjusted to match the total amount, and thus the one or more expected purchase commodities may match the expected payment amount. For example, it may be assumed that there are five expected purchase commodities, that the total amount is less than the expected payment amount, and that the difference between the total amount and the expected payment amount is greater than a preset reference difference by 50,000 Won. In this case, it is preferable to recommend a card using a method for adjusting the expected payment amount to match the total amount, rather than using a method for adding a commodity having a low probability of being purchased to the expected purchase commodities for the additional purchase of the commodity. That is, since the probability that the user will purchase an unnecessary commodity is low, the accuracy of the algorithm for recommending a card may be improved by decreasing the expected payment amount.

The section division unit 3360 checks the opening dates of card usage periods of multiple cards registered in the application, and divides each of the usage record determination periods corresponding to one month from the card usage period opening dates into a plurality of sections. For example, assuming that the opening date of the card usage period is the first day of each month, the usage record determination period may be divided into sections such that an interval ranging from the opening date to ⅓ of the usage record determination period is a first section, an interval ranging from the end of the first section to ⅔ of the usage record determination period is a second section, and an interval corresponding to the remaining ⅓ of the usage record determination period is a third section.

Here, since the opening dates of card usage periods of respective cards may be different from each other, the usage record determination periods may be divided into multiple sections in different ways for multiple respective cards.

In this case, separate recommendation algorithms may be applied to respective sections. For example, an algorithm for recommending an optimal card in consideration of benefits may be applied to the first section, an algorithm for recommending an optimal card in consideration of both benefits and the card usage record in the current month may be applied to the second section, and an algorithm for recommending an optimal card in consideration of only the card usage record in the current month may be applied to the third section. Further, when the card usage record is considered, as in the case of the second section or the third section, a card may also be recommended in consideration of the usage record in the future by operating in conjunction with other applications, such as the calendar or housekeeping book of the user terminal.

Further, recommendation factors, such as discounts or accumulation, the achievement rate of the usage record in the current month, or the non-achievement rate of the usage record in the current month, are designated for respective sections to which recommendation algorithms are applied, and weights may be differently set for respective recommendation factors. Furthermore, weights for respective recommendation factors may be set differently for respective cards. For example, the weights of discounts and accumulation for card A may be set to values greater than those of card B.

In this case, the multiple sections may be variously set and divided depending on the optimal card recommendation system.

Here, cards having the same card usage period opening date, among the multiple cards, may be grouped, and then one or more card groups may be generated. For example, it may be assumed that five credit cards corresponding to A to E are registered in the application and that the opening dates of card usage periods of cards A to C are the first day of each month, but the opening dates of card usage periods of cards D and E are the 11th of each month. Here, cards A, B, and C may be grouped to generate a first card group, and cards D and E may be grouped to generate a second card group.

In this case, the usage record determination period corresponding to each of the one or more card groups may be divided into multiple group-based sections. That is, in the above example, since the opening date of the card usage period for the first card group is the first day of each month, the usage record determination period may be divided into multiple sections such that an interval ranging from the first to the 10th of the month is a first section, an interval ranging from the 11th to the 20th is a second section, and an interval ranging from the 21st to the last day is a third section. Further, since the opening date of the card usage period for the second card group is the 11th of each month, the usage record determination period may be divided into multiple sections such that an interval ranging from the 11th to the 20th of the month is a first section, an interval ranging from the 21st to the last day is a second section, and an interval ranging from the first to the 10th is a third section.

The payment section determination unit 3370 determines a payment section corresponding to the current date, among the multiple sections corresponding to the usage record determination period. That is, among the multiple sections, the section in which the current date, on which the user enters the store, falls may be determined.

The card recommendation unit 3380 recommends an optimal card, among multiple cards registered in the application, in consideration of at least one of a recommendation algorithm corresponding to the payment section, the one or more expected purchase commodities, and the expected payment amount, and in particular recommends the optimal card by additionally considering the possibility of a target usage record being achieved when the closing of a card usage period is postponed depending on the payment section.

Here, weights for recommendation are respectively assigned to the recommendation algorithm corresponding to the payment section, the one or more expected purchase commodities, and the expected payment amount, and the card for which the sum of the individual weights is the largest may be recommended as an optimal card.

Here, the multiple cards may include payment cards such as a cash card, a debit card, and a credit card for payment. Further, the multiple cards may include a membership card, a cash-back card, and a discount card, which enable points to be accumulated or a discount to be provided when commodities are purchased.

Here, the application may include a mobile payment application, a mobile electronic wallet application, etc., which register the card information of the user and allow the terminal to perform payment using the card information.

Here, when the payment section is the first section among the multiple sections, an optimal card may be recommended among the multiple cards in consideration of benefits. When the payment section is the second section among the multiple sections, an optimal card may be recommended among the multiple cards in consideration of both benefits and the usage record in the current month. When the payment section is the third section among the multiple sections, an optimal card may be recommended among the multiple cards in consideration of the usage record in the current month.

At this time, the first section may be a section corresponding to a first part of the usage record determination period, the second section may be a section corresponding to the middle part of the usage record determination period, and the third section may be a section corresponding to the last part of the usage record determination period.

Therefore, since the first section is not yet the time during which the usage record in the current month is to be considered, the card that provides the maximum benefits may be recommended as an optimal card in consideration of benefits such as discounts or accumulation.

Further, in the second section, a card which provides more benefits, among cards for which the usage records in the current month have not yet reached target usage records, may be recommended as an optimal card in consideration of the usage record in the current month together with benefits. For example, it may be assumed that, when payment is performed using card A, for which the usage record in the current month has reached the target usage record, a discount benefit of 1,000 Won may be obtained, and that when payment is performed using card B, for which the usage record in the current month has not yet reached the target usage record, a discount benefit 800 Won may be obtained. Here, when an optimal card is recommended by assigning a weight to the usage record in the current month for card B, card B may be recommended as an optimal card even if the discount amount of card B is lower than that of card A by 200 Won.

Furthermore, in the third section, a card for which the usage record in the current month is expected to reach the target usage record during the period remaining until the opening date of the next card usage period may be recommended as an optimal card, among cards for which usage records in the current month have not yet reached the target usage records, in consideration of the usage record in the current month. For example, it may be assumed that when payment is performed using card C, for which 100,000 Won remains in order for the usage record in the current month to reach the target usage record, a discount benefit of 500 Won may be obtained, and when payment is performed using card D, for which 10,000 Won remains in order for the usage record in the current month to reach the target usage record, a discount benefit of 300 Won is obtained. Here, assuming that the same period of three days remains until the opening dates of the card usage periods of card C and card D, card D, which is expected to reach the target usage record in the remaining three days based on the payment pattern of the user, may be recommended as the optimal card even if a 200-Won discount is not immediately obtained.

In this case, when the payment section corresponds to the third section, a possibility that the closing date of the card usage period of at least one card for which a usage record in the current month has not yet reached a target usage record may be postponed may be checked.

For example, it may be assumed that the target usage record of card A corresponds to 300,000 Won, and the usage record in the current month of card A corresponds to 290,000 Won, and that only a single day remains until the closing date of the card usage period. In this case, the closing date of the card usage period is postponed by four or five days, thus allowing the user to naturally use an amount remaining until the target usage record is reached, with the result that the target usage record of card A may be achieved. Therefore, card A may be classified as a card having a possibility of the closing date of the card usage period being postponed.

As another example, it may be assumed that the target usage record of card B corresponds to 400,000 Won, that the usage record in the current month of card B corresponds to 100,000 Won, and that three days remain until the closing date of the card usage period. In this case, even if the closing date of the card usage period is postponed to some extent, the amount remaining until the target usage record is achieved is large, and thus a possibility of the target usage record being achieved may be low. Therefore, card B may be classified as a card having no possibility of the closing date of the card usage period being postponed.

In this case, among the one or more cards, the optimal card may be recommended in consideration of the usage record in the current month, which is expected when the closing date of the card usage period of the card having a possibility of the closing date of the card usage period being postponed is postponed. That is, when an optimal card is recommended, the card that is expected not to achieve a target usage record because the closing date of the card usage period is approaching may be excluded from the candidates to be recommended as an optimal card. However, the card that has been excluded from the candidates may be considered again if the closing date of the card usage period is postponed. Therefore, the usage record in the current month that may be obtained when the closing date of the card usage period is postponed may be predicted, and thus an optimal card may be recommended in consideration of the predicted usage record in the current month.

Here, when the card having a possibility of the closing date of the card usage period being postponed is recommended as an optimal card, the closing date of the card usage period may be postponed by delaying the opening date of the card usage period of the optimal card.

In this case, the closing date of the card usage period denotes the last day of a usage record determination period for the corresponding card, and the day after the closing date of the card usage period may correspond to the opening date of a new card usage period during which the calculation of a usage record is newly performed.

Therefore, when the opening date of a card usage period is delayed, the closing date of the card usage period may also be postponed, and thus the closing date of the card usage period may be adjusted by changing the opening date of the card usage period. Alternatively, the closing date of the card usage period may be postponed by adjusting the closing date itself.

Here, the closing date of the card usage period may be postponed within a predetermined range. For example, there are the cases where the payment due dates or the card usage period opening dates of respective cards are designated for respective card companies. In other words, generally, various dates, such as the first, 10th, 25th or last day of each month, may be designated and one of the designated dates may be selected and used. Therefore, if there is a designated date even when the closing date of a card usage period is changed, the closing date may be changed and postponed in accordance with the designated date.

At this time, when the remaining amount required to reach the target usage record of at least one card is less than a reference remaining amount that is preset based on the purchasing pattern of the user, it may be determined that the card has a possibility of the closing date of a card usage period being postponed.

For example, it may be assumed that the target usage record of card D corresponds to 300,000 Won, that the usage record in the current month corresponds to 250,000 Won. Further, the current date is the 28th of the month, and the closing date of the card usage period of the card is the 30th of each month. When the closing date of the card usage period is postponed, it may be postponed up to the fifth of each month. Here, the purchasing pattern of the user may be checked, and the amount of the payment that is expected to be made by the user in an interval ranging from the 28th to the fifth day of the next month may be set to the reference remaining amount.

Therefore, when the set reference remaining amount is greater than 50,000 Won, which is the remaining amount required to reach the target usage record, that is, when the amount of the payment expected to be made by the user before the postponed closing date of the card usage period is greater than the remaining amount required to reach the target usage record, card D is determined to be able to achieve the target usage record when the closing date of the card usage period is postponed, and it may be determined that card D has a possibility of the closing date of the card usage period being postponed.

In contrast, when the set reference remaining amount is less than 50,000 Won, which is the remaining amount required to reach the target usage record, that is, when the amount of the payment expected to be made by the user before the postponed closing date of the card usage period is less than the remaining amount required to reach the target usage record, it may be determined that card D cannot achieve the target usage record even if the closing date of the card usage period is postponed, and then it may be determined that that card D has no possibility of the closing date of the card usage period being postponed.

Here, when the payment section is the first section, and there are cards having the same benefits, among multiple cards, an optimal card may be recommended in the sequence of usage records in the current month from lowest to highest usage records. When the payment section is the second section, and there are cards having the same benefits, among the multiple cards, an optimal card may be recommended in the sequence of usage records in the current month from closest to farthest from target usage records for respective cards. That is, when there are cards for which recommendation criteria for respective sections are identical to each other, the usage record in the current month may be accumulated by prompting the user to primarily use a card having a low usage record in the current month in the first section. Further, a card for which the usage record has not yet reached the target usage record, but is expected to reach the target usage record because the usage record in the current month is high, may be recommended in the second section.

In this case, it is possible to determine which one of the multiple sections corresponds to the payment section, select one or more group-based optimal cards from each of one or more card groups, and recommend an optimal card, among the one or more group-based optimal cards, in consideration of at least one of the benefits and the usage record in the current month.

For example, it may be assumed that cards A, B, and C are included in the first card group, the opening date of the card usage period of which is the first day of each month, and that cards D and E are included in the second card group, the opening date of the card usage period of which is the 11th of each month. Here, it may also be assumed that, for the first card group, the first section may range from the first to the 10th of the month, the second section may range from the 11th to the 20th, and the third section may range from the 21st to the last day, and for the second card group, the first section may range from the 11th to the 20th, the second section may range from the 21st to the last day, the third section may range from the first to the 10th, and a payment due date is the 12th. At this time, in the first card group, the payment due date may fall within the second section, and in the second card group, the payment due date may fall within the first section. Therefore, in the first card group, one of cards A, B, and C may be selected based on the recommendation algorithm applied to the second section, and in the second card group, one of cards D and E may be selected based on the recommendation algorithm applied to the first section.

First, assuming that card A is selected from the first card group and that card D is selected from the second card group, one of the selected cards may be recommended as an optimal card in consideration of at least one of the benefits of cards A and D and the usage records in the current month for cards A and D.

Here, among one or more payment cards included in the multiple cards, an optimal payment card may be recommended.

In an embodiment, since discount or accumulation rates may differ from each other depending on whether the payment card is a credit card, a cash card or a debit card, the discount rates and accumulation rates for respective types of payment cards may be checked, and the card having the maximum benefits may be recommended as the optimal payment card when the payment section of the corresponding card is a section in which benefits are considered depending on the payment sections of respective payment cards.

In another embodiment, discount rates or accumulation rates for respective card companies and banks corresponding to credit cards or debit cards may differ. Thus, the discount rates and accumulation rates for respective card companies and banks may be checked so as to recommend an optimal card.

In a further embodiment, since the benefits of respective credit cards or debit cards may be provided differently depending on the card usage record in the previous month, an optimal card may be recommended by additionally considering whether the card usage record in a previous month has been achieved.

Further, among one or more membership cards included in the multiple cards, an optimal membership card may be recommended together with the optimal payment card.

For example, when an optimal payment card is recommended, a membership card, which can be used together with the recommended payment card and can be used at the corresponding store, is recommended together with the payment card, thus allowing the user to be sufficiently provided with the benefits of discounts and accumulation without missing the benefits.

Furthermore, when it is possible to purchase a commodity using points accumulated in a membership card, the corresponding membership card may be included in a card recommendation list for payment and may also be recommended. In addition, when payment using points is possible according to the setting of the user, the recommendation priority of the corresponding membership card is designated to be higher than that of a credit card or a debit card, and then the membership card may be primarily recommended.

Here, information about an optimal payment card and an optimal membership card may be provided together through the application. For example, information about the optimal membership card that matches information about the optimal payment card may be displayed together on a single screen of the application. Alternatively, when the optimal payment card is clicked, optimal membership cards that can be used together with the clicked optimal payment card may be provided in the form of a list in descending order of benefit amount.

As described above, the storage unit 3390 stores various types of information generated during a procedure for providing the optimal card recommendation service according to an embodiment of the present invention.

In an embodiment, the storage unit 3390 may be implemented independently of the optimal card recommendation apparatus 3300 and may then support a function for the optimal card recommendation service. Here, the storage unit 3390 may function as separate large-capacity storage and may include a control function for performing operations.

Meanwhile, the optimal card recommendation apparatus 3300 is equipped with memory and may store information in the apparatus. In an exemplary embodiment, the memory is a computer-readable medium. In an exemplary embodiment, the memory may be a volatile memory unit, and in another exemplary embodiment, the memory may be a nonvolatile memory unit. In an embodiment, the storage may be a computer-readable medium. In various different embodiments, the storage may include, for example, a hard disk device, an optical disk device or other types of large-capacity storage device.

Such an optimal card recommendation apparatus 3300 is used, and thus the user may use an automatic payment service with a previously recommended payment card when paying for a commodity at a store using his or her mobile terminal.

Further, a payment card and a membership card which allow the user to obtain the maximum benefits, such as discounts or accumulation, are recommended depending on the commodity expected to be purchased by the user and the expected payment amount, thus inducing the user to consume appropriately and helping the user make a reasonable purchase.

Furthermore, an operation required by the user to pay at a store using a mobile terminal may be minimized, and thus there is an advantage in that the user's convenience may be maximized when commodities are purchased.

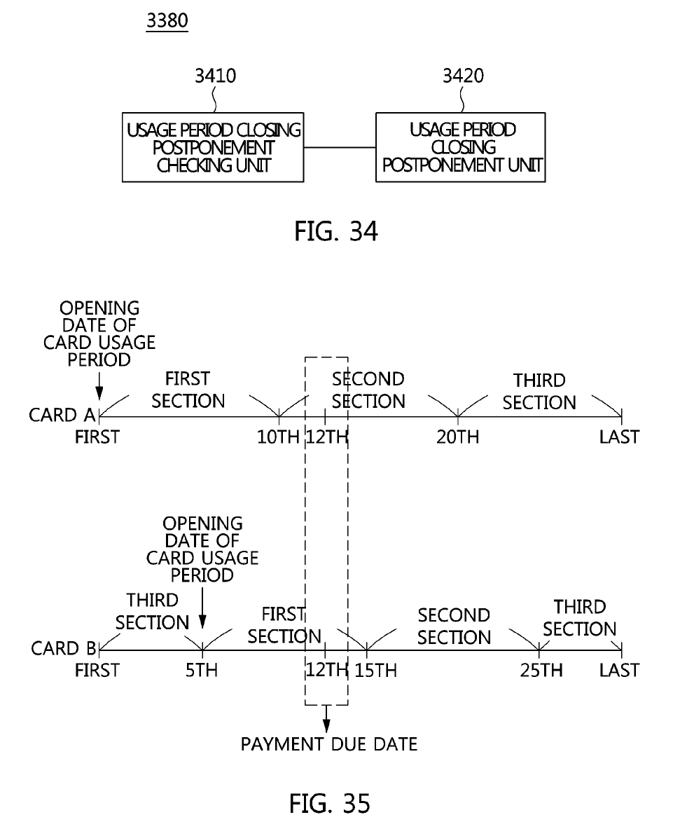

FIG. 34 is a block diagram showing in detail the card recommendation unit shown in FIG. 33.

Referring to FIG. 34, the card recommendation unit 3380 shown in FIG. 33 includes a usage period closing postponement checking unit 3410 and a usage period closing postponement unit 3420.

The usage period closing postponement checking unit 3410 checks whether, among multiple cards, at least one card for which the usage record in the current month has not yet reached the target usage record has a possibility of the closing date of a card usage period being postponed when the payment section is the third section.

For example, it may be assumed that the target usage record of card A corresponds to 300,000 Won, and the usage record in the current month of card A corresponds to 290,000 Won, and that only a single day remains until the closing date of the card usage period. In this case, the closing date of the card usage period is postponed by four or five days, thus allowing the user to naturally use an amount remaining until the target usage record is reached, with the result that the target usage record of card A may be achieved. Therefore, card A may be classified as a card having a possibility of the closing date of the card usage period being postponed.

As another example, it may be assumed that the target usage record of card B corresponds to 400,000 Won, that the usage record in the current month of card B corresponds to 100,000 Won, and that three days remain until the closing date of the card usage period. In this case, even if the closing date of the card usage period is postponed to some extent, the amount remaining until the target usage record is achieved is large, and thus a possibility of the target usage record being achieved may be low. Therefore, card B may be classified as a card having no possibility of the closing date of the card usage period being postponed.

In this case, among the one or more cards, the optimal card may be recommended in consideration of the usage record in the current month, which is expected when the closing date of the card usage period of the card having a possibility of the closing date of the card usage period being postponed is postponed. That is, when an optimal card is recommended, the card that is expected not to achieve a target usage record because the closing date of the card usage period is approaching may be excluded from the candidates to be recommended as an optimal card. However, the card that has been excluded from the candidates may be considered again if the closing date of the card usage period is postponed. Therefore, the usage record in the current month that may be obtained when the closing date of the card usage period is postponed may be predicted, and thus an optimal card may be recommended in consideration of the predicted usage record in the current month.

At this time, when the remaining amount required to reach the target usage record of at least one card is less than a reference remaining amount that is preset based on the purchasing pattern of the user, it may be determined that the card has a possibility of the closing date of a card usage period being postponed.

For example, it may be assumed that the target usage record of card D corresponds to 300,000 Won, that the usage record in the current month corresponds to 250,000 Won. Further, the current date is the 28th of the month, and the closing date of the card usage period of the card is the 30th of each month. When the closing date of the card usage period is postponed, it may be postponed up to the fifth of each month. Here, the purchasing pattern of the user may be checked, and the amount of the payment that is expected to be made by the user in an interval ranging from the 28th to the fifth day of the next month may be set to the reference remaining amount.

Therefore, when the set reference remaining amount is greater than 50,000 Won, which is the remaining amount required to reach the target usage record, that is, when the amount of the payment expected to be made by the user before the postponed closing date of the card usage period is greater than the remaining amount required to reach the target usage record, card D is determined to be able to achieve the target usage record when the closing date of the card usage period is postponed, and it may be determined that card D has a possibility of the closing date of the card usage period being postponed.

In contrast, when the set reference remaining amount is less than 50,000 Won, which is the remaining amount required to reach the target usage record, that is, when the amount of the payment expected to be made by the user before the postponed closing date of the card usage period is less than the remaining amount required to reach the target usage record, it may be determined that card D cannot achieve the target usage record even if the closing date of the card usage period is postponed, and then it may be determined that that card D has no possibility of the closing date of the card usage period being postponed.

The usage period closing postponement unit 3420 is configured to, when the card having a possibility of the closing date of the card usage period being postponed is recommended as an optimal card, postpone the closing date of the card usage period of the optimal card by delaying the opening date of the card usage period.

In this case, the closing date of the card usage period denotes the last day of a usage record determination period for the corresponding card, and the day after the closing date of the card usage period may correspond to the opening date of a new card usage period during which the calculation of a usage record is newly performed.

Therefore, when the opening date of a card usage period is delayed, the closing date of the card usage period may also be postponed, and thus the closing date of the card usage period may be adjusted by changing the opening date of the card usage period. Alternatively, the closing date of the card usage period may be postponed by adjusting the closing date itself.

Here, the closing date of the card usage period may be postponed within a predetermined range. For example, there are the cases where the payment due dates or the card usage period opening dates of respective cards are designated for respective card companies. In other words, generally, various dates, such as the first, 10th, 25th or last day of each month, may be designated and one of the designated dates may be selected and used. Therefore, if there is a designated date even when the closing date of a card usage period is changed, the closing date may be changed and postponed in accordance with the designated date.

FIG. 35 is a diagram showing sections obtained by dividing a usage record determination period according to an embodiment of the present invention.

Referring to FIG. 35, the usage record determination period according to the embodiment of the present invention may be determined differently depending on the opening dates of card usage periods for respective cards.

For example, referring to the usage record determination periods of card A and card B shown in FIG. 35, the opening date of the card usage period of card A is the first day of each month, and thus a period ranging from the first to the last day of the month may correspond to the usage record determination period. However, the opening date of the card usage period of card B is the fifth of each month, and thus a period ranging from the fifth of this month to the fourth of the next month may correspond to the usage record determination period.

In this way, since usage record determination periods differ from each other depending on the opening dates of card usage periods, cards having different card usage period opening dates may be configured so as to divide their usage record determination periods into different sections.

That is, in the case of card A, the usage record determination period may be divided into sections such that an interval ranging from the first of the month, which is the opening date of the card usage period, to the 10th is the first section, an interval ranging from the 11th to the 20th of the month is the second section, and an interval ranging from the 21st to the last of the month is the third section. In contrast, even if the usage record determination period of card B is divided in the same way as card A, it may be divided into sections such that an interval ranging from the fifth of the month, which is the opening date of the card usage period, to the 15th is the first section, an interval ranging from the 16th to the 25th is the second section, and an interval ranging from the 26th of the month to the fourth of the next month is the third section.

Therefore, assuming that the current date, on which the user enters a store, is the 12th, the date may correspond to the second section of card A, but the date may correspond to the first section of card B. Therefore, when a recommendation algorithm depending on the payment section is applied, recommendation priority may be assigned to card A based on the recommendation algorithm corresponding to the second section, and recommendation priority may be assigned to card B based on the recommendation algorithm corresponding to the first section.

For example, it may be assumed that an algorithm for recommending an optimal card in consideration of benefits is used in the first section of payment sections for respective cards, an algorithm for recommending an optimal card in consideration of both benefits and the usage record in the current month is used in the second section, and an algorithm for recommending an optimal card in consideration of the usage record in the current month is used in the third section. Here, since the payment due date of card A corresponds to the second section, it is determined whether card A is the target to be recommended in consideration of both benefits and the usage record in the current month. Since the payment due date of card B corresponds to the first section, it may be determined whether card B is the target to be recommended in consideration of only benefits.

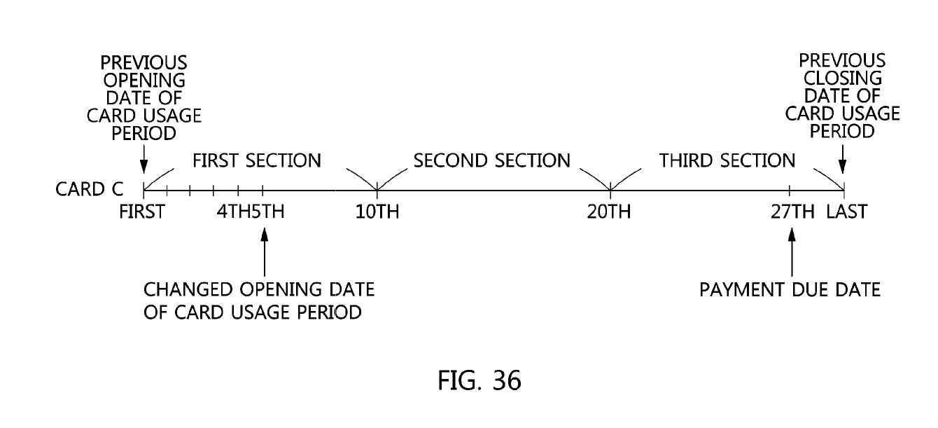

FIG. 36 is a diagram showing a scheme for postponing the closing date of a card usage period according to an embodiment of the present invention.

Referring to FIG. 36, since the previous opening date of the card usage period of card C is the first day of each month, it may be determined that the previous closing date of the card usage period is the last day of each month.

Here, it may be assumed that a payment due date is the 27th and corresponds to the third section, and that a usage record in the current month of card C has not yet reached a target usage record.

For example, when the target usage record of card C corresponds to 300,000 Won and the usage record in the current month of card C corresponds to 250,000 Won, the user may be provided with benefits using card C in the next month only when a payment amount of 50,000 Won is further spent using card C during the period from the 27th to the last day of the month.

In this situation, purchasing unnecessary commodities to achieve the target usage record may instead be a waste. Therefore, the present invention may postpone the previous closing date of the card usage period so as to provide the temporal margin required by the user in order to purchase a necessary commodity.

Referring to FIG. 36, it can be seen that the previous opening date of a card usage period is the first of each month, but that the new opening date of the card usage period has been postponed to the 5th of each month. That is, assuming that the previous payment due date is the 27th, it may be determined that the closing date of the card usage period is postponed to the 4th, which the day just before the changed opening date of the card usage period.

Therefore, since only a time period of two or three days, which remain to achieve the target usage record of card C may be prolonged to seven or eight days, the user does not need to purchase unnecessary commodities in order to quickly achieve the target usage record.

Here, because the opening date of the card usage period has changed, the multiple sections corresponding to the usage record determination period may also change. That is, in FIG. 36, if, in the existing scheme, the interval ranging from the first to the 10th of the month is the first section, the interval ranging from the 11th to the 20th of the month is the second section, and the interval ranging from the 21st to the last day of the month is the third section, the multiple sections may be changed such that the interval ranging from the 5th to 14th of the month is the first section, the interval ranging from the 15th to 24th of the month is the second section, and the interval ranging from the 25th of the month to the 4th of the next month is the third section after the opening date of the card usage period is changed to the 5th of the month.

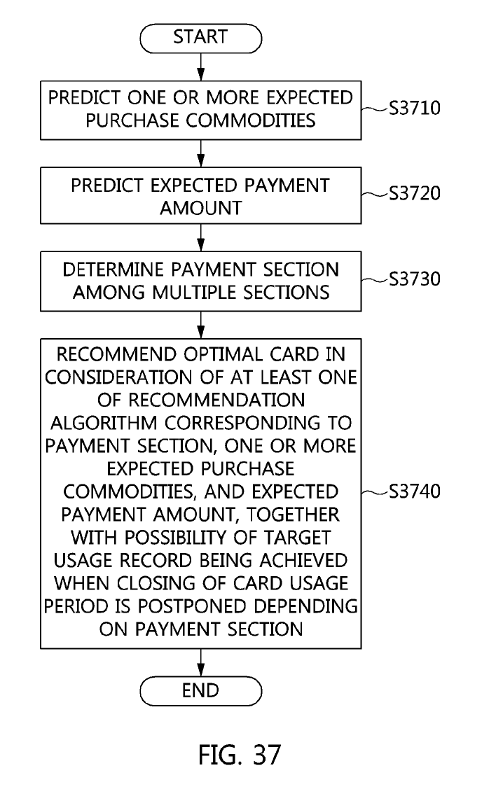

FIG. 37 is an operation flowchart showing an optimal card recommendation method using the postponement of card usage period closing according to an embodiment of the present invention.

Referring to FIG. 37, the optimal card recommendation method using the postponement of card usage period closing according to the embodiment of the present invention is an optimal card recommendation method performed by the optimal card recommendation apparatus using the postponement of card usage period closing. The optimal card recommendation method predicts one or more purchase commodities that are expected to be purchased by the user at a store S3710. That is, conventional card recommendation technology is configured to recommend an optimal payment card and an optimal membership card in consideration of information about the type and price of the corresponding commodity to be purchased by the user in the state in which the commodity to be purchased by the user has been fixed. Thus, the conventional card recommendation technology merely enables a card to be recommended only when the user enters information about the commodity to be purchased through the application, or only when commodity information is provided through the POS device at the store. However, such card recommendation technology cannot provide a particular advantage except for convenience in that information about the card to be used for payment is provided when the user purchases a commodity through the POS device.

In contrast, the present invention predicts in advance commodities expected to be purchased by the user and recommends a card in the state in which the commodity to be purchased by the user at the store is not yet fixed, thus providing assistance in further simplifying and facilitating the procedure in which the user actually performs payment through the POS device.

Here, one or more commodities expected to be purchased may be predicted in consideration of at least one of the purchasing pattern of the user in an affiliated store group corresponding to the store, the purchasing pattern of a user group identical to the user in the affiliated store group, benefit information provided by each store, and the utilization of benefits by the user.

In an embodiment, the purchasing patterns of the user for respective affiliated store groups may be generated using information, such as the types of commodities purchased by the user in each affiliated store group, which sells household items, the time of the purchase, or the price range of purchased commodities.

In another embodiment, based on the age, gender, occupation, and preference information of the user, a user group may be generated based on other users corresponding to information similar to the above information, and the purchasing pattern of the corresponding user group may be generated and may be used to predict commodities that are expected to be purchased.

In a further embodiment, information about the store visited by the user may be obtained, and benefit information currently provided by the store, that is, information about discounted commodities, commodities corresponding to a Buy-One-Get-One-Free (BOGOF) offer, or commodities available for a limited time, may be obtained and used to predict the commodities that are expected to be purchased.

In yet another embodiment, commodities expected to be purchased may be predicted in consideration of how the user has utilized benefits obtained from the purchase of commodities. That is, benefit information preferred by the user between discounts and accumulation may be considered, or a usage pattern for accumulated points may be considered when the commodities expected to be purchased are predicted.

Here, unnecessary commodity items may be detected in consideration of at least one of information about the commodity most recently purchased by the user in the affiliated store group and the time of the purchase, and may be excluded when one or more commodities expected to be purchased are predicted.

For example, when there is a commodity purchased by the user in an affiliated store group identical to a specific store before the user visits the specific store, there is a low probability that the user will purchase the corresponding commodity at the current store. Therefore, when the commodity expected to be purchased at the current store is predicted, the commodity previously purchased in the same affiliated store group may be recognized as an unnecessary commodity item, and may be excluded from the commodities expected to be purchased.

In still another embodiment, when there is a commodity purchased by the user in an affiliated store group identical to a specific store before the user visits the specific store, the commodity may instead be predicted to be the commodity expected to be purchased in consideration of the time at which the corresponding commodity was purchased and whether the commodity is discounted or not. That is, assuming that hair gel is on sale at a discount price at a hair product shop visited by the user, and the user purchased the hair gel one month ago, there may be a high probability that the user will purchase the hair gel owing to the benefits of the discount price at this visit.

Further, the optimal card recommendation method using the postponement of card usage period closing according to the embodiment of the present invention predicts the amount of the payment that is expected to be made by the user at the store at step S3720.

Here, the reason for additionally predicting an expected payment amount as well as an expected purchase commodity so as to recommend an optimal card is that there may be benefits that are provided when a predetermined amount or more is paid at each store. Therefore, the amount required to purchase a commodity, that is, the payment amount, may be a very important factor in recommending a card. For example, assuming that a discount benefit is provided when commodities corresponding to more than 100,000 Won are purchased with a specific payment card at a store visited by the user, a payment amount for purchase commodities, which are expected to be purchased by the user at the corresponding store, is predicted to reach an amount of 100,000 Won, thus allowing the user to obtain more benefits.

Here, the expected payment amount may be predicted in consideration of at least one of the purchasing pattern of the user, information about the amount of the purchase by a single user at the store, and information about the amount of each purchase by a user group identical to the user in an affiliated store group.

In an embodiment, when the purchasing pattern of the user, which was considered when the expected purchase commodity was predicted, is used, information about the prices of commodities to be purchased by the user may be acquired, and thus the expected payment amount may be predicted in consideration of the purchasing pattern of the user.

In another embodiment, an expected payment amount may be predicted using information about the average purchase amount by a single user at the store visited by the user.

In a further embodiment, whether the store visited by the user is a jewelry shop which sells relatively expensive goods, or a grocery shop which sells relatively cheap goods, is determined, and information about the amount of each purchase in the corresponding affiliated store group may be considered. Further, whether a user is a student, a housewife, or an office worker is determined, and thus information about the amount of each purchase by a user group identical to the user may be considered. That is, in the cases where the user is a student and where the user is an office worker, there may be a great difference in consumption tendencies, and thus an expected payment amount may be predicted in consideration of the purchase amount information based on the user group.

Further, although not shown in FIG. 37, the optimal card recommendation method using the postponement of card usage period closing according to the embodiment of the present invention determines whether to match the one or more expected purchase commodities with the expected payment amount by comparing the total amount of one or more expected purchase commodities with the expected payment amount. For example, assuming that the expected payment amount is predicted to be excessively high compared to the number of the one or more expected purchase commodities, there is the possibility that the reliability of the recommended card may be deteriorated because the tendencies of two conditions that are considered when recommending an optimal card are different from each other. Therefore, it is possible to compare the total amount obtained by summing the prices of one or more expected purchase commodities with the expected payment amount, and to determine to match the expected purchase commodities with the expected payment amount if it is determined that a difference is present between the total amount and the expected payment amount. Then, an algorithm for performing matching may be executed.

Further, if it is determined that the total amount is relatively similar to the expected payment amount when comparing the total amount with the expected payment amount, matching is not performed, and the expected payment amount may be used as a reference value that is considered when recommending an optimal card.

At this time, when the difference between the total amount and the expected payment amount is equal to or greater than a preset reference difference, it may be determined that matching is to be performed. For example, when the preset reference difference is 30,000 Won, matching may be performed when the difference between the total amount and the expected payment amount is 30,000 Won or more.

Here, the preset reference difference may be set to different values depending on affiliated store groups. For example, the reference difference in an affiliated store group that sells expensive commodities is set to a value larger than that of the reference difference in an affiliated store group that sells relatively inexpensive commodities, thus preventing unnecessary matching from being performed. Further, the reference difference in an affiliated store group that sells inexpensive commodities is set to a smaller value, thus improving the accuracy of the algorithm for recommending an optimal card.

Furthermore, although not shown in FIG. 37, the optimal card recommendation method using the postponement of card usage period closing according to the embodiment of the present invention is configured to, when performing matching between the one or more expected purchase commodities and the expected payment amount, adjust any one of the expected payment amount and the one or more expected purchase commodities, and then match the one or more expected purchase commodities with the expected payment amount. That is, in order to reduce the difference between the total amount of the one or more expected purchase commodities and the expected payment amount, any one of the total amount and the expected payment amount may be adjusted.

Here, when the total amount is greater than the expected payment amount, a commodity having a low probability of being purchased is first excluded from the one or more expected purchase commodities, and thus the total amount may be adjusted to match the expected payment amount. For example, it may be assumed that there are 10 expected purchase commodities, that the total amount is greater than the expected payment amount, and that the difference between the total amount and the expected payment amount is greater than a preset reference difference by 50,000 Won. In this case, it is determined that an unnecessary commodity is further included in the expected purchase commodities, the probabilities of being purchased are determined for 10 respective expected purchase commodities, and the commodity having the lowest probability of being purchased may be excluded first.

Further, when the total amount is less than the expected payment amount, the expected payment amount is adjusted to match the total amount, and thus the one or more expected purchase commodities may match the expected payment amount. For example, it may be assumed that there are five expected purchase commodities, that the total amount is less than the expected payment amount, and that the difference between the total amount and the expected payment amount is greater than a preset reference difference by 50,000 Won. In this case, it is preferable to recommend a card using a method for adjusting the expected payment amount to match the total amount, rather than using a method for adding a commodity having a low probability of being purchased to the expected purchase commodities for the additional purchase of the commodity. That is, since the probability that the user will purchase an unnecessary commodity is low, the accuracy of the algorithm for recommending a card may be improved by decreasing the expected payment amount.

Furthermore, although not shown in FIG. 37, the optimal card recommendation method using the postponement of card usage period closing according to the embodiment of the present invention application checks the opening dates of card usage periods of multiple cards registered in the application, and divides each of the usage record determination periods corresponding to one month from the card usage period opening dates into a plurality of sections. For example, assuming that the opening date of the card usage period is the first day of each month, the usage record determination period may be divided into sections such that an interval ranging from the opening date to ⅓ of the usage record determination period is a first section, an interval ranging from the end of the first section to ⅔ of the usage record determination period is a second section, and an interval corresponding to the remaining ⅓ of the usage record determination period is a third section.

Here, since the opening dates of card usage periods of respective cards may be different from each other, the usage record determination periods may be divided into multiple sections in different ways for multiple respective cards.

In this case, separate recommendation algorithms may be applied to respective sections. For example, an algorithm for recommending an optimal card in consideration of benefits may be applied to the first section, an algorithm for recommending an optimal card in consideration of both benefits and the card usage record in the current month may be applied to the second section, and an algorithm for recommending an optimal card in consideration of only the card usage record in the current month may be applied to the third section. Further, when the card usage record is considered, as in the case of the second section or the third section, a card may also be recommended in consideration of the usage record in the future by operating in conjunction with other applications, such as the calendar or housekeeping book of the user terminal.

Further, recommendation factors, such as discounts or accumulation, the achievement rate of the usage record in the current month, or the non-achievement rate of the usage record in the current month, are designated for respective sections to which recommendation algorithms are applied, and weights may be differently set for respective recommendation factors. Furthermore, weights for respective recommendation factors may be set differently for respective cards. For example, the weights of discounts and accumulation for card A may be set to values greater than those of card B.

In this case, the multiple sections may be variously set and divided depending on the optimal card recommendation system.

Here, cards having the same card usage period opening date, among the multiple cards, may be grouped, and then one or more card groups may be generated. For example, it may be assumed that five credit cards corresponding to A to E are registered in the application and that the opening dates of card usage periods of cards A to C are the first day of each month, but the opening dates of card usage periods of cards D and E are the 11th of each month. Here, cards A, B, and C may be grouped to generate a first card group, and cards D and E may be grouped to generate a second card group.

In this case, the usage record determination period corresponding to each of the one or more card groups may be divided into multiple group-based sections. That is, in the above example, since the opening date of the card usage period for the first card group is the first day of each month, the usage record determination period may be divided into multiple sections such that an interval ranging from the first to the 10th of the month is a first section, an interval ranging from the 11th to the 20th is a second section, and an interval ranging from the 21st to the last day is a third section. Further, since the opening date of the card usage period for the second card group is the 11th of each month, the usage record determination period may be divided into multiple sections such that an interval ranging from the 11th to the 20th of the month is a first section, an interval ranging from the 21st to the last day is a second section, and an interval ranging from the first to the 10th is a third section.

Furthermore, the optimal card recommendation method using the postponement of card usage period closing according to the embodiment of the present invention determines a payment section corresponding to the current date, among the multiple sections corresponding to the usage record determination period, at step S3730. That is, among the multiple sections, the section in which the current date, on which the user enters the store, falls may be determined.

Furthermore, the optimal card recommendation method using the postponement of card usage period closing according to the embodiment of the present invention recommends an optimal card, among multiple cards registered in the application, in consideration of at least one of a recommendation algorithm corresponding to the payment section, the one or more expected purchase commodities, and the expected payment amount, and especially recommends the optimal card by additionally considering a possibility of a target usage record being achieved when the closing of a card usage period is postponed depending on the payment section at step S3740.

Here, weights for recommendation are respectively assigned to the recommendation algorithm corresponding to the payment section, the one or more expected purchase commodities, and the expected payment amount, and the card for which the sum of the individual weights is the largest may be recommended as an optimal card.

Here, the multiple cards may include payment cards such as a cash card, a debit card, and a credit card for payment. Further, the multiple cards may include a membership card, a cash-back card, and a discount card, which enable points to be accumulated or a discount to be provided when commodities are purchased.

Here, the application may include a mobile payment application, a mobile electronic wallet application, etc., which register the card information of the user and allow the terminal to perform payment using the card information.

Here, when the payment section is the first section among the multiple sections, an optimal card may be recommended among the multiple cards in consideration of benefits. When the payment section is the second section among the multiple sections, an optimal card may be recommended among the multiple cards in consideration of both benefits and the usage record in the current month. When the payment section is the third section among the multiple sections, an optimal card may be recommended among the multiple cards in consideration of the usage record in the current month.

At this time, the first section may be a section corresponding to a first part of the usage record determination period, the second section may be a section corresponding to the middle part of the usage record determination period, and the third section may be a section corresponding to the last part of the usage record determination period.

Therefore, since the first section is not yet the time during which the usage record in the current month is to be considered, the card that provides the maximum benefits may be recommended as an optimal card in consideration of benefits such as discounts or accumulation.

Further, in the second section, a card which provides more benefits, among cards for which the usage records in the current month have not yet reached target usage records, may be recommended as an optimal card in consideration of the usage record in the current month together with benefits. For example, it may be assumed that, when payment is performed using card A, for which the usage record in the current month has reached the target usage record, a discount benefit of 1,000 Won may be obtained, and that when payment is performed using card B, for which the usage record in the current month has not yet reached the target usage record, a discount benefit 800 Won may be obtained. Here, when an optimal card is recommended by assigning a weight to the usage record in the current month for card B, card B may be recommended as an optimal card even if the discount amount of card B is lower than that of card A by 200 Won.

Furthermore, in the third section, a card for which the usage record in the current month is expected to reach the target usage record during the period remaining until the opening date of the next card usage period may be recommended as an optimal card, among cards for which usage records in the current month have not yet reached the target usage records, in consideration of the usage record in the current month. For example, it may be assumed that when payment is performed using card C, for which 100,000 Won remains in order for the usage record in the current month to reach the target usage record, a discount benefit of 500 Won may be obtained, and when payment is performed using card D, for which 10,000 Won remains in order for the usage record in the current month to reach the target usage record, a discount benefit of 300 Won is obtained. Here, assuming that the same period of three days remains until the opening dates of the card usage periods of card C and card D, card D, which is expected to reach the target usage record in the remaining three days based on the payment pattern of the user, may be recommended as the optimal card even if a 200-Won discount is not immediately obtained.

In this case, when the payment section corresponds to the third section, a possibility that the closing date of the card usage period of at least one card for which a usage record in the current month has not yet reached a target usage record may be postponed may be checked.

For example, it may be assumed that the target usage record of card A corresponds to 300,000 Won, and the usage record in the current month of card A corresponds to 290,000 Won, and that only a single day remains until the closing date of the card usage period. In this case, the closing date of the card usage period is postponed by four or five days, thus allowing the user to naturally use an amount remaining until the target usage record is reached, with the result that the target usage record of card A may be achieved. Therefore, card A may be classified as a card having a possibility of the closing date of the card usage period being postponed.

As another example, it may be assumed that the target usage record of card B corresponds to 400,000 Won, that the usage record in the current month of card B corresponds to 100,000 Won, and that three days remain until the closing date of the card usage period. In this case, even if the closing date of the card usage period is postponed to some extent, the amount remaining until the target usage record is achieved is large, and thus a possibility of the target usage record being achieved may be low. Therefore, card B may be classified as a card having no possibility of the closing date of the card usage period being postponed.

In this case, among the one or more cards, the optimal card may be recommended in consideration of the usage record in the current month, which is expected when the closing date of the card usage period of the card having a possibility of the closing date of the card usage period being postponed is postponed. That is, when an optimal card is recommended, the card that is expected not to achieve a target usage record because the closing date of the card usage period is approaching may be excluded from the candidates to be recommended as an optimal card. However, the card that has been excluded from the candidates may be considered again if the closing date of the card usage period is postponed. Therefore, the usage record in the current month that may be obtained when the closing date of the card usage period is postponed may be predicted, and thus an optimal card may be recommended in consideration of the predicted usage record in the current month.

Here, when the card having a possibility of the closing date of the card usage period being postponed is recommended as an optimal card, the closing date of the card usage period may be postponed by delaying the opening date of the card usage period of the optimal card.

In this case, the closing date of the card usage period denotes the last day of a usage record determination period for the corresponding card, and the day after the closing date of the card usage period may correspond to the opening date of a new card usage period during which the calculation of a usage record is newly performed.

Therefore, when the opening date of a card usage period is delayed, the closing date of the card usage period may also be postponed, and thus the closing date of the card usage period may be adjusted by changing the opening date of the card usage period. Alternatively, the closing date of the card usage period may be postponed by adjusting the closing date itself.

Here, the closing date of the card usage period may be postponed within a predetermined range. For example, there are the cases where the payment due dates or the card usage period opening dates of respective cards are designated for respective card companies. In other words, generally, various dates, such as the first, 10th, 25th or last day of each month, may be designated and one of the designated dates may be selected and used. Therefore, if there is a designated date even when the closing date of a card usage period is changed, the closing date may be changed and postponed in accordance with the designated date.

At this time, when the remaining amount required to reach the target usage record of at least one card is less than a reference remaining amount that is preset based on the purchasing pattern of the user, it may be determined that the card has a possibility of the closing date of a card usage period being postponed.

For example, it may be assumed that the target usage record of card D corresponds to 300,000 Won, that the usage record in the current month corresponds to 250,000 Won. Further, the current date is the 28th of the month, and the closing date of the card usage period of the card is the 30th of each month. When the closing date of the card usage period is postponed, it may be postponed up to the fifth of each month. Here, the purchasing pattern of the user may be checked, and the amount of the payment that is expected to be made by the user in an interval ranging from the 28th to the fifth day of the next month may be set to the reference remaining amount.

Therefore, when the set reference remaining amount is greater than 50,000 Won, which is the remaining amount required to reach the target usage record, that is, when the amount of the payment expected to be made by the user before the postponed closing date of the card usage period is greater than the remaining amount required to reach the target usage record, card D is determined to be able to achieve the target usage record when the closing date of the card usage period is postponed, and it may be determined that card D has a possibility of the closing date of the card usage period being postponed.

In contrast, when the set reference remaining amount is less than 50,000 Won, which is the remaining amount required to reach the target usage record, that is, when the amount of the payment expected to be made by the user before the postponed closing date of the card usage period is less than the remaining amount required to reach the target usage record, it may be determined that card D cannot achieve the target usage record even if the closing date of the card usage period is postponed, and then it may be determined that that card D has no possibility of the closing date of the card usage period being postponed.

Here, when the payment section is the first section, and there are cards having the same benefits, among multiple cards, an optimal card may be recommended in the sequence of usage records in the current month from lowest to highest usage records. When the payment section is the second section, and there are cards having the same benefits, among the multiple cards, an optimal card may be recommended in the sequence of usage records in the current month from closest to farthest from target usage records for respective cards. That is, when there are cards for which recommendation criteria for respective sections are identical to each other, the usage record in the current month may be accumulated by prompting the user to primarily use a card having a low usage record in the current month in the first section. Further, a card for which the usage record has not yet reached the target usage record, but is expected to reach the target usage record because the usage record in the current month is high, may be recommended in the second section.

In this case, it is possible to determine which one of the multiple sections corresponds to the payment section, select one or more group-based optimal cards from each of one or more card groups, and recommend an optimal card, among the one or more group-based optimal cards, in consideration of at least one of the benefits and the usage record in the current month.

For example, it may be assumed that cards A, B, and C are included in the first card group, the opening date of the card usage period of which is the first day of each month, and that cards D and E are included in the second card group, the opening date of the card usage period of which is the 11th of each month. Here, it may also be assumed that, for the first card group, the first section may range from the first to the 10th of the month, the second section may range from the 11th to the 20th, and the third section may range from the 21st to the last day, and for the second card group, the first section may range from the 11th to the 20th, the second section may range from the 21st to the last day, the third section may range from the first to the 10th, and a payment due date is the 12th. At this time, in the first card group, the payment due date may fall within the second section, and in the second card group, the payment due date may fall within the first section. Therefore, in the first card group, one of cards A, B, and C may be selected based on the recommendation algorithm applied to the second section, and in the second card group, one of cards D and E may be selected based on the recommendation algorithm applied to the first section.

First, assuming that card A is selected from the first card group and that card D is selected from the second card group, one of the selected cards may be recommended as an optimal card in consideration of at least one of the benefits of cards A and D and the usage records in the current month for cards A and D.

Here, among one or more payment cards included in the multiple cards, an optimal payment card may be recommended.

In an embodiment, since discount or accumulation rates may differ from each other depending on whether the payment card is a credit card, a cash card or a debit card, the discount rates and accumulation rates for respective types of payment cards may be checked, and the card having the maximum benefits may be recommended as the optimal payment card when the payment section of the corresponding card is a section in which benefits are considered depending on the payment sections of respective payment cards.

In another embodiment, discount rates or accumulation rates for respective card companies and banks corresponding to credit cards or debit cards may differ. Thus, the discount rates and accumulation rates for respective card companies and banks may be checked so as to recommend an optimal card.

In a further embodiment, since the benefits of respective credit cards or debit cards may be provided differently depending on the card usage record in the previous month, an optimal card may be recommended by additionally considering whether the card usage record in a previous month has been achieved.

Further, among one or more membership cards included in the multiple cards, an optimal membership card may be recommended together with the optimal payment card.

For example, when an optimal payment card is recommended, a membership card, which can be used together with the recommended payment card and can be used at the corresponding store, is recommended together with the payment card, thus allowing the user to be sufficiently provided with the benefits of discounts and accumulation without missing the benefits.

Furthermore, when it is possible to purchase a commodity using points accumulated in a membership card, the corresponding membership card may be included in a card recommendation list for payment and may also be recommended. In addition, when payment using points is possible according to the setting of the user, the recommendation priority of the corresponding membership card is designated to be higher than that of a credit card or a debit card, and then the membership card may be primarily recommended.

Here, information about an optimal payment card and an optimal membership card may be provided together through the application. For example, information about the optimal membership card that matches information about the optimal payment card may be displayed together on a single screen of the application. Alternatively, when the optimal payment card is clicked, optimal membership cards that can be used together with the clicked optimal payment card may be provided in the form of a list in descending order of benefit amount.

Furthermore, although not shown in FIG. 37, in the optimal card recommendation method using the postponement of card usage period closing according to the embodiment of the present invention, the optimal card recommendation transmits and receives information required to recommend an optimal card to and from the terminal of the user over a communication network, such as a typical network, through a separate communication module. In particular, the communication module according to the embodiment of the present invention may receive information required to predict the one or more expected purchase commodities and the expected payment amount from the terminal, and may provide information corresponding to the optimal card to the terminal. Further, information about the opening dates of card usage periods for respective cards registered in the application may be received through the homepages of respective card companies connected to the application server.

Here, information required to predict the one or more expected purchase commodities and the expected payment amount may be received from a separate application server. For example, user information, such as the purchase information, personal information, possessed payment card information, and possessed membership card information of the user, and various types of information, pertaining for example to events, discounts, and marketing information provided by the corresponding store, may be received.

Furthermore, although not shown in FIG. 37, the optimal card recommendation method using the postponement of card usage period closing according to the embodiment of the present invention stores various types of information, generated during a procedure for providing the optimal card recommendation service according to an embodiment of the present invention, as described above, in a storage module.

Here, the storage module may be implemented independently of the optimal card recommendation apparatus to support a function for the optimal card recommendation service. Here, the storage module may function as separate large-capacity storage, and may include a control function for performing operations.

By means of such an optimal card recommendation method, when the user pays for a commodity at a store using his or her mobile terminal, an automatic payment service may be used using a payment card that is recommended in advance.

Further, a payment card and a membership card that allow the user to obtain the maximum benefits, such as discounts or accumulation, are recommended depending on the commodities expected to be purchased by the user and the amount of the payment expected to be made by the user, thus inducing the user to consume appropriately and helping the user make reasonable purchases.

Furthermore, the number of operations required by the user to pay at the store using the mobile terminal may be minimized, and thus there is an advantage in that the convenience of the user may be maximized when commodities are purchased.

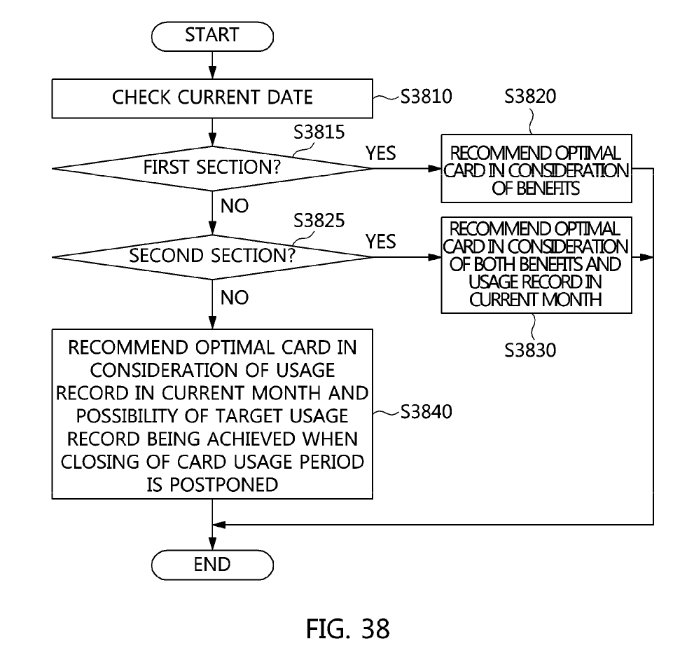

FIG. 38 is a diagram showing in detail a procedure for determining recommendation algorithms depending on payment sections in the optimal card recommendation method using the postponement of card usage period closing according to an embodiment of the present invention.

Referring to FIG. 38, the procedure for determining recommendation algorithms depending on payment sections in the optimal card recommendation method using the postponement of card usage period closing according to the embodiment of the present invention checks the current date on which the user enters a store at step S3810.

Next, it is determined whether the current date falls within a first section, among the multiple sections corresponding to the usage record determination period, at step S3815.

Here, the usage record determination period may be divided into multiple sections based on the opening dates of card usage periods of the multiple cards registered in the application. For example, assuming that the opening date of the card usage period is the first day of each month, the usage record determination period may be divided into sections such that an interval ranging from the opening date to ⅓ of the usage record determination period is a first section, an interval ranging from the end of the first section to ⅔ of the usage record determination period is a second section, and an interval corresponding to the remaining ⅓ of the usage record determination period is a third section.

Here, since the opening dates of card usage periods of respective cards may be different from each other, the usage record determination periods may be divided into multiple sections in different ways for multiple respective cards.

In this case, separate recommendation algorithms may be applied to respective sections. For example, an algorithm for recommending an optimal card in consideration of benefits may be applied to the first section, an algorithm for recommending an optimal card in consideration of both benefits and the card usage record in the current month may be applied to the second section, and an algorithm for recommending an optimal card in consideration of only the card usage record in the current month may be applied to the third section. Further, when the card usage record is considered, as in the case of the second section or the third section, a card may also be recommended in consideration of the usage record in the future by operating in conjunction with other applications, such as the calendar or housekeeping book of the user terminal.

If it is determined at step S3815 that the current date falls within the first section, an optimal card is recommended in consideration of benefits, together with the expected purchase commodities and the expected payment amount, at step S3820.

If it is determined at step S3815 that the current date does not fall within the first section, it is determined whether the current date falls within a second section, among the multiple sections corresponding to the usage record determination period, at step S3825.

If it is determined at step S3825 that the current date falls within the second section, an optimal card is recommended in consideration of both benefits and the usage record in the current month, together with the expected purchase commodities and the expected payment amount, at step S3830.

If it is determined at step S3825 that the current date does not correspond to the second section, it is determined that the current date corresponds to the third section, among the multiple sections corresponding to the usage record determination period, and an optimal card is recommended in consideration of both the usage record in the current month and a possibility that the target usage record may be achieved when the closing of a card usage period is postponed, together with the expected purchase commodities and the expected payment amount, at step S3840.

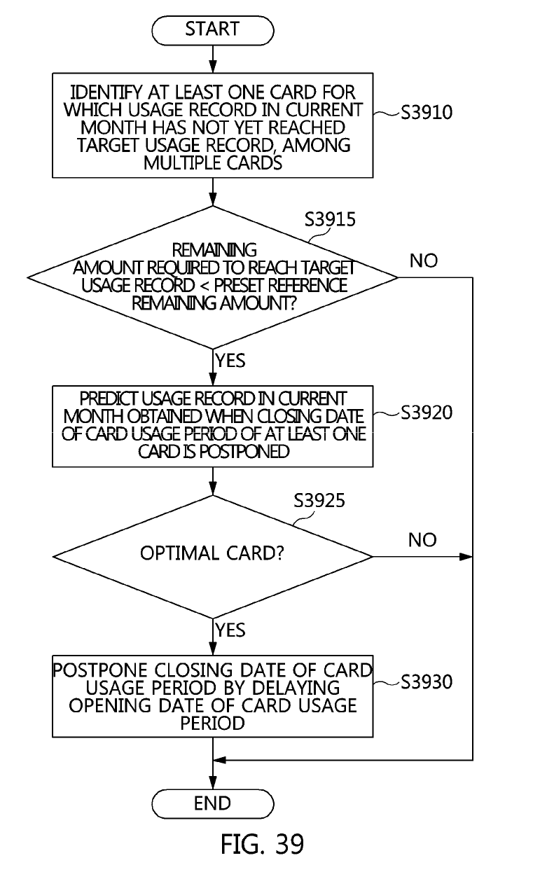

FIG. 39 is a flow diagram showing in detail a procedure for postponing the closing date of the card usage period of the optimal card in the optimal card recommendation method using the postponement of card usage period closing according to an embodiment of the present invention.

Referring to FIG. 39, the procedure for postponing the closing date of the card usage period of the optimal card in the optimal card recommendation method using the postponement of card usage period closing according to the embodiment of the present invention identifies at least one card for which a usage record in the current month has not yet reached a target usage record, among multiple cards, at step S3910.

Here, the payment section corresponding to the payment time may be the last of multiple sections corresponding to the usage record determination period. For example, when the usage record determination period is divided into multiple sections, specifically, a first section, a second section, and a third section, the payment section of FIG. 39 may be the third section.

Therefore, an optimal card may be recommended in consideration of usage records in the current month for the multiple cards, and at least one card for which a usage record in the current month has not yet reached the target usage record may be separately identified in order to consider the possibility that the usage record in the current month may reach the target usage record when the closing of the card usage period is postponed.

Thereafter, it is determined whether the remaining amount required to reach the target usage record of the at least one card is less than a preset reference remaining amount at step S3915.

In this case, the preset reference remaining amount may be an amount set based on the purchasing pattern of the user.

Further, the current date is the 28th of the month, and the closing date of the card usage period of the card is the 30th of each month. When the closing date of the card usage period is postponed, it may be postponed up to the fifth of each month. Here, the purchasing pattern of the user may be checked, and the amount of the payment that is expected to be made by the user in an interval ranging from the 28th to the fifth day of the next month may be set to the reference remaining amount.

If it is determined at step S3915 that the remaining amount required to reach the target usage record of the at least one card is not less than the preset reference remaining amount, it may be determined that there is no possibility of the closing date of the card usage period being postponed for the at least one card, and the closing date of the card usage period may not be postponed.

That is, since an amount expected to be spent by the user until the postponed closing date of the card usage period is less than the remaining amount required to reach the target usage record, it is determined that the at least one card cannot achieve the target usage record even if the closing date of the card usage period is postponed, and there is no possibility of the closing date of the card usage period being postponed.

Further, if it is determined at step S3915 that the remaining amount required to reach the target usage record of the at least one card is less than the preset reference remaining amount, it may be determined that there is a possibility of the closing date of the card usage period being postponed for the at least one card, and the usage record in the current month obtained when the closing date of the card usage period is postponed may be predicted at step S3920.

That is, since an amount expected to be spent by the user until the postponed closing date of the card usage period is greater than the remaining amount required to reach the target usage record, it is determined that the at least one card may achieve the target usage record when the closing date of the card usage period is postponed, and there is a possibility of the closing date of the card usage period being postponed.

Therefore, as the closing date of the card usage period is postponed, the at least one card, which is excluded from the optimal card candidates, may be considered again as an optimal card candidate. Accordingly, the usage record in the current month, obtained when the closing date of the card usage period is postponed, may be predicted, and an optimal card may be recommended in consideration of the predicted usage record in the current month.

Then, it is determined whether the at least one card has been recommended as an optimal card at step S3925.

If it is determined at step S3925 that the at least one card has been recommended as the optimal card, the closing date of the card usage period is postponed by delaying the opening date of the card usage period of the optimal card at step S3930.

Here, the closing date of the card usage period may be postponed by delaying the opening date of the card usage period of the optimal card.

In this case, the closing date of the card usage period denotes the last day of a usage record determination period for the corresponding card, and the day after the closing date of the card usage period may correspond to the opening date of a new card usage period during which the calculation of a usage record is newly performed.

Therefore, when the opening date of a card usage period is delayed, the closing date of the card usage period may also be postponed, and thus the closing date of the card usage period may be adjusted by changing the opening date of the card usage period. Alternatively, the closing date of the card usage period may be postponed by adjusting the closing date itself.

Here, the closing date of the card usage period may be postponed within a predetermined range. For example, there are the cases where the payment due dates or the card usage period opening dates of respective cards are designated for respective card companies. In other words, generally, various dates, such as the first, 10th, 25th or last day of each month, may be designated and one of the designated dates may be selected and used. Therefore, if there is a designated date even when the closing date of a card usage period is changed, the closing date may be changed and postponed in accordance with the designated date.

Further, if it is determined at step S3925 that the at least one card is not recommended as the optimal card, the process may be terminated without postponing the closing date of the card usage period.

The optimal card recommendation method according to the present invention may be implemented in the form of program instructions that may be executed by various computer means and may be stored in a computer-readable storage medium. The computer-readable storage medium may include program instructions, data files, and data structures, either solely or in combination. The program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine language code, such as code created by a compiler, and high-level language code executable by a computer using an interpreter. The hardware devices may be configured to operate as one or more software modules in order to perform the operation of the present invention, and vice versa.

In accordance with the present invention, the most suitable payment card may be recommended by predicting a commodity to be purchased by a user and a payment amount for the commodity so that the user may use an automatic payment service when paying for a commodity at a store through his or her mobile terminal.

Further, the present invention may recommend a payment card and a membership card, which allow a user to obtain the maximum benefits, such as discounts or accumulation, depending on the commodity expected to be purchased by the user and a payment amount for the commodity.

Furthermore, the present invention may maximize the convenience of a user by allowing the user to process payment while minimizing an operation of performing payment at a store using his or her mobile terminal.

Furthermore, the present invention may recommend a card that provides optimal benefits even in the situation in which a commodity and a payment amount are not fixed, as in the case of a store check-in-based service.

Furthermore, the present invention may change the current card to another card having more benefits based on an actually purchased commodity and a payment amount for the commodity and may recommend the changed card when the prediction of a commodity or an amount is incorrect, thus improving the reliability of a card recommendation algorithm.

Furthermore, the present invention may provide a recommended card so that a user may purchase each commodity most effectively on each payment due date by applying a recommendation algorithm in consideration of benefits and usage records based on the date on which the commodity is paid for.

Furthermore, the present invention may recommend an optimal card by applying different weights to the discount rates and the accumulation rates of cards based on the date on which a commodity is paid for, thus allowing the user to obtain the most effective benefits depending on the payment date.

Furthermore, the present invention may provide a payment method, which allows a user to continuously obtain benefits based on usage records by postponing the closing date of the card usage period of the corresponding card in consideration of the usage records of respective cards when recommending a payment card.

As described above, in the optimal card recommendation system, the optimal card recommendation apparatus, and the method using the apparatus according to the present invention, the configurations and schemes in the above-described embodiments are not limitedly applied, and some or all of the above embodiments can be selectively combined and configured so that various modifications are possible.

In addition, in accordance with the present invention, it is possible to predict one or more purchase commodities that are expected to be purchased by a user at a store, predict the amount of the payment that is expected to be made by the user at the store, and recommend an optimal card, among multiple cards registered in an application for payment, in consideration of at least one of the expected payment amount and the one or more expected purchase commodities.

Furthermore, in accordance with the present invention, it is possible to predict one or more purchase commodities that are expected to be purchased by a user at a store, predict the amount of the payment that is expected to be made by the user at the store, recommend an optimal card, among multiple cards registered in an application for payment, in consideration of at least one of the one or more expected purchase commodities and the expected payment amount, determine whether to change an optimal card in consideration of at least one card change condition, and then change an optimal card in consideration of an actual purchase commodity and an actual payment amount if it is determined to change the optimal card.

Furthermore, in accordance with the present invention, it is possible to predict one or more expected purchase commodities that are expected to be purchased by a user at a store, predict the amount of the payment that is expected to be made by the user at the store, determine the payment section corresponding to the current date among multiple sections corresponding to a usage record determination period, and recommend an optimal card, among the multiple cards registered in the application, in consideration of at least one of the recommendation algorithm corresponding to the payment section, the one or more expected purchase commodities, and the expected payment amount.

Furthermore, in accordance with the present invention, it is possible to predict one or more expected purchase commodities that are expected to be purchased by a user at a store, predict the amount of the payment that is expected to be made by the user at the store, determine the payment section corresponding to the current date, among multiple sections corresponding to a usage record determination period, and recommend an optimal card, among the multiple cards registered in the application, in consideration of at least one of a recommendation algorithm to which a weight corresponding to the payment section is applied, the one or more expected purchase commodities, and the expected payment amount.

Furthermore, in accordance with the present invention, it is possible to predict one or more expected purchase commodities that are expected to be purchased by a user at a store, predict the amount of the payment that is expected to be made by the user at the store, determine the payment section corresponding to the current date among multiple sections corresponding to a usage record determination period, and recommend an optimal card, among the multiple cards registered in the application, in consideration of at least one of a recommendation algorithm corresponding to the payment section, the one or more expected purchase commodities, and the expected payment amount, and it is also possible to recommend an optimal card in consideration of a possibility of a target usage record being achieved when the closing of a card usage period is postponed depending on the payment section, together with the above considerations.

Furthermore, the present invention may maximize the convenience of each user who purchases a commodity at a store, thus inducing users to conveniently purchase commodities, with the result that the profits of stores or shops may be improved.

What is claimed is:

1. A payment card recommendation apparatus, comprising:
a purchase commodity prediction unit for predicting one or more purchase commodities that are expected to be purchased by a user at a store;
an expected amount prediction unit for predicting an amount of a payment that is expected to be made by the user at the store; and
a card recommendation unit for recommending a payment card, among multiple cards registered in an application for payment, in consideration of at least one of the expected payment amount and the one or more expected purchase commodities.

2. The payment card recommendation apparatus of claim 1, further comprising:
a matching determination unit for determining whether to match the one or more expected purchase commodities with the expected payment amount by comparing a total amount of the one or more expected purchase commodities with the expected payment amount; and
a commodity amount matching unit for, if it is determined to perform matching, matching the one or more expected purchase commodities with the expected payment amount by adjusting any one of the expected payment amount and the one or more expected purchase commodities.

3. The payment card recommendation apparatus of claim 2, wherein:
the matching determination unit is configured to determine to perform matching if a difference between the total amount and the expected payment amount is equal to or greater than a preset reference difference, and
the commodity amount matching unit is configured to match the one or more expected purchase commodities with the expected payment amount in such a way that, when the total amount is greater than the expected payment amount, the total amount is adjusted such that the total amount matches the expected payment amount by first excluding a commodity having a low probability of being purchased from the one or more expected purchase commodities; and when the total amount is less than the expected payment amount, the expected payment amount is adjusted such that the expected payment amount matches the total amount.

4. The payment card recommendation apparatus of claim 1, wherein the card recommendation unit comprises:
a payment card recommendation unit for recommending a payment card providing maximum benefits, among one or more payment cards included in the multiple cards; and
a membership card recommendation unit for recommending a payment membership card in consideration of at least one of accumulation rates and discount rates, among one or more membership cards included in the multiple cards.

5. The payment card recommendation unit of claim 4, wherein the purchase commodity prediction unit predicts the expected purchase commodities in consideration of at least one of a purchasing pattern of the user in an affiliated store group corresponding to the store, a purchasing pattern of a user group identical to the user in the affiliated store group, information about benefits provided by the store, and utilization of the benefits by the user.

6. The payment card recommendation apparatus of claim 5, wherein the expected amount prediction unit predicts the expected payment amount in consideration of at least one of the purchasing pattern of the user, information about an amount of a purchase by a single user at the store, and information about an amount of each purchase by the identical user group in the affiliated store group.

7. The payment card recommendation apparatus of claim 5, wherein the purchase commodity prediction unit detects unnecessary commodity items in consideration of at least one of information about a commodity most recently purchased by the user in the affiliated store group and information about a time of the purchase of the most recently purchased commodity, and excludes the unnecessary commodity items from the one or more expected purchase commodities when the one or more expected purchase commodities are predicted.

8. The payment card recommendation apparatus of claim 1, further comprising:
a card change unit for determining whether to change the payment card in consideration of at least one card change condition, and changing the payment card in consideration of at least one of an actual purchase commodity and an actual payment amount if it is determined to change the payment card.

9. The payment card recommendation apparatus of claim 8, wherein the card change unit is configured to, when a difference obtained by comparing an expected discount amount based on at least one of the actual purchase commodity and the actual payment amount with an actual discount amount corresponding to the payment card is equal to or greater than a preset change reference amount, determine that the at least one card change condition is satisfied, and then change the payment card.

10. The payment card recommendation apparatus of claim 8, wherein the card change unit is configured to, when a determination as to whether to apply a conditional discount based on a total payment amount is changed, determine that the at least one card change condition is satisfied, and then change the payment card.

11. A payment card recommendation apparatus, comprising:
a purchase commodity prediction unit for predicting one or more purchase commodities that are expected to be purchased by a user at a store;
an expected amount prediction unit for predicting an amount of a payment that is expected to be made by the user at the store;
a payment section determination unit for determining a payment section corresponding to a current date, among multiple sections corresponding to a usage record determination period; and
a card recommendation unit for recommending a payment card, among multiple cards registered in an application, in consideration of at least one of a recommendation algorithm corresponding to the payment section, the one or more expected purchase commodities, and the expected payment amount.

12. The payment card recommendation apparatus of claim 11, wherein the card recommendation unit is configured to recommend the payment card, among the multiple cards, in consideration of benefits when the payment section is a first section among the multiple sections, recommend the payment card, among the multiple cards, in consideration of both the benefits and a usage record in a current month when the payment section is a second section among the multiple sections, and recommend the payment card, among the multiple cards, in consideration of the usage record in the current month when the payment section is a third section among the multiple sections.

13. The payment card recommendation apparatus of claim 12, wherein the card recommendation unit is configured to recommend the payment card in a sequence of usage records in the current month from lowest to highest usage records when the payment section is the first section and there are cards having identical benefits, among the multiple cards, and recommend the payment card in a sequence of usage records in the current month from closest to farthest from the target usage records for respective cards when the payment section is the second section and there are cards having identical benefits, among the multiple cards.

14. The payment card recommendation apparatus of claim 13, further comprising:
a section division unit for checking opening dates of card usage periods of the multiple cards, and dividing the usage record determination period corresponding to one month from each of the opening dates into the multiple sections.

15. The payment card recommendation apparatus of claim 14, wherein the section division unit comprises:
a card group generation unit for generating at least one card group by grouping cards having identical opening dates of card usage periods, among the multiple cards; and
a group-based section division unit for dividing the usage record determination period corresponding to the at least one card group into multiple group-based sections.

16. The payment card recommendation apparatus of claim 11, wherein the card recommendation unit recommends the payment card, among the multiple cards registered in the application, in consideration of at least one of a recommendation algorithm to which a weight corresponding to the payment section is applied, the one or more expected purchase commodities, and the expected payment amount.

17. The payment card recommendation apparatus of claim 16, further comprising:
a weight application unit for applying a first weight to any one of discount rates and accumulation rates corresponding to the multiple cards in a first section among the multiple sections, applying a second weight to any one of the discount rates and the accumulation rates in a second section among the multiple sections, and applying a third weight to any one of the discount rates and the accumulation rates in a third section among the multiple sections,
wherein the weight application unit applies the weights so that the discount rates are greater than the accumulation rates.

18. The payment card recommendation apparatus of claim 12, wherein the card recommendation unit recommends the payment card in consideration of a possibility that a target usage record will be achieved when closing of a card usage period is postponed, depending on the payment section.

19. The payment card recommendation apparatus of claim 18, wherein the card recommendation unit comprises:
a usage period closing postponement checking unit for checking whether, among the multiple cards, one or more cards for which usage records in the current month have not yet reached target usage records have a possibility that a closing date of a card usage period will be postponed when the payment section is the third section,
wherein the payment card is recommended in consideration of a usage record in the current month, which is expected when the closing date of the card usage period is postponed for a card having the possibility that the closing date of the card usage period will be postponed, among the one or more cards.

20. The payment card recommendation apparatus of claim 19, wherein:
the card recommendation unit further comprises a usage period closing postponement unit for postponing the closing date of the card usage period by delaying an opening date of the card usage period of the payment card when the card having the possibility that the closing date of the card usage period will be postponed is recommended as the payment card, and
the usage period closing postponement checking unit is configured to, when a remaining amount required to achieve target usage records of the one or more cards is less than a reference remaining amount that is preset based on a purchasing pattern of the user, determine that the corresponding card has the possibility that the closing date of the card usage period will be postponed.
